(19) United States
(12) Patent Application Publication
(10) Pub. No.: US 2025/0224742 A1
(43) Pub. Date: Jul. 10, 2025

(54) CONTROL APPARATUS, METHOD AND PROGRAM

(71) Applicant: NIPPON TELEGRAPH AND TELEPHONE CORPORATION, Tokyo (JP)

(72) Inventor: Hiroshi KAWANO, Tokyo (JP)

(73) Assignee: NIPPON TELEGRAPH AND TELEPHONE CORPORATION, Tokyo (JP)

(21) Appl. No.: 18/853,702

(22) PCT Filed: Apr. 5, 2022
(86) PCT No.: PCT/JP2022/017082

§ 371 Date: Oct. 2, 2024

(51) Int. Cl. G05D 1/69; G05D 101/00

(52) U.S. Cl. CPC G05D 1/69; G05D 2101/22

(57) ABSTRACT

On the assumption that a combined control object unit and a second type control object unit are alternately disposed along a Hamilton cycle at intermediate positions, and intermediate positions include an intermediate position M before exchange and an intermediate position M′ after exchange, a control device includes a first movement planning unit 1 and a first movement unit 2 that move each control object at an initial position S to an intermediate position M before exchange in control object units, a second movement planning unit 3 that creates a second movement plan for moving each control object assumed to be at a target position G to an intermediate position M′ after exchange in control object units, and an intermediate position exchange unit 4 that moves each control object at the intermediate position M before exchange to a movement destination of each control object determined by the second movement plan among intermediate positions M′ after exchange.

### TECHNICAL FIELD

The present invention relates to a technique for controlling actions of a plurality of control objects.

### BACKGROUND ART

In recent years, research has been being actively conducted into efficiently controlling a large number of autonomous mobile robots. The details of tasks are various, including monitoring locations which people cannot enter, transporting goods, and so on, but there is a need for technology that enables efficient formation creation through coordinated operations of a large number of robots, and research into this technology is actively being conducted.

Particularly, in a robot formation control under the assumption that robots move as a whole like an amoeba in a state in which the robots are in contact with each other among robot formation control, there are the advantage that the absolute position of each robot can be determined and the advantage that additional equipment for position measurement is not required, and research into such robots is being conducted. For example, in a series of research leading to the research shown in NPL 1, formation control for changing from a certain formation to another formation is shown (refer to NPL 1, for example).

In this manner, to realize efficient formation creation by a large number of robots, it is important to plan the disposition, the operation order, and the like of respective robots in advance. In such a plan, the presence of obstacles and the shape of a route in a real environment in which a plurality of robots are operating need to be sufficiently considered.

In the technique disclosed in the research shown in NPL 1, formation transformation of robots by an expansion and retraction plane operation between a plurality of cubic robots (an operation of a certain robot moving while expanding and retracting in a state of coming in contact with other robots) is handled. Here, it is assumed that respective robots are in contact, and the respective robots have the same characteristics (homogeneous). That is, formation control in a case in which a target position of each robot within a target form is not determined is realized. In addition, transformation of a robot structure based on a robot unit composed of robots in 8 squares is handled. Transformation requires a transformation time proportional to the square of the number of robots.

In the technique disclosed in research shown in NPL 2, formation transformation of robots by a plane shearing operation between a plurality of cubic robots (an operation of a certain robot sliding on a contact plane while in contact with another robot) is handled. Here, transformation of a robot structure based on a robot unit composed of robots in 8 squares is also handled. Each robot unit has different characteristics (heterogeneous). That is, formation control in a case in which a target position of each robot unit within a target form is determined for each robot unit is realized. Transformation requires a transformation time proportional to the number of robots. In NPL 2, robots in the same robot unit are handled as homogeneous, and thus it is impossible to set the mutual positional relationship between the robots in the same robot unit to positions designated before and after formation transformation.

In the technique disclosed in research shown in NPL 3, formation transformation of robots by a plane shearing operation between a plurality of cubic robots (an operation of a certain robot sliding on a contact plane while in contact with another robot) is handled. Here, an 8-square robot unit is not used, and transformation of a robot structure with full resolution is handled. Each robot has different characteristics (heterogeneous). That is, formation control in a case in which a target position of each robot within a target form is determined for each robot is realized. Transformation requires a transformation time proportional to the number of robots.

In both of the inventions of NPL 1 and NPL 2, a space other than a space occupied by a set of initial positions and target positions of robots is not required in the transformation process, and the process is applicable in a space where an obstacle is present, but the invention of NPL 3 requires a free space having no obstacle in the transformation process.

### CITATION LIST

### Non Patent Literature

[NPL 1] S. Vassilivitskii, M. YIM, J. Suh, “A Complete, Local and Parallel Reconfiguration Algorithm for Cube Style Modular Robots,” in Proc. 2002 IEEE Int. Conf. Robotics and Automation, pp. 117-122, Washington DC, May 2002
[NPL 2] Kawano H., “Distributed Linear Heterogeneous Reconfiguration of Cubic Modular Robots via Simultaneous Tunneling and Permutation,” IEEE Transactions on Robotics, Vol. 36, Issue 1, pp. 62-77, February 2020.
[NPL 3] Kawano, H., “Parallel Permutation for Linear Full Resolution Reconfiguration of Heterogeneous Sliding-only Cubic Modular Robots,” 2020 IEEE International Conference on Robotics and Automation, pp. 8281-8287 May 2020, Paris, France.

### SUMMARY OF INVENTION

### Technical Problem

However, there is no control technique for performing high-speed formation transformation with a reduced space in formation transformation in which a target position is determined for each control object (in other words, formation control enables heterogeneous formation transformation for each control object) and movement is performed for each control object.

An object of the present invention is to provide a control device, method, and program for performing high-speed formation transformation in formation transformation in which a target position is determined for each control object and movement is performed for each control object.

### Solution to Problem

A control device according to one aspect of the present invention includes, on the assumption that object units include a first type control object unit and a second type control object unit, each of the first type control object unit and the second type control object unit is composed of U (U is an integer of 4 or more) control objects, an initial position S and a target position G are determined for each control object, a structure composed of control objects at initial positions S and target positions G is constituted by a combined control object unit composed of 20 control objects by combining the first type control object unit and the second type control object unit, a graph in which a control object unit at an intermediate position is defined as a node and a plane connecting two control object units in contact with each other is defined as an edge constitutes a part or the whole of a Hamilton cycle, a combined control object unit and a second type control object unit are alternately disposed at intermediate positions along the Hamilton cycle, and intermediate positions include an intermediate position M before exchange and an intermediate position M′ after exchange: a first movement planning unit configured to create a first movement plan for moving each control object at an initial position S to an intermediate position M before exchange in control object units; a first movement unit configured to move each control object at the initial position S to the intermediate position M before exchange in control object units according to the first movement plan; a second movement planning unit configured to create a second movement plan for moving each control object assumed to be at a target position G to an intermediate position M′ after exchange in control object units; an intermediate position exchange unit configured to move each control object at the intermediate position M before exchange to a movement destination of each control object determined by the second movement plan among intermediate positions M′ after exchange; and a second movement unit configured to move each control object at the intermediate position M′ after exchange to a target position G in control object units according to a plan obtained by temporally reversing the second movement plan.

### Advantageous Effects of Invention

According to the present invention, in formation transformation in which a target position is determined for each control object and movement is performed for each control object, the formation transformation can be performed in a space-saving manner at a high speed.

### BRIEF DESCRIPTION OF DRAWINGS

FIG. 1 is a diagram for describing an example of robot movement.

FIG. 2 is a diagram for describing examples of an initial position and a target position of a control object unit.

FIG. 3 is a diagram for describing an example of a state of void movement.

FIG. 4 is a diagram for describing an example of a control object unit.

FIG. 5 is a diagram for describing an example of forms of intermediate positions M and M′.

FIG. 6 is a diagram for describing an example of generating the intermediate position M.

FIG. 7 is a diagram for describing numbering of each position of the intermediate position M.

FIG. 8 is a diagram for describing numbering of each position of the intermediate position M.

FIG. 9 is a diagram for describing an intermediate position Mpre in a transformation process of S→M.

FIG. 10 is a diagram for describing an exchange process.

FIG. 11 is a diagram for describing formation of the intermediate position M′ when A_max=0.

FIG. 12 is a diagram for describing the intermediate position M′ when A_max=1, 2.

FIG. 13 is a diagram for describing an example of movement of a control object unit.

FIG. 14 is a diagram for describing an example of movement of a control object unit.

FIG. 15 is a diagram for describing transformation from LCMM to UCMM of a control object unit.

FIG. 16 is a diagram for describing transformation from LCMM to UCMM of a control object unit.

FIG. 17 is a diagram for describing an operation example of an exchange process.

FIG. 18 is a diagram for describing an operation example of an exchange process.

FIG. 19 is a diagram for describing an operation example of an exchange process.

FIG. 20 is a diagram for describing an operation example of an exchange process.

FIG. 21 is a diagram for describing an operation example of an exchange process.

FIG. 22 is a diagram for describing an operation example of an exchange process.

FIG. 23 is a diagram for describing an operation example of an exchange process.

FIG. 24 is a diagram for describing an operation example of an exchange process.

FIG. 25 is a diagram for describing an operation example of an exchange process.

FIG. 26 is a diagram for describing an operation example of an exchange process.

FIG. 27 is a diagram for describing an operation example of an exchange process.

FIG. 28 is a diagram for describing an example of an exchange operation of a control object.

FIG. 29 is a diagram for describing an example of an exchange operation of a control object.

FIG. 30 is a diagram for describing an example of an exchange operation of a control object.

FIG. 31 is a diagram for describing an example of an exchange operation of a control object.

FIG. 32 is a diagram for describing an example of an exchange operation of a control object.

FIG. 33 is a diagram for describing an example of an exchange operation of a control object.

FIG. 34 is a diagram for describing an example of an exchange operation of a control object.

FIG. 35 is a diagram for describing an example of an exchange operation of a control object.

FIG. 36 is a diagram for describing an example of an exchange operation of a control object.

FIG. 37 is a diagram for describing an example of an exchange operation of a control object.

FIG. 38 is a diagram for describing an example of an exchange operation of a control object.

FIG. 39 is a diagram for describing an example of an exchange operation of a control object.

FIG. 40 is a diagram for describing an example of an exchange operation of a control object.

FIG. 41 is a diagram for describing an example of an exchange operation of a control object.

FIG. 42 is a diagram for describing an example of an exchange operation of a control object.

FIG. 43 is a diagram for describing an example of an exchange operation of a control object.

FIG. 44 is a diagram for describing an example of an exchange operation of a control object.

FIG. 45 is a diagram for describing an example of an exchange operation of a control object.

FIG. 46 is a diagram for describing an example of an exchange operation of a control object.

FIG. 47 is a diagram for describing an example of an exchange operation of a control object.

FIG. 48 is a diagram for describing an example of an exchange operation of a control object.

FIG. 49 is a diagram for describing an example of an exchange operation of a control object.

FIG. 50 is a diagram for describing an example of an exchange operation of a control object.

FIG. 51 is a diagram for describing an example of an exchange operation of a control object.

FIG. 52 is a diagram for describing an example of an exchange operation of a control object.

FIG. 53 is a diagram for describing an example of an exchange operation of a control object.

FIG. 54 is a diagram for describing an example of an exchange operation of a control object.

FIG. 55 is a diagram for describing an example of an exchange operation of a control object.

FIG. 56 is a diagram for describing an example of an exchange operation of a control object.

FIG. 57 is a diagram for describing an example of an exchange operation of a control object.

FIG. 58 is a diagram for describing an example of an exchange operation of a control object.

FIG. 59 is a diagram for describing an example of an exchange operation of a control object.

FIG. 60 is a diagram for describing an example of an exchange operation of a control object.

FIG. 61 is a diagram for describing an example of an exchange operation of a control object.

FIG. 62 is a diagram for describing an example of an exchange operation of a control object.

FIG. 63 is a diagram for describing an example of an exchange operation of a control object.

FIG. 64 is a diagram for describing an example of an exchange operation of a control object.

FIG. 65 is a diagram for describing an example of an exchange operation of a control object.

FIG. 66 is a diagram for describing an example of an exchange operation of a control object.

FIG. 67 is a diagram for describing an example of an exchange operation of a control object.

FIG. 68 is a diagram for describing an example of an exchange operation of a control object.

FIG. 69 is a diagram for describing an example of an exchange operation of a control object.

FIG. 70 is a diagram for describing an example of an exchange operation of a control object.

FIG. 71 is a diagram for describing an example of an exchange operation of a control object.

FIG. 72 is a diagram for describing an example of an exchange operation of a control object.

FIG. 73 is a diagram for describing an example of an exchange operation of a control object.

FIG. 74 is a diagram for describing an example of an exchange operation of a control object.

FIG. 75 is a diagram for describing an example of an exchange operation of a control object.

FIG. 76 is a diagram for describing an example of an exchange operation of a control object.

FIG. 77 is a diagram for describing an example of an exchange operation of a control object.

FIG. 78 is a diagram for describing an example of an exchange operation of a control object.

FIG. 79 is a diagram for describing an example of an exchange operation of a control object.

FIG. 80 is a diagram for describing an example of an exchange operation of a control object.

FIG. 81 is a diagram for describing an example of an exchange operation of a control object.

FIG. 82 is a diagram for describing an example of an exchange operation of a control object.

FIG. 83 is a diagram for describing an example of an exchange operation of a control object.

FIG. 84 is a diagram for describing an example of an exchange operation of a control object.

FIG. 85 is a diagram for describing an example of an exchange operation of a control object.

FIG. 86 is a diagram for describing an example of an exchange operation of a control object.

FIG. 87 is a diagram for describing an example of an exchange operation of a control object.

FIG. 88 is a diagram for describing an example of an exchange operation of a control object.

FIG. 89 is a diagram for describing an example of an exchange operation of a control object.

FIG. 90 is a diagram for describing an example of an exchange operation of a control object.

FIG. 91 is a diagram for describing an example of an exchange operation of a control object.

FIG. 92 is a diagram for describing an example of an exchange operation of a control object.

FIG. 93 is a diagram for describing an example of an exchange operation of a control object.

FIG. 94 is a diagram for describing an example of an exchange operation of a control object.

FIG. 95 is a diagram for describing an example of an exchange operation of a control object.

FIG. 96 is a diagram for describing an example of an exchange operation of a control object.

FIG. 97 is a diagram for describing an example of an exchange operation of a control object.

FIG. 98 is a diagram for describing an example of an exchange operation of a control object.

FIG. 99 is a diagram for describing an example of an exchange operation of a control object.

FIG. 100 is a diagram for describing an example of an exchange operation of a control object.

FIG. 101 is a diagram for describing an example of an exchange operation of a control object.

FIG. 102 is a diagram for describing an example of an exchange operation of a control object.

FIG. 103 is a diagram for describing an example of an exchange operation of a control object.

FIG. 104 is a diagram for describing an example of an exchange operation of a control object.

FIG. 105 is a diagram for describing an example of an exchange operation of a control object.

FIG. 106 is a diagram for describing an example of an exchange operation of a control object.

FIG. 107 is a diagram for describing an example of an exchange operation of a control object.

FIG. 108 is a diagram showing an example of a functional configuration of a control device.

FIG. 109 is a diagram showing an example of a processing procedure of a control method.

FIG. 110 is a diagram showing a functional configuration example of a computer.

### DESCRIPTION OF EMBODIMENTS

Hereinafter, embodiments of the present invention will be described. Note that in the figures used in the following description, constituent parts having identical functions and steps in which identical processing is performed are denoted by the same reference numerals, and redundant description thereof will be omitted.

### Theoretical Background

First, a theoretical background to a control device and method will be described. Although a case in which a control object serving as an action control subject is a robot will be described below as an example, the control object is not limited to a robot and may be any object that can be a control subject.

### Problem Setting

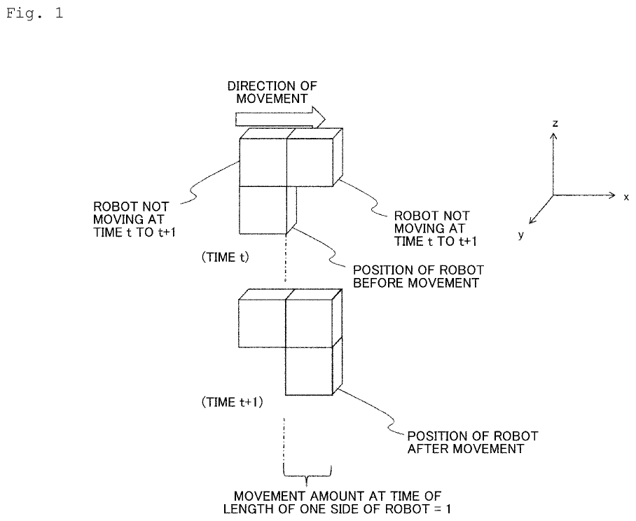

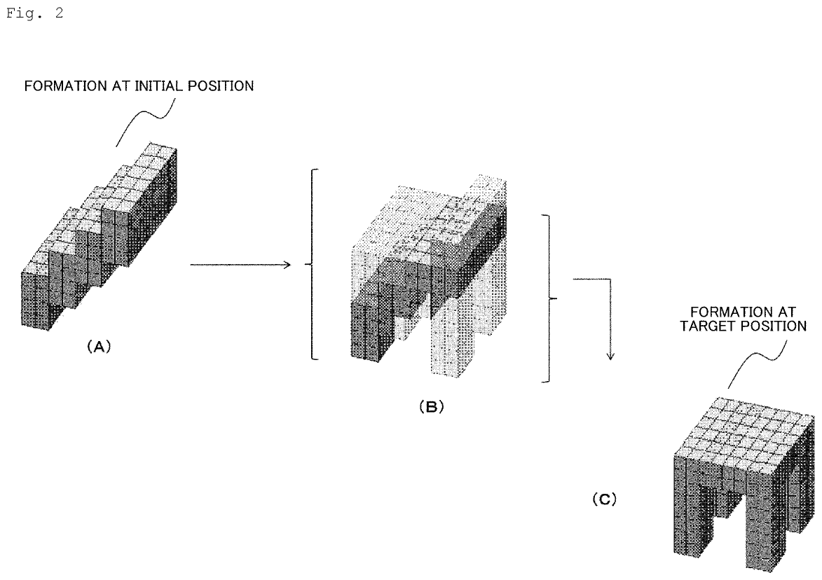

In a task in which a large number of control objects cooperatively perform formation transformation from a formation creation state at an initial position to a target position by moving while maintaining a state in which respective control objects are in contact with each other, it is assumed that cubic control objects capable of moving by sliding over a mutual contact plane, as illustrated in FIG. 1, for example, are used. This is realized by movement of a plurality of control objects from an initial position to a target position in a room partitioned by walls (walls are omitted in the figure), as shown in FIG. 2.

As shown in FIG. 1, for example, a control object is assumed to move while maintaining a state in which another control object is present in one of 6 squares in vertical, horizontal and height directions around the control object (hereinafter, referred to as “upward, downward, leftward, rightward, frontward, and rearward directions”). This method has an advantage in that by moving one control object itself by a distance corresponding to the size of a single control object, the movement amount of a single action can be measured accurately. Further, by measuring relative positions of adjacent control objects sharing a single plane, the position of each control object from among all of the control objects in a control object group can easily be ascertained. As a result, a problem in which the formation collapses due to an error in the movement amount of the control objects is unlikely to occur. Furthermore, a plurality of control objects can be moved simultaneously as if the plurality of control objects had been connected. Note that the control object is assumed to be capable of ascertaining whether or not another control object is present in a position adjacent thereto, whether or not there is an obstacle, and whether or not the control object itself is in a target position.

The number of control objects performing the task is p (where p≥24=8×3 is satisfied), and each control object is assumed to be capable of moving in X-Y-Z axis directions within a three-dimensional space while sharing at least one plane with the adjacent control object. Each cube in FIG. 1 shows the position of one control object. Only one control object can exist in each cube. It is assumed that each control object stops in a case where an obstacle or another control object is present in a direction in which the control object attempts to move. Note that a cubic space in which the control object can be present is also referred to as a square or a grid cell. In FIG. 2, dark gray squares indicate the positions at which control objects are present. The position where the control objects are present in FIG. 2A indicates a set of initial positions of the control objects, and the position where the control objects are present in FIG. 2C indicates a set of target positions of the control objects. As shown in FIG. 2B, the set of target positions and the set of initial positions are in contact with each other or have overlapping parts (common parts). An area represented by a set of target positions is also referred to as a target formation area. In this manner, each initial position and each target position is adjacent to another initial position and target position in at least any of the vertical, horizontal and height directions, and formation shapes at the initial positions and target positions of the control objects are groups of arbitrary shapes.

### [Coordinate Setting of Control Object]

When the position of each control object i (i represents a control object number, i=0, 1, 2, 3, . . . , p−1) is (Xr[i], Yr[i], Zr[i]), an initial position is (Xr0[i], Yr0[i], Zr0[i]), and a target position is (Xre[i], Yre[i], Zre[i]), the problem can be defined as obtaining an action plan for moving the control object disposed at the initial position to the target position. A set of initial positions of the control object is represented by s, and a set of target positions (Xre[i], Yre[i], Zre[i]) is represented by g.

### [Definition of Task Space]

When i is defined as a control object number, each state of the control object i (position and action of the control object) is represented by a discrete value. When a room is represented by a three-dimensional space composed of the X, Y and Z orthogonal coordinate system, each position is represented by values obtained by discretely representing the X-axis, the Y-axis, and the Z-axis. That is, the room (three-dimensional space) is divided into grid cells, and each grid cells corresponds to each position. In addition, in each grid cell, “presence or absence” of an obstacle is set in advance.

### [Definition of Control Object Operation]

Further, a subject of action is each control object disposed in the room. An action a of the control object i (i is a control object number) takes one of seven kinds of remaining stationary and moving by one grid cell in the vertical, horizontal and height directions. For example, a∈{0, 1, 2, 3, 4, 5, 6} is established.
0: remaining stationary
1: moving by one grid cell within the three-dimensional space in a direction in which the X coordinate value increases
2: moving by one grid cell within the three-dimensional space in a direction in which the Y coordinate value increases
3: moving by one grid cell within the three-dimensional space in a direction in which the X coordinate value decreases
4: moving by one grid cell within the three-dimensional space in a direction in which the Y coordinate value decreases
5: moving by one grid cell within the three-dimensional space in a direction in which the Z coordinate value increases
6: moving by one grid cell within the three-dimensional space in a direction in which the Z coordinate value decreases are defined.

### [Problem in Search Calculation]

The state space in such a task environment includes a number of states corresponding to the number of dimensions of control objects×3, and the number of selectable actions is equal to the number of actions of the control objects (=7) multiplied by the number of control objects. For example, if the number of control objects is 50 and the number of grid cells in the vertical, horizontal and height directions of the room is 20 each, the number of states is 20 to the power of 150, and thus a massive amount of resources is required for search calculations. Moreover, each time the number of control object increases by 1, the number of states increases 8000 times. As described in [problem setting] section of the present embodiment, in a case in which the constraint condition that the control objects are in contact with each other is adopted, search calculations need to be performed in consideration of mutual movement of the control objects, and thus it is difficult to reduce the basic calculation amount, which becomes a significant problem in cases where a plurality of control objects are used.

### Features in Reference 1

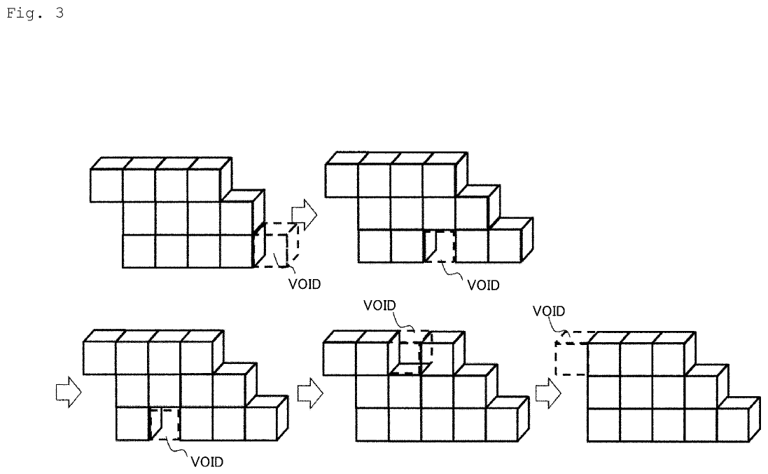

In the heterogeneous formation control in Reference 1, a concept of void control is introduced as one of measures for solving the above-described calculation load problem. In addition, in order to overcome the problem of formation transformation as described in the [problem setting], a concept of 8-square control objects is also introduced. First, void control will be described. A void mentioned here is a void, as illustrated in FIG. 3, formed at a vacant position after a certain control object has moved to another position. In other words, the void is a virtual presence that moves in a direction opposite to a direction in which the control object moves. In such a formation creation problem of group control objects, the search calculation amount significantly increases since attention is paid to the operations of a plurality of control objects, however, if attention is paid to movement of a void by changing a viewpoint, the problem of the operation plan of a large number of control objects can be considered as an operation plan of a single void, and it is suitable to reduce the search calculation load. However, each control object belonging to the control object unit is scattered during the transformation operation, and is divided into different control object units, leading to increase in the load of the subsequent control object exchange operation, and a space other than sets of initial positions and target positions is not required for transformation, but a delay of transformation in which a time required for transformation is proportional to a square of the number of control objects becomes a problem. The main cause is the duration of a time required for the position exchange operation of each control object. At the time of performing the exchange operation, it is difficult to secure a space necessary for the exchange operation in a robot structure in which control objects are densely assembled and therefore, it is difficult to speed up an exchange process by performing the exchange operations of a plurality of sets of control objects in parallel.
[Reference 1] Kawano, H., “Tunneling-Based Self-Reconfiguration of Heterogeneous Sliding Cube-Shaped Modular Robots in Environments with Obstacles,” 2017 IEEE International Conference on Robotics and Automation, pp. 825-832, May 2017, Singapore.

### [Introduction of 4-Square Control Object Unit]

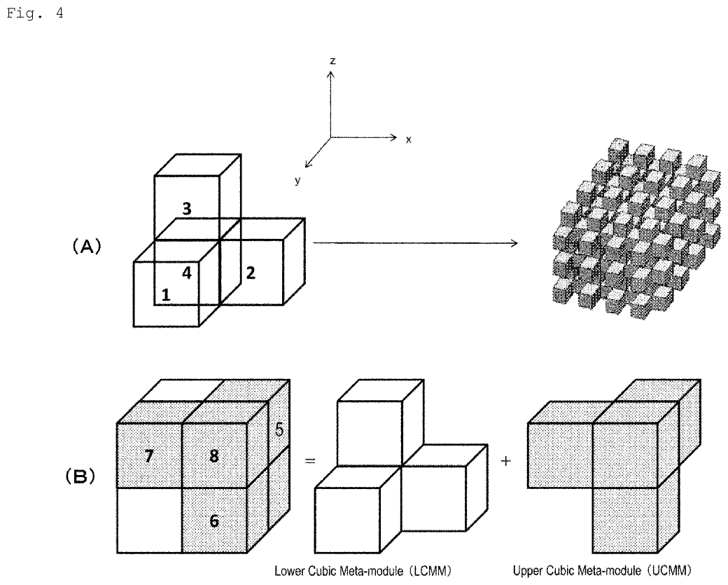

Therefore, as shown in FIG. 4A, four adjacent control objects are defined as one unit (control object unit) and the control objects are assumed to move while maintaining the control object unit. In other words, one control object unit is configured for four control objects, and the four control objects constituting one control object unit move while maintaining a state in which they are adjacent to other control objects constituting one control object unit in three directions. The group of control object unit is controlled such that the control objects share one plane for each control object unit and move in contact with each other. It is assumed that four control objects belonging to the same control object unit are not the same but heterogeneous, and each control object has a unique target position even in a control object unit and moves between different control object units before and after formation transformation.

The reason why the four control objects are moved as one unit is that the control objects belonging to another control object unit can pass through four void spaces inside each control object unit, and thus the control objects belonging to different control object units can easily come and go. Further, it is easy to maintain connectivity when the control objects belonging to another control object unit pass through the four void spaces inside each control object unit. That is, this is because the calculation load for considering connection between the control objects is reduced in determination of the operation of each control object for which maintaining of formation shape needs to be considered.

Here, the control object unit formed by the four control objects is defined as one square unit (this unit is referred to as a “square unit” or a “position unit” below in the present embodiment), and one square unit is set as one state to form a state space. When the position of a control object unit is (Xr_u[j], Yr_u[j], Zr_u[j]) (j=0, 1, 2, . . . , j_max−1), if the control objects in the control object unit j are defined as i1, i2, i3, and i4,

Xr[i1]=2×Xr_u[j]

Yr[i1]=2×Yr_u[j]+1

Zr[i1]=2×Zr_u[j]

Xr=2×Xr_u[j]+1

Yr=2×Yr_u[j]

Zr=2×Zr_u[j]

Xr=2×Xr_u[j]

Yr=2×Yr_u[j]

Zr=2×Zr_u[j]+1

Xr=2×Xr_u[j]

Yr=2×Yr_u[j]

Zr=2×Zr_u[j]

Note that a variable representing the control object unit j to which each control object i belongs is defined as Rr[i]=j. Further, a variable indicating which position of i1, i2, i3, i4 is the position of the control object i is defined as Ir[i]=(1, 2, 3, 4). The initial position of each control object unit is defined as (Xr_u0[j], Yr_u0[j], Zr_u0[j]), and the target position is defined as (XR_ue[j], Yr_ue[j], Zr_ue[j]. Hereinafter, the total number of control objects p is set to a multiple of 4.

As shown in FIG. 4B, it is also possible to constitute a control object unit with 8 squares by combining two control object units, and it is also possible to perform formation control of the control object group constituted by the control object unit with 8 squares by controlling the control object unit with 4 squares. A combination of two control object units may be referred to as a combined control object unit.

In addition, the present invention is not limited to the example shown in FIG. 4, and the control object unit may be configured to satisfy the following conditions. That is, the control object unit is (1) a substructure in a cubic space (this space is hereinafter referred to as a meta module) having a length M (M≥2, where the length of one control object is 1) in each axial direction in a three-dimensional orthogonal coordinate system (in other words, the control object unit occupies a part of the meta module), (2) the number of control objects included in the control object unit in the meta module is equal to the number of parts (i.e., voids) other than the control object unit in the meta module, and (3) M control objects are adjacent to each other in each axial direction. For example, the control object unit illustrated in FIG. 4 is (1) a substructure of a meta module composed of cubes of 8 squares in total having a length M=2 in each axial direction, (2) the number of control objects in the control object unit and the number of voids in the meta module are identical as 4, and (3) two control objects are adjacent to each other in each axial direction.

Although a case in which a structure constituted by four control objects shown in FIG. 4 is defined as a control object unit will be described as an example of the control object unit in the following description, if a control object unit is configured to satisfy the above-described conditions (1) to (3) in a meta module having a size of M³, for example, the same effect can be obtained.

### [Heterogeneous Formation Control]

A heterogeneous control object formation control method in which a structure composed of control objects i constituting an 8-square control object unit is transformed from a state in which each control object is present at an initial position (Xr0[i], Yr0[i], Zr0[i]) in a set S of initial positions to a state in which each control object is present at a target position (Xre[i], Yre[i], Zre[i]) in a set G of target positions will be described below.

It is assumed that the sets S and G are composed of an 8-square control object unit formed by combining two 4-square control object units. The number j_max of 4-square control object units is an even number, and the numbers of two 4-square control object units j1 and j2 constituting one 8-square control object unit has a relationship of j1+j_max/2=j2 therebetween (In the case of j_max=8, j1 is 0, 1, 2 and 3, and j2 is 4, 5, 6 and 7, sets of (j1, j2)=(0, 4) (1, 5) (2, 6) (3, 7) constitute the 8-square unit). j2 is a 4-square control object unit represented by dots in FIG. 4B. The name of j1 is defined as LCMM, and the name of j2 is defined as UCMM. In some cases, j1 is referred to as a second type control object unit, and j2 is referred to as a first type control object unit. If control objects in the j-th UCMM are set to i5, 16, i7, and i8 (FIG. 4),

Xr=2×Xr_u[j]+1

Yr=2×Yr_u[j]

Zr=2×Zr_u[j]+1

Xr=2×Xr_u[j]+1

Yr=2×Yr_u[j]+1

Zr=2×Zr_u[j]

Xr=2×Xr_u[j]

Yr=2×Yr_u[j]+1

Zr[i7]=2×Zr_u[j]+1

Xr=2×Xr_u[j]+1

Yr=2×Yr_u[j]+1

Zr=2×Zr_u[j]+1

Similarly, in the UCMM, a variable representing the control object unit j to which each control object i belongs is defined as Rr[i]=j. In addition, a variable indicating which position of i5, 16, i7, and i8 is the position of the control object i is defined as Ir[i]=(5, 6, 7, 8).

In this manner, it is assumed that the control object unit includes the first type control object unit and the second type control object unit, each of the first type control object unit and the second type control object unit is composed of U (U is an integer of 4 or more) control objects, an initial position and a target position are determined for each control object, and a structure composed of control objects at the initial positions and the target positions is constituted by a combined control object unit which is composed of 2 U control objects by combining the first type control object unit and the second type control object unit.

In the process of transformation, an intermediate position at the start of an exchange process for exchanging the positions of each robot is defined as M, and an intermediate position after the exchange process is defined as M′. M and M′ are not a form constituted by an 8-square robot unit such as S and G, but a form in which only LCMM is present at a certain robot unit position.

Here, transformation of robots from S to G is divided into the following three processes.
(1) Homogeneous transformation process from S to M
(2) Process of exchanging the position of each control object at M After the exchange process, M→M′ is achieved.
(3) Homogeneous transformation process from M′ to G

In the transformation process of (1) and (3), a homogeneous transformation method proposed in the past is utilized (for example, PCT/JP 2021/025458), and in transformation of S→M, S is first transformed into an intermediate form Mpre of an 8-square form by homogeneous transformation, and Mpre is transformed into M through the method proposed in the present invention. Even in transformation of M′→G, G is first transformed into an intermediate form Mpost of the 8-square form by homogeneous transformation, the process of transforming Mpost into M′ through the method proposed in the present invention is calculated by simulation, and the calculated operation is reversely reproduced.

The robot intermediate positions M and M′ where the control object exchange process in the process (2) is performed are constituted by a mixture of 4-square control object units LMCC and UCMM (note that, unlike S and G which are composed of 8 squares, there is a robot unit position where LCMM is present alone). By adopting a robot structure constituted by 4-square control object units, it is possible to secure a space of 4 squares for allowing control objects belonging to another control object unit to pass through each control object unit and allowing each control object to exchange the position. Each control object unit in M secures such a space, and thus the control object exchange operations can be performed simultaneously in parallel in the respective control object units, and the exchange operations can be performed at a high speed.

As another condition regarding the forms of M and M′, in a graph created when each LCMM in M and M′ is defined as a node (vertex) and two planes connecting two LCMMs in contact with each other are defined as edges (branches), the graph needs to form a part of the Hamilton cycle pH. This is because a plurality of control objects moving simultaneously in parallel to the positions of control objects of exchange destinations for the exchange operation can reach the positions of the respective exchange destinations while avoiding collision with each other by tracing the common cycle pH. In this method, although it is difficult to individually optimize routes to be traced by the respective control objects, it is possible to easily increase the number of control objects which are simultaneously exchanged to a number close to the total number of control objects while providing routes with a length having no practical problem to the respective control objects. As another approach, there is an approach of optimizing and calculating a route for each control object unit which moves simultaneously by route search while taking collision avoidance into consideration without using the Hamilton cycle pH, but in a case in which the number of control object units which are simultaneously exchanged is increased to the limit as in the present invention, there is a small space available for securing the moving route of each moving control object, and thus it is still difficult to realize a method of providing a solution with a satisfactory high speed for the shape of an arbitrary robot structure through a route search based approach (a limited solution only for a rectangular parallelepiped robot structure has been reported), and therefore, the approach using the Hamilton cycle pH is advantageous in terms of realization.

Under the conditions related to the forms of M and M′ described above, the transformation processes of (1) and (3) are transformation processes between S and G composed of an 8-square control object unit and M and M′ composed of a 4-square control object, and thus they are transformation in which a structure formed of an 8-square control object unit is developed into a structure formed of a 4-square control object unit. As a matter of course, SnG (common part of S and G) may not be a O set as the positional relationship between S and G, and thus as a result, it is also necessary to consider that there are a plurality of control objects included in SOM (common part of S and M) and MNG (common part of M and G), but this corresponds to the aforementioned homogeneous transformation technique (for example, the method described in PCT/JP2021/025458). The problem in “Low speed property of heterogeneous transformation resulting from difficulty in simultaneous movement of control objects due to a dense robot structure” in [Reference 1] can be solved by adopting a structure having a large number of voids using the 4-square control object unit in M and M′ in the present invention.

### [Determination of Intermediate Positions M and M′]

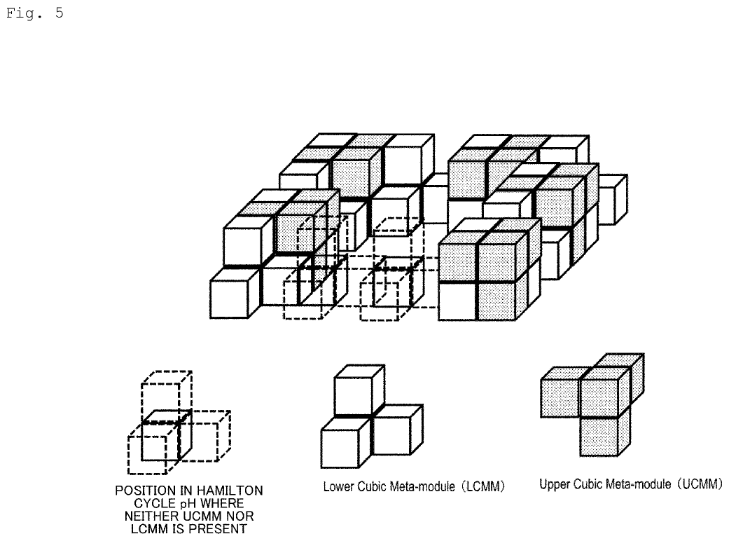

The form of M (and M′. Only M will be described hereinafter) will be described. As shown in FIG. 5, in a graph formed when an LCMM in M is defined as a node (vertex) and two planes connecting two control object units in contact with each other are defined as edges (branches), the graph needs to form a part of the Hamilton cycle pH (here, it is said that “M is a Hamilton graph shape”) (In FIG. 5, among the Hamilton cycle pH including twelve control object unit positions, ten control object unit positions are occupied by the LCMM in M). A graph created by LCMMs in M forms one Hamilton path (not limited to a cycle). UCMMs in M are disposed such that a control object unit position having only the LCMM and a control object unit position having an 8-square control object unit composed of LCMM+UCMM alternately appear along a Hamilton cycle including LCMMs. With this structure, the number of LCMMs in M becomes almost twice the number of UCMMs, and thus the number of control object unit positions occupied by M becomes almost j_max×(2/3) which is a Number (4/3) Times the Number of control object unit positions occupied by S and G. Here, the reason why “almost” is described is that the accurate number slightly differs depending on the number of the remainder obtained by dividing J_max/2 (=the number of control object unit positions in S and G) by 3. In the example shown in FIG. 5, the number of UCMMs is 5 and, the number of LCMMs is 10, and thus the number of LCMMs is just twice the number of UCMMs. By adopting such a structure of M, heterogeneous transformation can be performed simply by excessively requiring an area having a size of about (1/3) of the size of S and G for the intermediate position M (in the method shown in NPL 2, an area having a size of about twice the size of S and G is occupied by the intermediate position M).

Here, in the present state of graph theoretical research, since a method for generally determining whether or not an arbitrary graph has a Hamilton cycle when the graph is given has not been established, it is impossible to easily determine whether or not S+G is a Hamilton graph shape, for example. Therefore, it is considered that a Hamilton graph satisfying geometric conditions to be taken by M is generated from scratch.

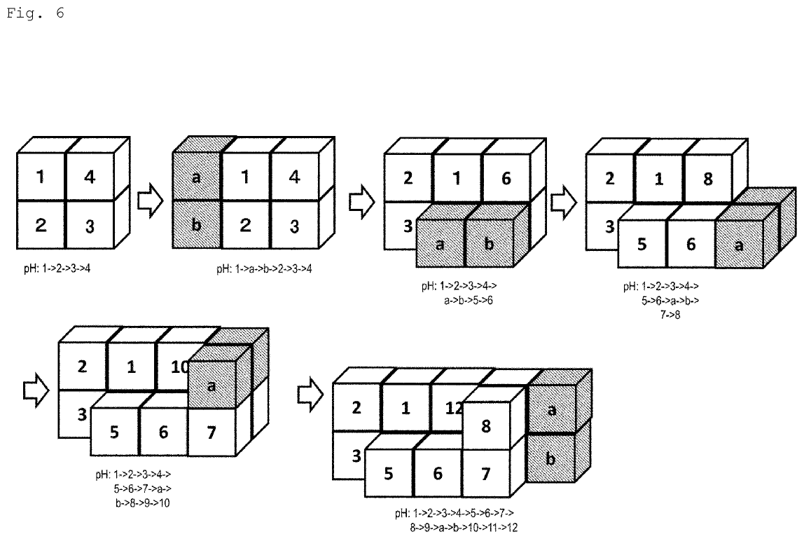

This technique will be briefly described. First, as a robot structure having a small Hamilton graph shape, a structure M₀ in which four control object units are arranged in a square shape is considered. M₀ clearly has a Hamilton cycle around four sides of a square as shown in FIG. 6. Here, two adjacent vertexes on the Hamilton cycle (for example, two adjacent control object units 1 and 2) are selected, two control objects a and b at positions in contact with the two control object units and at positions not overlapping the control object in M₀ are added to M₀, and a structure in which edges respectively connecting the control object unit 1 and a, a and b, and b and 2 are added is defined as M₁. Then, M₁ is a Hamilton graph-shaped structure having a Hamilton cycle 1→a→b→2→3→4→1. M_{L} is grown by repeating addition of such two control objects to M_{L} (L=0, 1, 2, 3, . . . ), and when the number of control object units included in M_{L} finally exceeds a certain value, M_{L} satisfies conditions required for the Hamilton cycle shape including M. The number of control object units to be included at the minimum in M_{L} slightly differs depending on the value of j_max/2. In a case in which the quotient obtained by dividing j_max/2 by 3 is defined as k_max and the remainder is defined as A_max, when the remainder A_max is 0, the number of UCMMs in M is 2k_max, the number of LCMMs is 4k_max, and the number of control object unit positions to be included at the minimum in M_{L} is 4k_max+2. When the remainder A_max is 1, the number of UCMMs in M is 2k_max, the number of LCMMs is 4k_max+2, and the number of control object unit positions to be included at the minimum in M_{L} is 4k_max+2. When the remainder A_max is 2, the number of UCMMs in M is 2k_max+1, the number of LCMMs is 4k_max+3, and the number of control object unit positions to be included at the minimum in M_{L} is 4k_max+4. Hereinafter, the number of UCMMs in M is defined as N_{ucmm}, the number of LCMMs is defined as N_{lcmm}, and the number of control object units to be included at the minimum in M_{L} is defined as N_{hamilton_min}.

In this case, by setting M₀ and repeatedly adding two control objects to M_{L} after setting of M₀ in consideration of the position of an obstacle in the space where transformation of robots is performed and the shapes of S and G, the shape of M can be determined in consideration of various geometric conditions of the space where transformation of robots is performed.

For example, M can be determined by the following processing.

### [M_Decision]

(1) M₀ to be settled within S+G is selected.
(2) The following (3) and (4) are repeated.
(3) Control object units included in M_{L} are numbered 0, 1, 2, 3, . . . , (4−1)+L×2 in the order traced by the Hamiltonian cycle in M_{L} to be represented as pH0, pH1, pH2, pH3, . . . , pH(4-1)+L×2. k=0 is set.
(4) Two control object units having adjacent numbers (k and k+1. (4−1)+L×2 and 0 when k=(4−1)+L×2) are selected in ascending order, and in a case in which there are two new control object unit positions which are in contact with both the two control object units, are within S+G and are not within M_{L} each time selection is performed, the two new control object unit positions (defined as a and b) are added to M_{L}, and a Hamilton cycle of M_{L+1} is set to pH 0, pH 1, . . . , pH k, a, b, pH k+1, . . . , pH (4-1)+L×2. In a case in which the control object unit positions included in M_{L+1} do not reach N_{hamilton_min}, processing returns to (3). In a case in which the control object unit positions included in M_{L+1} reach N_{hamilton_min}, processing is terminated. In a case in which there is no control object position which is within additional S+G and not within M_{L} with respect to all adjacent control object sets in the Hamilton cycle in M_{L}, processing proceeds to (5).
(5) The following (6) and (7) are repeated.
(6) The control object units included in M_{L} are numbered 0, 1, 2, 3, . . . (4−1)+L×2 in the order of the Hamiltonian cycle in M_{L} to be represented as pH0, pH1, pH2, pH3, . . . , pH(4−1)+L×2. k=0 is set.
(7) Two control object units having adjacent numbers (k and k+1. (4−1)+L×2 and 0 when k=(4−1)+L×2) are selected in ascending order, and in a case in which there are two new control object unit positions which are in contact with both the two control object units, at least one of which is within S+G, both of which are not within M_{L}, and which do not overlap an obstacle position, the two new control object unit positions (defined as a and b) are added to M_{L} and a Hamilton cycle of M_{L+1} is set to pH 0, pH 1, . . . , pH k, a, b, pH k+1, . . . , pH (4-1)+L×2. In a case in which the number of control object unit positions included in M_{L+1} does not reach N_{hamilton_min}, processing returns to (6). In a case in which the number of control object unit positions included in M_{L+1} reaches N_{hamilton_min}, processing ends. In a case in which there is no control object position that can be added with respect to all adjacent control object sets in the Hamilton cycle in M_{L}, processing proceeds to (8).
(8) The following (9) and (10) are repeated.
(9) Control object units included in M_{L} are numbered 0, 1, 2, 3, . . . , (4-1)+L×2 in the order traced by the Hamilton cycle in M_{L} to be represented as pH0, pH1, pH2, pH3, . . . , pH(4−1)+L×2. k=0 is set.)
(10) Two control object units having adjacent numbers (k and k+1. (4−1)+L×2 and 0 when k=(4−1)+L×2) are selected in ascending order, and in a case in which there are two new control object unit positions which are in contact with both the two control object units, are not within M_{L} and do not overlap an obstacle position, the two new control object unit positions (defined as a and b) are added to M_{L}, and the Hamilton cycle of M_{L+1} is set to pH 0, pH 1, . . . , pH k, a, b, pH k+1, . . . , pH(4-1)+L×2. In a case in which the control object unit positions included in M_{L+1} do not reach N_{hamilton_min}, processing returns to (6). In a case in which the control object unit positions included in M_{L+1} reach N_{hamilton_min}, processing is terminated. In a case in which there is no control object position that can be added with respect to all adjacent control object sets in the Hamilton cycle in M_{L}, processing proceeds to (11).
(11) Another M₀ than the one selected so far is selected again within S+G. When it is not found in S+G, M₀ at a position where a part is within S+G and does not overlap an obstacle is selected and returned to (2).

In a case in which M_{L} including an appropriate Hamilton cycle is found according to [M_Decision], the number of control object units included in M_{L} is always N_{hamilton_min}. This is because the process of [M_Decision] is a process of generating a Hamilton cycle by sequentially adding two control object unit positions to M_{L} starting from M₀ including minimum four control object unit positions. However, in a case in which no appropriate M_{L} is found according to [M_Decision], that is, in a case in which the number of control object unit positions included in M_{L} generated according to [M_Decision] is equal to or less than N_{hamilton_min}, it is possible to generate M_{L} in which the number of control object unit positions included in M_{L} is greater than N_{hamilton_min} through the following additional process. Even in such a case, high-speed heterogeneous transformation can be realized by applying a control object exchange process which will be described later.

### [M_Additional_Decision]

(1) The following (2) and (3) are repeated for M_{L} generated through [M_Decision].
(2) The control object units included in M_{L} are numbered 0, 1, 2, 3, . . . (4-1)+L×2 in the order traced by the Hamilton cycle within M_{L} to be represented as pH0, pH1, pH2, pH3, . . . , pH(4-1)+L×2.
(3) Two control object units having adjacent numbers (k and k+1. When k=(4−1)+L×2, ((4−1)+L×2)-th and 0-th) are selected in ascending order, and it is searched whether the two control object units are connected each time selection is performed and there is a path pₖ which does not pass through the control object positions included in the current M_{L} and the position of an obstacle. In a case in which the path pₖ is present, nₚ positions (pₖ1, pₖ2, pₖ3, pₖ4, . . . , pₖnₚ) in the path pₖ is added to M_{L}, and the Hamilton cycle of M_{L+1} is set to pH 0, pH 1, . . . , pH k, pₖ1, pₖ2, pₖ3, pₖ4, . . . , pₖnₚ, PH k+1, . . . , pH(4−1)+L×2. In a case in which the number of control object unit positions included in M_{L+1} does not exceed N_{hamilton_min}, processing returns to (2). In a case in which the number of control object unit positions included in M_{L+1} exceeds N_{hamilton_min}, processing is terminated. In a case in which there is no control object position which is not within additional M_{L} and does not overlap the obstacle position with respect to all adjacent control object sets in the Hamilton cycle in M_{L}, processing is terminated.

Each vertex (control object unit) position in the Hamilton cycle in M selected by [M_Decision] and [M_Additional_Decision] is defined as (Hamilton_X[k], Hamilton_Y[k], Hamilton_Z[k]) (k=0, 1, 2, . . . , Nₕₐₘᵢₗₜₒₙ−1). Nₕₐₘᵢₗₜₒₙ is the number of positions of each vertex (control object unit) of a Hamilton cycle included in M.

### [Process of Transformation of S→M]

This transformation process is divided into two processes, i.e., homogeneous transformation from S to Mpre and homogeneous transformation from Mpre to M. In M, the position of the j-th UCMM is defined as P_UCMM[j]=(X_UCMM[j], Y_UCMM[j], Z_UCMM[j]), the position of the j-th LCMM is defined as P_LCMM[j]=(X_LCMM[j], Y_LCMM[j], Z_LCMM[j]). Here, for convenience, numbering is made as follows. P_UCMM[j]=(Hamilton_X[2], Hamilton_Y[2j], Hamilton_Z[2j]),
(i) When A_max=0
P_LCMM[j]=(Hamilton_X[j]), Hamilton_Y[j], Hamilton_Z[j])
(ii) When A_max=1
(ii-i) when 0≤j≤N_{lcmm}−2
P_LCMM[j]=(Hamilton_X[j]), Hamilton_Y[j], Hamilton_Z[j])
(ii-ii) When j≥N_{lcmm}−2
P_LCMM[j]=(Hamilton_X[Nₕₐₘᵢₗₜₒₙ−2+(j−N_{lcmm}+2)], Hamilton_Y[Nₕₐₘᵢₗₜₒₙ−2+(j−N_{lcmm}+2)], Hamilton_Z[Nₕₐₘᵢₗₜₒₙ−2+(j−N_{lcmm}+2)])
(iii) When A_max=2
(iii-i) When 0≤j<N_{lcmm}−2
P_LCMM[j]=(Hamilton_X[j]), Hamilton_Y[j], Hamilton_Z[j])
(iii-ii) When j≥N_{lcmm}−2
P_LCMM[j]=(Hamilton_X[Nₕₐₘᵢₗₜₒₙ−2+(j−N_{lcmm}+2)], Hamilton_Y[Nₕₐₘᵢₗₜₒₙ−2+(j−N_{lcmm}+2)], Hamilton_Z[Nₕₐₘᵢₗₜₒₙ−2+(j−N_{lcmm}+2)])

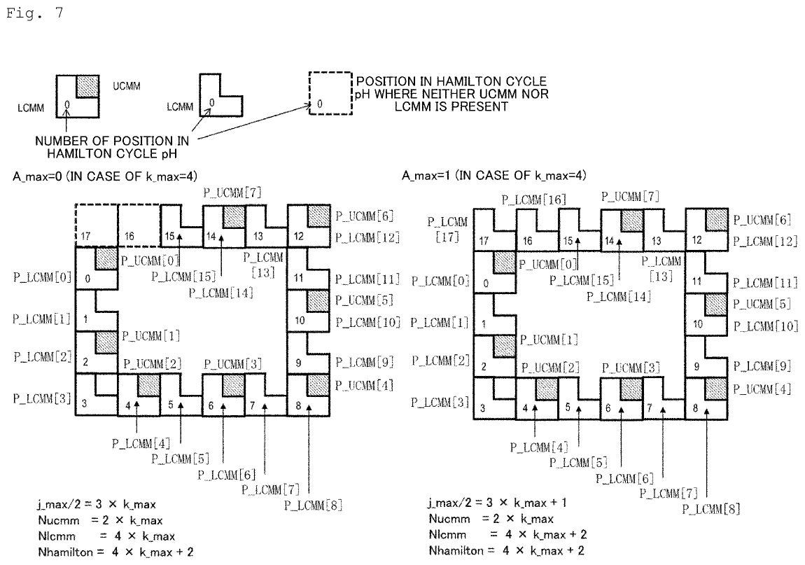

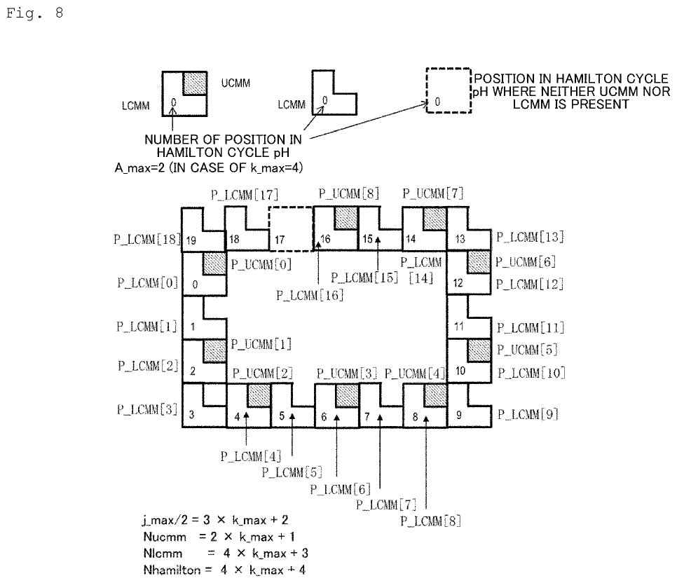

(FIGS. 7 and 8 (in the case of N_{hamilton_min}=Nₕₐₘᵢₗₜₒₙ)). As can be ascertained from the above equations and FIGS. 7 and 8, in the case of N_{hamilton_min}=Nₕₐₘᵢₗₜₒₙ, the number of control object unit positions in a (blank) Hamilton cycle pH having neither UCMM nor LCMM in M is 2 when A_max=0, 0 when A_max=1, and 1 when A_max=2. In a case in which the number Nₕₐₘᵢₗₜₒₙ of control object unit positions in the Hamilton cycle pH is greater than N_{hamilton_min}, N_add≠0, and when N_{hamilton_min}+N_add=Nₕₐₘᵢₗₜₒₙ, the number of control object unit positions in the blank Hamilton cycle pH in M is 2+N_add when A_max=0, N_add when A_max=1, and 1+N_add when A_max=2. The control object unit positions in the blank Hamilton cycle pH in M are between P_LCMM[0] and P_LCMM[N_{lcmm}−1] when A_max=0, and between P_LCMM[N_{lcmm}−2] and P_LCMM[N_{lcmm}−3] when A_max=1 and A_max=2.

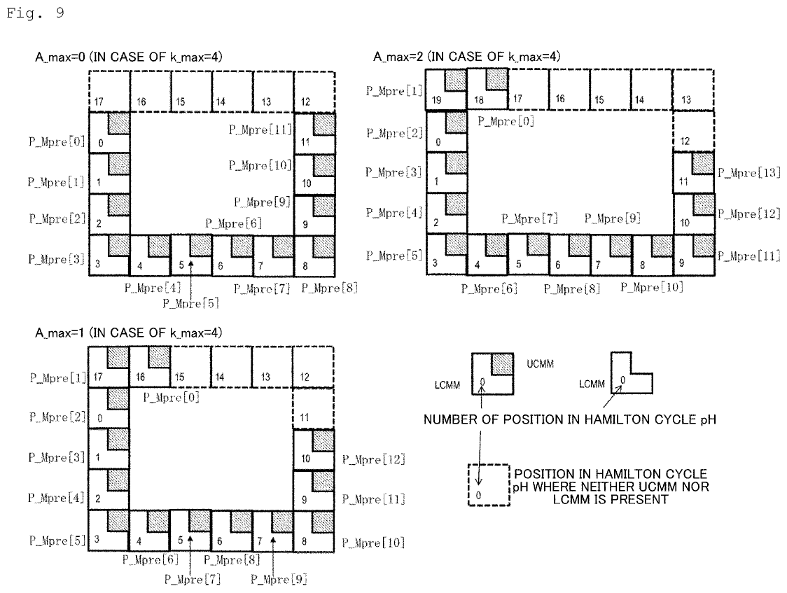

In the case of Mpre, similarly, for the convenience in the process of exchange of M→M′ which will be described later, 8-square control object positions in Mpre are numbered as P_Mpre[j]=(X_Mpre[j], Y_Mpre[j], Z_Mpre[j]) (j=0, 1, 2, . . . , j_max/2−1) as follows (FIG. 9).
(i) When A_max=0,
P_Mpre[j]=(Hamilton_X[j], Hamilton_Y[j], Hamilton_Z[j])
(ii) When A_max=1,
P_Mpre[0]=(Hamilton_X[Nₕₐₘᵢₗₜₒₙ−2], Hamilton_Y[Nₕₐₘᵢₗₜₒₙ−2], Hamilton_Z[Nₕₐₘᵢₗₜₒₙ−2])
P_Mpre[1]=(Hamilton_X[Nₕₐₘᵢₗₜₒₙ−1], Hamilton_Y[Nₕₐₘᵢₗₜₒₙ−1], Hamilton_Z[Nₕₐₘᵢₗₜₒₙ−1])
for j≥2, P_Mpre[j]=(Hamilton_X[j−2]), Hamilton_Y[j−2], Hamilton_Z[j−2])
(iii) When A_max=2,
P_Mpre[0]=(Hamilton_X[Nₕₐₘᵢₗₜₒₙ−2], Hamilton_Y[Nₕₐₘᵢₗₜₒₙ−2], Hamilton_Z[Nₕₐₘᵢₗₜₒₙ−2])
P_Mpre[1]=(Hamilton_X[Nₕₐₘᵢₗₜₒₙ−1], Hamilton_Y[Nₕₐₘᵢₗₜₒₙ−1], Hamilton_Z[Nₕₐₘᵢₗₜₒₙ−1])
for j≥2, P_Mpre[j]=(Hamilton_X[j−2]), Hamilton_Y[j−2], Hamilton_Z[j−2])

In homogeneous transformation from S to Mpre, both S and Mpre are composed of the same number of 8-square control objects, and thus transformation can be performed by an existing 8-square homogeneous transformation technique, and therefore the details thereof will be omitted here. An example of an existing 8-square homogeneous transformation technique is the method described in PCT/JP2021/025458.

Transformation from Mpre to M is performed in the following two processes (1) and (2).

(1) Each UCMM at a control object unit position from P_Mpre[j_max/2−1] to P_Mpre[j_max/2−1−j_become_lcmm] is moved to fill a Hamilton cycle position which is blank in Mpre. The value of j_become_lcmm is N_{lcmm}−j_max/2−1, that is, k_max−1 when A_max=0, k_max when A_max=1, and k_max when when A_max=2.

(2) UCMM at the control object unit position from P_Mpre[N_{ucmm}−1](=P_Mpre[j_max/2−1−j_become_lcmm−1]) to P_Mpre[0] is moved to a predetermined UCMM position in M.
Pseudo code is as follows.

### [Mpre->M_Transform]

(1) In j=0 to j_become_lcmm, UCMM at a control object unit position of P_Mpre[j_max/2−1−j] has a target position set to (Hamilton_X[N_{hamilton_min}−3−j], (Hamilton_Y[N_{hamilton_min}−3−j], (Hamilton_Z[N_{hamilton_min}−3−j]) when A_max=0 and 1, and set to (Hamilton_X[N_{hamilton_min}−4−j], (Hamilton_Y[N_{hamilton_min}−4−j], (Hamilton_Z[N_{hamilton_min}−4−j] when A_max=2 to move on LCMMs along the Hamilton cycle pH in a direction in which the number of the position within pH increases until reaching an adjacent position in the Hamilton cycle pH at each target position. Thereafter, it is transformed and moved to LCMM to each target position. The difference of the movement start time between UCMMs at P_Mpre[j_max/2−1−j] and P_Mpre[j_max/2−1−(j+1)] is set to the number of time steps required for P_Mpre[j_max/2−1−j] to be transformed and moved to LCMM.

(2) In j=0 to N_{ucmm}−1, UCMM at the control object unit position of P_Mpre[N_{ucmm}−1−j] has a target position set to P_UCMM[N_{ucmm}−1−j]=(Hamilton_x[2×(N_{ucmm}−1−j)], Hamilton_Y[2×(N_{ucmm}−1−j)], Hamilton_Z(2×[N_{ucmm}−1−j]) to move above LCMM, and moves on LCMMs along the Hamilton cycle pH in a direction in which the number of the position in pH increases until reaching each target position. The difference of the movement start time between UCMMs at P_Mpre[N_{ucmm}−1−j] and P_Mpre[N_{ucmm}−1−(j+1)] is set to the number of time steps required for each UCMM to move on LCMMs.

### [Setting of Target Position in Exchange Process]

The position exchange process in M is performed as follows. A target position of each control object i in M′ is set to target[i]. Control objects in the LCMM at P_LCMM[j] are defined as i1 [j], i2 [j], i3 [j], and i4 [j] (Rr [i][j]]=Rr[i2 [j]]=Rr[i3 [j]]=Rr[i4 [j]]=j). Control objects in the UCMM at P_UCMM[j] are defined as i5 [j], i6 [j], i7 [j], and i8 [j] (Rr[i5 [j]]=Rr[i6 [j]]=Rr[i7 [j]]=Rr[i8 [j]]=j). Here, the number of the position in the Hamilton cycle pH including the target position target[i] of each control object i is set to target_hamilton[i]. In M′, target_hamilton[i]=j when target[i] is within the LCMM at the j-th position in the Hamilton cycle pH, and target_hamilton[i]=j+Nₕₐₘᵢₗₜₒₙ when within the UCMM. A variable representing an inner position of target[i] in the UCMM or the LCMM including target[i] is defined as target_inner[i], and when target[i] is at the inner position of iX(=i1, i2, i3, 14, 15, 16, 17, 18), target_inner[i]=X. In the present invention, further attention is required to handle the target position of each control object. This because, since M and M′ do not have the same structure in general, control object units at the positions of P_LCMM[j] and P_UCMM[j] in M are not present at the same positions as those in M in M′. Since the control object position exchange process is constituted by exchange of control objects between each UCMM and LCMM, the position in M at which the UCMM or the LCMM at a control object unit position including the target position target[i] of each control object i in M′ was present must be appropriately managed (strictly speaking, when the process of performing only the operation of moving each UCMM and LCMM to transform them into M′ without performing only position exchange of control objects in the exchange process is considered, it is necessary to manage positions in pH in M′ to which the control object units at P_LCMM[j] and P_UCMM[j] in M move). A variable representing the number of the LCMM or the UCMM present at the control object unit position including the target position target[i] of each control object i is defined as target_UCMM_or_LCMM[i], target_UCMM_or_LCMM[i] is set to j when the control object i moves into the LCMM that was present at P_LCMM[i] in M, and target_UCMM_or_LCMM[i] is set to j+N_{lcmm} when moving to the UCMM at P_UCMM[i] in M. Assuming that the inner position of each control object i in the LCMM or UCMM that is a movement destination is target_inner[i], in M, a variable indicating the inner position in M where the control object at the position of target_inner[i] in M′ was present is set to target_inner_before[i] (strictly speaking, this means that the control object that was present at target_inner_before[i] in M moves to target_inner[i] in M′ when the process of performing only the operation of moving each UCMM and LCMM to transform them into M′ without performing only position exchange of control objects in the exchange process is considered).

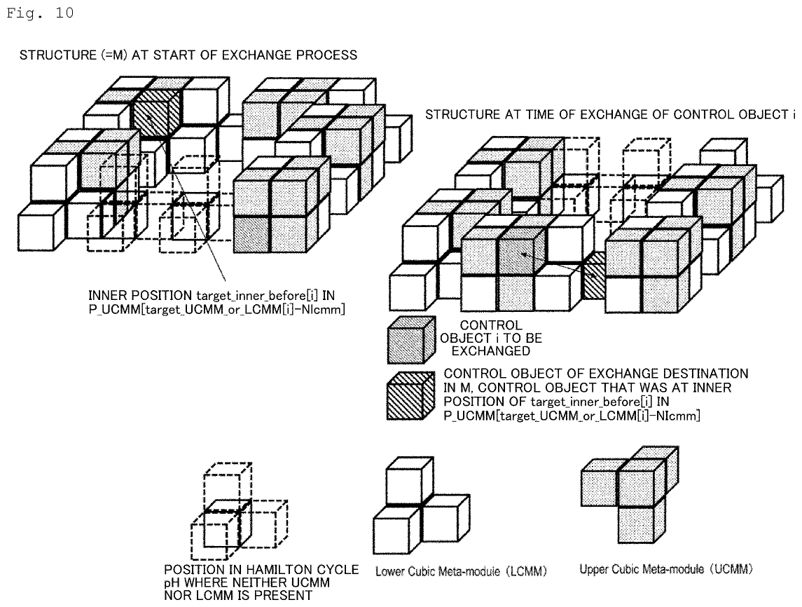

The outline of the position exchange process of the present invention is as follows. Each UCMM moves on LCMMs step by step along the Hamilton cycle pH at the same time in a direction in which the number of the position in pH increases, and if a target position of a control object within each UCMM is present within an LCMM (referred to as an exchange destination LCMM) at a position adjacent to the LCMM (LCMM paired with each UCMM to constitute a 8-square unit) on which each UCMM rides (strictly in other words, if the exchange destination LCMM is the UCMM that was present at P_UCMM[target_UCMM_or_LCMM[i]−N_{lcmm}] and has moved to that position or the LCMM that was present at P_LCMM[target_UCMM_or_LCMM[i] and has moved to that position), the operation of exchanging each control object i to be exchanged with the control object that was at target_inner_before[i] in M among control objects in the exchange destination LCMM is repeated (FIG. 10). In a case in which there is no LCMM at the movement destination position of a UCMM, the UCMM is transformed and moved to an LCMM at a void position of the movement destination (the position of a void at the position next to the position of the UCMM in the Hamilton cycle pH). Then, as the number of UCMMs decreases by one, the LCMM in which the previous position in the Hamilton cycle pH is a void is transformed and moved to a UCMM (it becomes the UCMM in the next position in the Hamilton cycle pH). Although the exchange process is completed after all control objects included in all LCMMs and UCMMs are moved to LCMMs or UCMMs including target positions of the control objects in this manner, to this end, all control object units which were UCMMs in M must be LCMMs once, and it is necessary to trace the positions of all the control object units (all of the control object units which were LCMMs and UCMMs in M) as UCMMs at least once. Similarly, all the control object units which were LCMMs in M must be UCMMs once, and when they have become UCMMs, it is necessary to trace the positions of all the control object units (all of the control object units which were LCMMs and UCMMs in M) at least once.

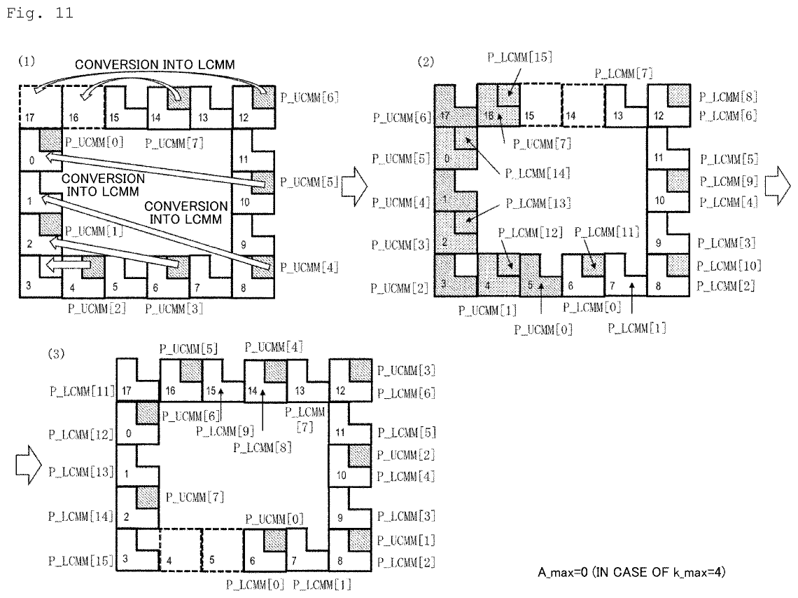

That is, before the start of the exchange process, the relationship between “the preset values of target_hamilton[i] and target_inner[i]” and target_UCMM_or_LCMM[i] and target_inner_before[i] must be accurately calculated in consideration of the operation of the above-described exchange process. Here, M′ will be described. FIG. 11 shows formation of M′ when A_max=0. (1) of FIG. 11 shows M (at the start of the exchange process). All of control object units which were UCMMs after the start of the exchange process are converted into LCMMs once (FIG. 11(2)). Thereafter, when all of them are converted into UCMMs again, the exchange process is terminated. The structure at the end of the exchange process is shown in (3), and at the same time, the structure shown in (3) is M′. Since all the control object units which were UCMMs in M are converted into LCMMs once during the exchange process, the positions of LCMMs and UCMMs in M′ have moved to positions shifted by N_{ucmm}−(2+N_add) ahead on the Hamilton cycle pH from the positions in M (naturally, the position of a void has also moved in the same manner.). That is, the positions of each UCMM and each LCMM in M′ are as follows.
(i) When A_max=0,
(i-i) when (j+N_{ucmm}−(2+N_add))≤Nₕₐₘᵢₗₜₒₙ−1
P′_LCMM[j]=(Hamilton_X[j+N_{ucmm}−(2+N_add)],
Hamilton_Y[j+N_{ucmm}−(2+N_add)],
Hamilton_Z[j+N_{ucmm}−(2+N_add)])
(i-ii) when (i+N_{ucmm}−(2+N_add))>Nₕₐₘᵢₗₜₒₙ−1
P′_LCMM[j]=(Hamilton_X[j+N_{ucmm}−(2+N_add)−Nₕₐₘᵢₗₜₒₙ],
Hamilton_Y[j+N_{ucmm}−(2+N_add)−Nₕₐₘᵢₗₜₒₙ],
Hamilton_Z[j+N_{ucmm}−(2+N_add)−Nₕₐₘᵢₗₜₒₙ]
(i-iii) when (2j+N_{ucmm}−(2+N_add))≤Nₕₐₘᵢₗₜₒₙ−1
P′_UCMM[j]=(Hamilton_X[2j+N_{ucmm}−(2+N_add)],
Hamilton_Y[2j+N_{ucmm}−(2+N_add)],
Hamilton_Z[2j+N_{ucmm}−(2+N_add)])
(i-iv) when (2j+N_{ucmm}−(2+N_add))>Nₕₐₘᵢₗₜₒₙ−1
P′_UCMM[j]=(Hamilton_X[2j+N_{ucmm}−(2+N_add)−Nₕₐₘᵢₗₜₒₙ],
Hamilton_Y[2j+N_{ucmm}−(2+N_add)−Nₕₐₘᵢₗₜₒₙ],
Hamilton_Z[2j+N_{ucmm}−(2+N_add)−Nₕₐₘᵢₗₜₒₙ]

Accordingly,
(i) when the target position of a control object i is an LCMM
(i-i) when target_hamilton[i]−(N_{ucmm}−(2+N_add))≥0
target_UCMM_or_LCMM[i]+target_hamilton[i]−(N_{ucmm}−(2+N_add))
(i-ii) when target_hamilton[i]−(N_{ucmm}−(2+N_add))<−(2+N_add) target_UCMM_or_LCMM[i]
←target_hamilton[i]−(N_{ucmm}−(2+N_add))+ (2+N_add)+N_{lcmm}

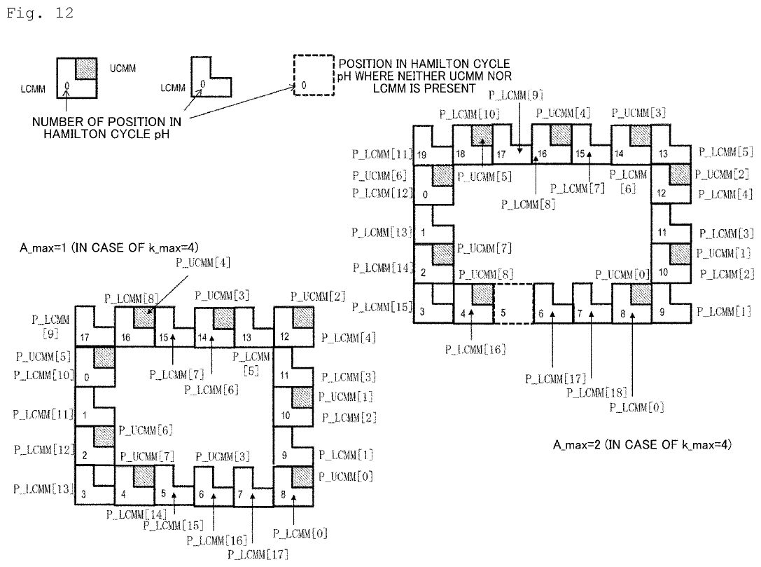

FIG. 12 shows M′ for cases in which A_max=1 and 2. Similarly, since the positions of LCMMs and UCMMs in M′ have moved to positions shifted by N_{ucmm}−(0+N_add) ahead from the positions in M on the Hamilton cycle pH when A_max=1 and the positions of LCMMs and UCMMs in M′ have moved to positions shifted by N_{ucmm}−(1+N_add) ahead from the positions in M on the Hamilton cycle pH when A_max=2,
(i) when A_max=1,
(i-i) when 0≤j<N_{lcmm}−2 and (j+N_{ucmm}−(0+N_add))≤Nₕₐₘᵢₗₜₒₙ−1
P′_LCMM[j]=(Hamilton_X[j+N_{ucmm}−(0+N_add)],
Hamilton_Y[j+N_{ucmm}−(0+N_add)],
Hamilton_Z[j+N_{ucmm}−(0+N_add)])
(i-ii) when 0≤j<N_{lcmm}−2 and (j+N_{ucmm}−(0+N_add))>Nₕₐₘᵢₗₜₒₙ−1
P′_LCMM[j]=(Hamilton_X[j+N_{ucmm}−(0+N_add)−Nₕₐₘᵢₗₜₒₙ],
Hamilton_Y[j+N_{ucmm}−(0+N_add)−Nₕₐₘᵢₗₜₒₙ],
Hamilton_Z[j+N_{ucmm}−(0+N_add)−Nₕₐₘᵢₗₜₒₙ]
(i-iii) when j≥N_{lcmm}−2 and Nₕₐₘᵢₗₜₒₙ−2+(j−N_{lcmm}+2)+N_{ucmm}−(0+N_add)≤Nₕₐₘᵢₗₜₒₙ−1
P′_LCMM[j]=(Hamilton_X[Nₕₐₘᵢₗₜₒₙ−2+(j−N_{lcmm}+2)+N_{ucmm}−(0+N_add)],
Hamilton_Y[Nₕₐₘᵢₗₜₒₙ−2+(j−N_{lcmm}+2)+N_{ucmm}−(0+N_add)],
Hamilton_Z[Nₕₐₘᵢₗₜₒₙ−2+(j−N_{lcmm}+2)+N_{ucmm}−(0+N_add)])
(i-iv) when j≥N_{lcmm}−2 and Nₕₐₘᵢₗₜₒₙ−2+(j−N_{lcmm}+2)+N_{ucmm}−(0+N_add)>Nₕₐₘᵢₗₜₒₙ−1
P′_LCMM[j]=(Hamilton_X[Nₕₐₘᵢₗₜₒₙ−2+(j−N_{lcmm}+2)+N_{ucmm}−(0+N_add)−Nₕₐₘᵢₗₜₒₙ],
Hamilton_Y[Nₕₐₘᵢₗₜₒₙ−2+(j−N_{lcmm}+2)+N_{ucmm}−(0+N_add)−Nₕₐₘᵢₗₜₒₙ],
Hamilton_Z[Nₕₐₘᵢₗₜₒₙ−2+(j−N_{lcmm}+2)+N_{ucmm}−(0+N_add)−Nₕₐₘᵢₗₜₒₙ]
(i-v) when (2j+N_{ucmm}−(0+N_add))≤Nₕₐₘᵢₗₜₒₙ−1
P′_UCMM[j]=(Hamilton_X[2j+N_{ucmm}−(0+N_add)],
Hamilton_Y[2j+N_{ucmm}−(0+N_add)],
Hamilton_Z[2j+N_{ucmm}−(0+N_add)])
(i-vi) when (2j+N_{ucmm}−(0+N_add))>Nₕₐₘᵢₗₜₒₙ−1
P′_UCMM[j]=(Hamilton_X[2j+N_{ucmm}−(0+N_add)−Nₕₐₘᵢₗₜₒₙ],
Hamilton_Y[2j+N_{ucmm}−(0+N_add)−Nₕₐₘᵢₗₜₒₙ],
Hamilton_Z[2j+N_{ucmm}−(0+N_add)−Nₕₐₘᵢₗₜₒₙ]
when A_max=2,
(ii-i) when 0≤j<N_{lcmm}−2 and (j+N_{ucmm}−(1+N_add))≤Nₕₐₘᵢₗₜₒₙ−1
P′_LCMM[j]=(Hamilton_X[j+N_{ucmm}−(1+N_add)],
Hamilton_Y[j+N_{ucmm}−(1+N_add)],
Hamilton_Z[j+N_{ucmm}−(1+N_add)])
(ii-ii) when 0≤j<N_{lcmm}−2 and (j+N_{ucmm}−(1+N_add))>Nₕₐₘᵢₗₜₒₙ−1
P′_LCMM[j]=(Hamilton_X[j+N_{ucmm}−(1+N_add)−Nₕₐₘᵢₗₜₒₙ],
Hamilton_Y[j+N_{ucmm}−(1+N_add)−Nₕₐₘᵢₗₜₒₙ],
Hamilton_Z[j+N_{ucmm}−(1+N_add)−Nₕₐₘᵢₗₜₒₙ]
(ii-iii) when j≥N_{lcmm}−2 and (Nₕₐₘᵢₗₜₒₙ−2+(j−N_{lcmm}+2)+N_{ucmm}−(1+N_add)≤Nₕₐₘᵢₗₜₒₙ−1
P′_LCMM[j]=(Hamilton_X[Nₕₐₘᵢₗₜₒₙ−2+(j−N_{lcmm}+2)+N_{ucmm}−(1+N_add)],
Hamilton_Y[Nₕₐₘᵢₗₜₒₙ−2+(j−N_{lcmm}+2)+N_{ucmm}−(1+N_add)],
Hamilton_Z[Nₕₐₘᵢₗₜₒₙ−2+(j−N_{lcmm}+2)+N_{ucmm}−(1+N_add)])
(ii-iv) when j≥N_{lcmm}−2 and (Nₕₐₘᵢₗₜₒₙ−2+(j−N_{lcmm}+2)+N_{ucmm}−(1+N_add)>Nₕₐₘᵢₗₜₒₙ−1
P′_LCMM[j]=(Hamilton_X[Nₕₐₘᵢₗₜₒₙ−2+(j−N_{lcmm}+2)+N_{ucmm}−(1+N_add)−Nₕₐₘᵢₗₜₒₙ],
Hamilton_Y[Nₕₐₘᵢₗₜₒₙ−2+(j−N_{lcmm}+2)+N_{ucmm}−(1+N_add)−Nₕₐₘᵢₗₜₒₙ],
Hamilton_Z[Nₕₐₘᵢₗₜₒₙ−2+(j−N_{lcmm}+2)+N_{ucmm}−(1+N_add)−Nₕₐₘᵢₗₜₒₙ]
(ii-v) when (2j+N_{ucmm}−(1+N_add))≤Nₕₐₘᵢₗₜₒₙ−1
P′_UCMM[j]=(Hamilton_X[2j+N_{ucmm}−(1+N_add)],
Hamilton_Y[2j+N_{ucmm}−(1+N_add)],
Hamilton_Z[2j+N_{ucmm}−(1+N_add)])
(ii-vi) when (2j+N_{ucmm}−(1+N_add))>Nₕₐₘᵢₗₜₒₙ−1
P′_UCMM[j]=(Hamilton_X[2j+N_{ucmm}−(1+N_add)−Nₕₐₘᵢₗₜₒₙ],
Hamilton_Y[2j+N_{ucmm}−(1+N_add)−Nₕₐₘᵢₗₜₒₙ],
Hamilton_Z[2j+N_{ucmm}−(1+N_add)−Nₕₐₘᵢₗₜₒₙ]

Therefore,
(i) when A_max=1
(i-i) when target_hamilton[i]−(N_{ucmm}−(0+N_add))≥−2
target_UCMM_or_LCMM[i]+target_hamilton[i]−(N_{ucmm}−(0+N_add))

As a result of the above processing, when
target_UCMM_or_LCMM[i]<0,
target_UCMM_or_LCMM[i]+target_UCMM_or_LCMM[i]+N_{lcmm}((i-i) end)
(i-ii) when target_hamilton[i]−(N_{ucmm}−(0+N_add))<−2-(0+N_add)
target_UCMM_or_LCMM[i]
←target_hamilton[i]−(N_{ucmm}−(0+N_add))+ (0+N_add)+N_{lcmm}
((i-ii) end)
(ii) When A_max=2
(ii-i) when target_hamilton[i]−(N_{ucmm}−(1+N_add))≥−2
target_UCMM_or_LCMM[i]←target_hamilton[i]−(N_{ucmm}−(1+N_add))

As a result of the above processing, when
target_UCMM_or_LCMM[i]<0,
target_UCMM_or_LCMM[i]+target_UCMM_or_LCMM[i]+N_{lcmm}((ii-i) end)
(ii-ii) when target_hamilton[i]−(N_{ucmm}−(1+N_add))<−2−(1+N_add) target_UCMM_or_LCMM[i]
←target_hamilton[i]−(N_{ucmm}−(1+N_add))+ (1+N_add)+N_{lcmm} ((ii-ii end)

When the target position of the control object i is a UCMM, target_UCMM_or_LCMM[i] for the case of LCMM is calculated first for a value after subtracting Nₕₐₘᵢₗₜₒₙ from target_hamilton[i], and the value is divided by 2 to add N_{lcmm}.

Subsequently, before the relationship between the value of target_inner[i] and the value of target_inner_before[i] is described, the operation of the control object unit used in the exchange process is defined. This is because the inner position of each control object cannot be discussed without the definition.

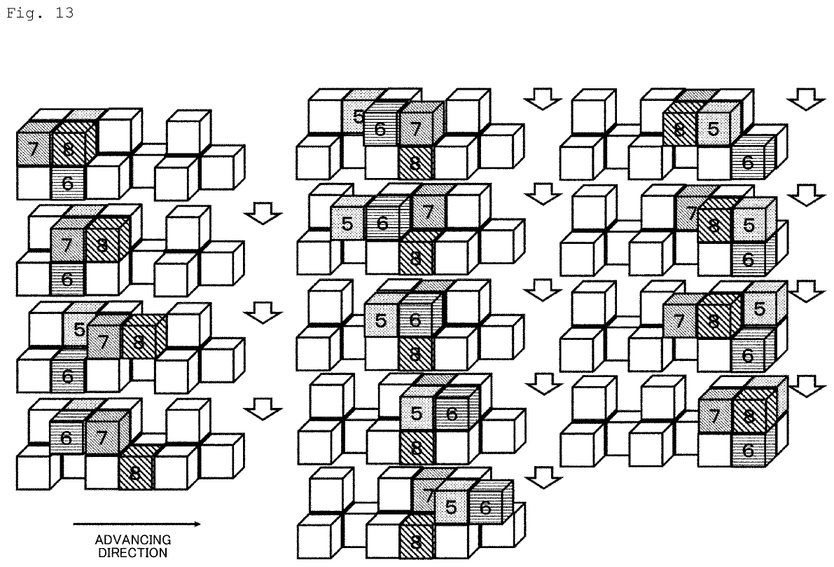

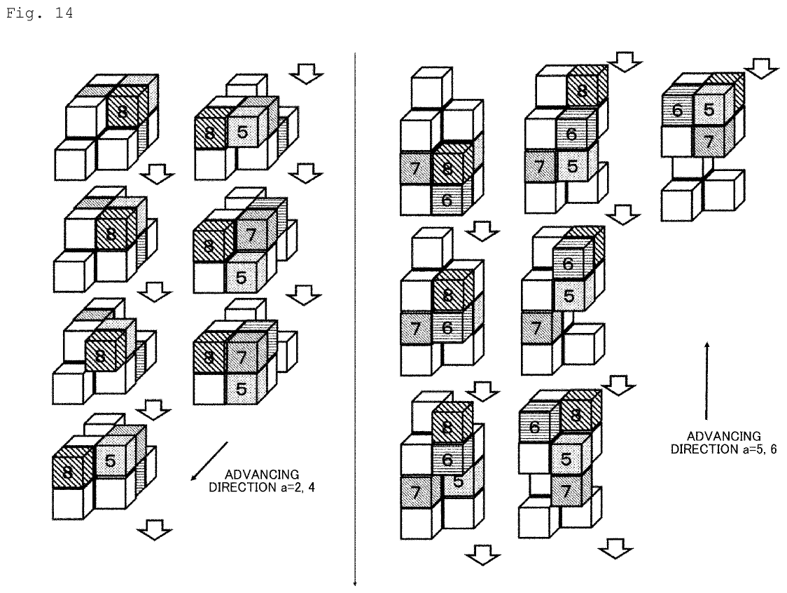

FIG. 13 shows an operation when a control object unit when it is a UCMM moves on LCMMs in the direction of a=1 and 3. FIG. 14 shows an operation when a control object unit when it is a UCMM moves on LCMMs in the direction of a=2 and 4 and moves on the LCMMs in the direction of a=5 and 6. If a UCMM at a certain control object unit position moves to an adjacent control object unit position, the position of each control object in the UCMM changes. The way of the change varies depending on the direction of movement. Functions indicating changes in the inner position are defined as fx⁺(iX), fx⁻(iX), fy⁺(iX), fy⁻(iX), fz⁺(iX), and fz⁻(iX). The functions corresponds to operations when a=1, 3, 2, 4, 5, 6.

Specifically, in the operations shown in FIGS. 13 and 14,

fx⁺(i5)=i7

fx⁺(i6)=18

fx⁺(i7)=15

fx⁺(i8)=16

fx⁺(iX)=fx⁻((iX)

fx⁺(fx⁺(iX))=fx⁻(fx⁻(iX))=fx⁺(fx⁻(iX))=fx⁻(fx⁺(iX))=iX

fy⁺(i5)=i6

fy⁺(i6)=i5

fy⁺(i7)=i8

fy⁺(i8)=i7

fy⁺(iX)=fy⁻(iX)

fy⁺(fy⁺(iX))=fy⁻(fy⁻(iX))=fy⁺(fy⁻(iX))=fy⁻(fy⁺(iX))=iX

fz⁺(i5)=18

fz⁺(i6)=17

fz⁺(i7)=i6

fz⁺(i8)=i5

fz⁺(iX)=fz⁻(iX)

fz⁺(fz⁺(iX))=fz⁻(fz⁻(iX))=fz⁺(fz⁻(iX))=fz⁻(fz⁺(iX))=iX

The features of the moving operations shown in FIGS. 13 and 14 are as follows.

(1) The inner position of a control object returns to the same position in the case of even-numbered movements in the same direction.

(2) The way of changing the inner position is the same with respect to movement in the parallel and opposite direction.

In addition to the above, the following properties are also provided.

fx⁺(fy⁺(iX))=fy⁺(fx⁺(iX))=fz⁺(iX)=fz⁻(iX)

fx⁺(fz⁺(iX))=fz⁺(fx⁺(iX))=fy⁺(iX)=fy⁻(iX)

fz⁺(fy⁺(iX))=fy⁺(fz⁺(iX))=fx⁺(iX)=fx⁻(iX)

That is, the following (3) and (4) can be said.

(3) Inner position changes when movements in different directions are combined one by one are equal to inner position changes at the time of movement in a direction that is not included in the combination.

(4) Inner position changes when movements in different directions are combined one by one is the same even if the order of movements in a direction of movement included in the combination is changed.

From the above, the following properties are naturally satisfied.

fx⁻(fy⁻(iX))=fy⁻(fx⁻(iX))=fz⁺(iX)=fz⁻(iX)

fx⁺(fy⁻(iX))=fy⁻(fx⁺(iX))=fz⁺(iX)=fz⁻(iX)

fx⁻(fy⁺(iX))=fy⁺(fx⁻(iX))=fz⁺(iX)=fz⁻(iX)

fx⁻(fz⁻(iX))=fz⁻(fx⁻(iX))=fy⁺(iX)=fy⁻(iX)

fx⁺(fz⁻(iX))=fz⁻(fx⁺(iX))=fy⁺(iX)=fy⁻(iX)

fx⁻(fz⁺(iX))=fz⁺(fx⁻(iX))=fy⁺(iX)=fy⁻(iX)

fy⁻(fz⁻(iX))=fz⁻(fy⁻(iX))=fx⁺(iX)=fx⁻(iX)

fy⁺(fz⁻(iX))=fz⁻(fy⁺(iX))=fx⁺(X)=fx⁻(iX)

fy⁻(fz⁺(iX))=fz⁺(fy⁻(iX))=fx⁺(iX)=fx⁻(iX)

By utilizing the above properties, for example, after a certain control object unit moves twice in the direction of a=1, moves once in the direction of a=2, moves three times in the direction of a=1, moves four times in the direction of a=6, moves twice in the direction of a=3, and moves three times in the direction of a=4, inner position change of a control object is calculated. The inner position of the control object which was at iX before movement has moved to

fy⁻(fy⁻(fy⁻(fx⁻(fx⁻(fz⁻(fz⁻(fz⁻(fz⁻(fx⁺(fx⁺(fx⁺(fy⁺(fx⁺(fx⁺(iX)))))))))

after movement, and this formula is simplified as follows.

fy⁻(fy⁻(fy⁻(fx⁻(fx⁻(fz⁻(fz⁻(fz⁻(fz⁻(fx⁺(fx⁺(fx⁺(fy⁺(fx⁺(fx⁺(iX)))))))))))))))=fy⁺(fy⁺(fy⁺(fx⁺(fx⁺(fz⁺(fz⁺(fz⁺(fz⁺(fx⁺(fx⁺(fx⁺(fy⁺(fx⁺(fx⁺(iX)))))=fy⁺(fy⁺(fy⁺(fy⁺(fz⁺(fz⁺(fz⁺(fz⁺(fx⁺(fx⁺(fx⁺(fx⁺(fx⁺(fx⁺(fx⁺(iX)))))==fz⁺(fz⁺(fz⁺(fz⁺(fx⁺(fx⁺(fx⁺(fx⁺(fx⁺(fx⁺(fx⁺(X)))))))))))=fx⁺(fx⁺(fx⁺(fx⁺(fx⁺(fx⁺(fx⁺(iX)))))))=fx⁺(iX)

That is, the way of changing the inner position is determined as follows only by one point of whether movement is performed odd-number times or even-number times in directions parallel to the x-axis, y-axis, and z-axis in a movement route.

Move even-number times, even-number times, and even-number times in directions parallel to the x-axis, y-axis, and z-axis, respectively.

fXₑᵥₑₙyₑᵥₑₙzₑᵥₑₙ(iX)=iX

Move even-number times, even-number times, and odd-number times in directions parallel to the x-axis, y-axis, and z-axis, respectively.

fXₑᵥₑₙyₑᵥₑₙz_{odd}(iX)=fz⁺(iX)

Move even-number times, odd-number times, and even-number times in directions parallel to the x-axis, y-axis, and z-axis, respectively.

fxₑᵥₑₙfy_{odd}fzₑᵥₑₙ(iX)=fy⁺(iX)

Move odd-number times, even-number times, and even-number times in directions parallel to the x-axis, y-axis, and z-axis, respectively.

fX_{odd}fYₑᵥₑₙfzₑᵥₑₙ(iX)=fx⁺(iX)

Move even-number times, odd-number times, and odd-number times in directions parallel to the x-axis, y-axis, and z-axis, respectively.

fXₑᵥₑₙy_{odd}z_{odd}(iX)=fy⁺(fz⁺(iX))=fx⁺(iX)

Move odd-number times, odd-number times, and even-number times in directions parallel to the x-axis, y-axis, and z-axis, respectively.

fX_{odd}fy_{odd}fzₑᵥₑₙ(iX)=fx⁺(fy⁺(iX))=fz⁺(iX)

Move odd-number times, even-number times, and odd-number times in directions parallel to the x-axis, y-axis, and z-axis, respectively.

fx_{odd}fyₑᵥₑₙfz_{odd}(iX)=fx⁺(fz⁺(iX))=fy⁺(iX)

Move odd-number times, odd-number times, and odd-number times in directions parallel to the x-axis, y-axis, and z-axis, respectively.

fX_{odd}fy_{odd}fz_{odd}(iX)=fx⁺(fy⁺(fz⁺(iX)))=fz⁺(fz⁺(iX))=iX

In the present invention, the number of control object unit positions within the Hamilton cycle pH is an even number. If a UCMM is returned to the original position after one round of pH, it is easily derived from the above formulas that change in the inner position is the same as the position before round of pH. That is, since pH is a cycle, the numbers of times of movement in the positive and negative directions are identical in movements parallel to the x, y and z axes, and the numbers of times of movement in directions parallel to the x, y and z axes are all even numbers.

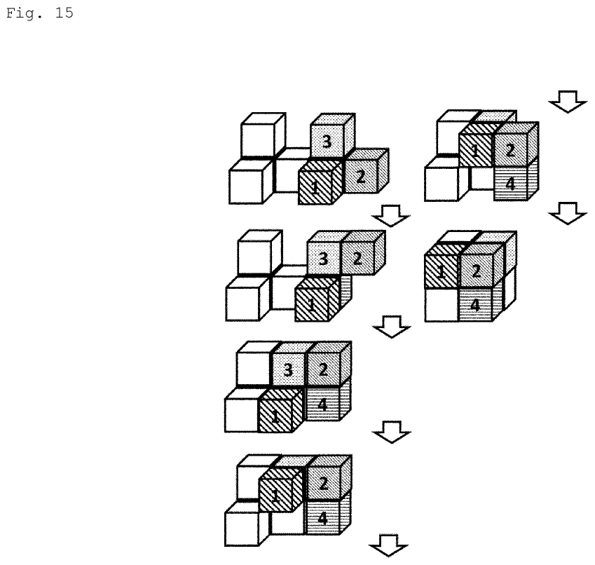

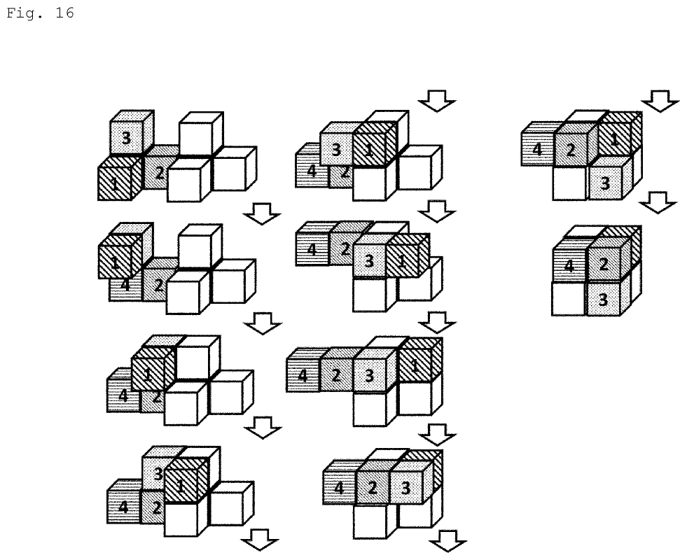

Subsequently, functions representing inner position changes when an LCMM moves to the position of an adjacent LCMM in the directions of a=1, 3, 2, 4, 5, 6 to become a UCMM are defined as fx⁺ₑₙₜₑᵣ (iX), fx⁻ₑₙₜₑᵣ (iX), fy⁺ₑₙₜₑᵣ (iX), fy⁻ₑₙₜₑᵣ (iX), fz⁺ₑₙₜₑᵣ (iX), and fz⁻ₑₙₜₑᵣ (iX), and functions representing inner position changes when a UCMM moves to the position of an adjacent void in the directions of a=1, 3, 2, 4, 5, 6 to become an LCMM are defined as fx⁺_{extract} (iX), fx⁻_{extract} (iX), fy⁺_{extract} (iX), fy⁻_{extract} (iX), fz⁺_{extract} (iX), and fz⁻_{extract} (iX). FIG. 15 shows operations in the case where an LCMM moves to the position of an adjacent LCMM in the direction of a=3 to become a UCMM and in the opposite case. In addition, FIG. 16 shows operations in the case where an LCMM moves to the position of an adjacent LCMM in the direction of a=1 to become a UCMM and in the opposite case. From FIGS. 15 and 16,

fx⁺ₑₙₜₑᵣ(i1)=i5

fx⁺ₑₙₜₑᵣ(i2)=i8

fx⁺ₑₙₜₑᵣ(i3)=i6

fx⁺ₑₙₜₑᵣ(i4)=i7

fx⁻ₑₙₜₑᵣ(i1)=i7

fx⁻ₑₙₜₑᵣ(i2)=i8

fx⁻ₑₙₜₑᵣ(i3)=i5

fx⁻ₑₙₜₑᵣ(i4)=i6

fx⁺_{extract}(i5)=i3

fx⁺_{extract}(i6)=i4

fx⁺_{extract}(i7)=i1

fx⁺_{extract}(i8)=i2

fx⁻_{extract}(i5)=i1

fx⁻_{extract}(i6)=i3

fx⁻_{extract}(i7)=i4

fx⁻_{extract}(i8)=i2

With respect to other directions, the following can be obtained by interpreting the directions of movement shown in FIGS. 15 and 16 with respect to the respective axes.

fy⁺ₑₙₜₑᵣ(i1)=i8

fy⁺ₑₙₜₑᵣ(i2)=i7

fy⁺ₑₙₜₑᵣ(i3)=i6

fy⁺ₑₙₜₑᵣ(i4)=i5

fy⁻ₑₙₜₑᵣ(i1)=i8

fy⁻ₑₙₜₑᵣ(i2)=i6

fy⁻ₑₙₜₑᵣ(i3)=i5

f⁻ₑₙₜₑᵣ(i4)=i7

fy⁻ₑₙₜₑᵣ(i5)=i3

fy⁺_{extract}(i6)=i2

fy⁺_{extract}(i7)=i4

fy⁺_{extract}(i8)=i1

fy⁻_{extract}(i5)=i4

fy⁻_{extract}(i6)=i3

fy⁻_{extract}(i7)=i2

fy⁻_{extract}(i8)=i1

fz⁺ₑₙₜₑᵣ(i1)=i5

fz⁺ₑₙₜₑᵣ(i2)=i7

fz⁺ₑₙₜₑᵣ(i3)=i8

fz⁺ₑₙₜₑᵣ(i4)=i6

fz⁻ₑₙₜₑᵣ(i1)=i7

fz⁻ₑₙₜₑᵣ(i2)=i6

fz⁻ₑₙₜₑᵣ(i3)=i8

fz⁻ₑₙₜₑᵣ(i4)=i5

fz⁺_{extract}(i5)=i4

fz⁺_{extract}(i6)=i2

fz⁺_{extract}(i7)=i1

fz⁺_{extract}(i8)=i3

fz⁻_{extract}(i5)=i1

fz⁻_{extract}(i6)=i4

fz⁻_{extract}(i7)=i2

fz⁻_{extract}(i8)=i3

As a matter of course, the following relationships are established.

fx⁻ₑₙₜₑᵣ(fx⁺_{extract}(iX))=fx⁺_{extract}(fx⁻ₑₙₜₑᵣ(iX))=iX

fx⁺ₑₙₜₑᵣ(fX⁻_{extract}(iX))=fx⁻_{extract}(fx⁺ₑₙₜₑᵣ(iX))=iX

fy⁻ₑₙₜₑᵣ(fy⁺_{extract}(iX))=fy⁺_{extract}(fy⁻ₑₙₜₑᵣ(iX))=iX

fy⁺ₑₙₜₑᵣ(fy⁻_{extract}(iX))=fy⁻_{extract}(fy⁺ₑₙₜₑᵣ(iX))=iX

fz⁺ₑₙₜₑᵣ(fz⁺_{extract}(iX))=fz⁺_{extract}(fz⁻ₑₙₜₑᵣ(iX))=iX

fz⁺ₑₙₜₑᵣ(fz⁻_{extract}(iX))=fz⁻_{extract}(fz⁺ₑₙₜₑᵣ(iX))=iX

By using the above functions, a relational expression between the value of target_inner[i] and the value of target_inner_before[i] can be obtained as will be described below.

When a control object unit including the target position of the control object i is an LCMM in M (target_UCMM_or_LCMM[i]<N)_{lcmm}, the first operation in the exchange process of the control object unit target_UCMM_or_LCMM[i] that is an LCMM in M is conversion into a UMCC, and then the UMCC moves by Nₕₐₘᵢₗₜₒₙ+(N_{ucmm}−(2+N_add)−2) steps when A_max=0, moves by Nₕₐₘᵢₗₜₒₙ+N_{ucmm}−(0+N_add)−2 steps when A_max=1, and moves by Nₕₐₘᵢₗₜₒₙ+N_{ucmm}−(1+N_add)−2 steps when A_max=2 on pH (the number of movements described here is obtained by subtracting one step from the number of steps of each movement for conversion into UCMM and re-conversion into LCMM although the control object unit that is an LCMM in M moves one round of pH during the exchange process and additionally moves by (N_{ucmm}−(2+N_add)−2) steps when A_max=0, moves by N_{ucmm}−(0+N_add)−2 steps when A_max=1, and moves by N_{ucmm}−(1+N_add)−2 steps when Z_max=2.). Thereafter, it is finally converted into the LCMM. That is, if even/odd of the number of times of movement in the direction of movement at the time of the first conversion into the UCMM, the direction of movement at the time of the last re-conversion into the LCMM, and directions parallel to the x, y, and z-axes at the time of movement as the UCMM is determined, change in the inner position of the control object included in the control object unit target_UCMM_or_LCMM[i] between N and M′ can be calculated. Code for calculating the value of target_inner_before[i] when the control object unit including the target position of the control object i is an LCMM in M is [LCMM_inner_transform(i)] which is illustrated below.

### [LCMM_inner_transform(i)]

(1) When the direction of movement to the next position P_start at the time of moving by tracing pH of an LCMM at the position of P_LCMM[target_UCMM_or_LCMM[i] in M is defined as a_start,

when a_start=1,fₑₙₜₑᵣ(iX)←fx⁺ₑₙₜₑᵣ(iX)

when a_start=2,fₑₙₜₑᵣ(iX)←fy⁺ₑₙₜₑᵣ(iX)

when a_start=3,fₑₙₜₑᵣ(iX)←fx⁻ₑₙₜₑᵣ(iX)

when a_start=4,fₑₙₜₑᵣ(iX)←fy⁻ₑₙₜₑᵣ(iX)

when a start=5,fₑₙₜₑᵣ(iX)←fz⁺ₑₙₜₑᵣ(iX)

when a_start=6,fₑₙₜₑᵣ(iX)←fz⁻ₑₙₜₑᵣ(iX)

are defined.

(2) When the reverse direction of the direction of movement to the next position P_end at the time of moving by tracing pH of an LCMM at the position of P′_LCMM[target_UCMM_or_LCMM[i] in M′ in the reverse direction is defined as a_start,

when a_end=1,f_{extract}(iX)←fx⁺_{extract}(iX)

when a_end=2,f_{extract}(iX)←fy⁺_{extract}(iX)

when a_end=3,f_{extract}(iX)←fx⁻_{extract}(iX)

when a_end=4,f_{extract}(iX)←fy⁻_{extract}(iX)

when a_end=5,f_{extract}(iX)←fz⁺_{extract}(iX)

when a_end=6,f_{extract}(iX)←fz⁻_{extract}(iX)

are defined.

(3) When a function representing change in the inner position of a control object in a UCMM when the UCMM moves along the Hamilton cycle pH from P_start to P_end is defined as fₘₒᵥ(iX), and the numbers of times of movement in directions parallel to the x, y and z-axes are set to nx, ny, and nz, when nx, ny, and nz are an even number, an even number, and an even number, respectively,

fₘₒᵥ(iX)←fXₑᵥₑₙyₑᵥₑₙzₑᵥₑₙ(iX)=ix

when nx, ny, and nz are an even number, an even number, and an odd number, respectively,

fₘₒᵥ(iX)←fXₑᵥₑₙyₑᵥₑₙz_{odd}(iX)=fz⁺(iX)

when nx, ny, and nz are an even number, an odd number, and an even number, respectively,

fₘₒᵥ(iX)←fxₑᵥₑₙfy_{odd}fzₑᵥₑₙ(iX)=fy⁺(iX)

when nx, ny, and nz are an odd number, an even number, and an even number, respectively,

fₘₒᵥ(iX)+fz_{odd}fyₑᵥₑₙfzₑᵥₑₙ(iX)=fx⁺(iX)

when nx, ny, and nz are an even number, an odd number, and an odd number, respectively,

fₘₒᵥ(iX)←fxₑᵥₑₙy_{odd}z_{odd}(iX)=fx⁺(iX)

when nx, ny, and nz are an odd number, an odd number, and an even number, respectively,

fₘₒᵥ(iX)←fx_{odd}fy_{odd}fzₑᵥₑₙ(iX)=fz⁺(iX)

when nx, ny, and nz are an odd number, an even number, and an odd number, respectively,

fₘₒᵥ(iX)←fX_{odd}fyₑᵥₑₙfz_{odd}(iX)=fy⁺(iX)

when nx, ny, and nz are an odd number, an odd number, and an odd number, respectively,

fₘₒᵥ(iX)←fX_{odd}fy_{odd}fz_{odd}(iX)=iX

are defined.

(4) When a function representing change in the inner position of a control object within the control object unit target_UCMM_or_LCMM[i] is defined as f_{perm_lcmm}(iX) in the exchange process,

f_{perm_lcmm}(iX)=f_{extract}(fₘₒᵥ(fₑₙₜₑᵣ(iX)))

is provided.

When f_{perm_lcmm}(iX)=target_inner[i],target_inner_before[i]←iX

When the control object unit including the target position of the control object i is a UCMM in M (target_UCMM_or_LCMM[i]>N_{lcmm}−1), the first operation in the exchange process of the control object unit target_UCMM_or_LCMM[i] in M is movement on pH to a place where the UMCC is to be converted into an LCMM, and then the UMCC is converted into the LCMM. The number of steps of movement on pH to the place where the UCMM is to be converted to the LCMM is 3*(N_{ucmm}−1−j)+1 when A_max=0, 3*(N_{ucmm}−1−j)+1 when A_max=1, and 3*(N_{ucmm}−1−j) when A_max=2 in the j-th UCMM. After converted into the LCMM, the LCMM stops for a while and re-converted into the UCMM. After re-conversion into the UCMM, the UCMM moves by Nₕₐₘᵢₗₜₒₙ+ (N_{ucmm}−(2+N_add))−(3*(N_{ucmm}−1−j)+1)-2 steps when A_max=0, moves by Nₕₐₘᵢₗₜₒₙ+N_{ucmm}−(0+N_add)−(3*(N_{ucmm}−1−j)+1)-2 steps when A_max=1, and moves by Nₕₐₘᵢₗₜₒₙ+N_{ucmm}−(1+N_add)−(3*(N_{ucmm}−1−j))−2 when A_max=2 on pH.

That is, if even/odd of the number of times of movement in the directions parallel to the x, y and z-axes at the time of moving as the UCMM before the first conversion into the LCMM, even/odd of the number of times of movement in the directions parallel to the x, y and z-axes at the time of moving as the UCMM after re-conversion into the UCMM, the direction of movement at the time of the first conversion into the LCMM, and the direction of movement at the time of re-conversion into the UCMM are determined, change in the inner position of a control object included in the control object unit target_UCMM_or_LCMM[i] between M and M′ can be calculated. Code for calculating the value of target_inner_before[i] when the control object unit including the target position of the control object i is a UCMM in M is [UCMM_inner_transform(i)] illustrated below.

### [UCMM_inner_transform(i)]

(1) It is assumed that pre_move=3*(N_{ucmm}−1−j)+1 when A_max=0, 1 and pre_move=3*(N_{ucmm}−1−j) when A_max=2. When a function representing change in the inner position of the control object within the UCMM when it has moved by pre_move step along the Hamilton cycle pH to a position immediately before the UCMM is converted into an LCMM from P_UCMM[target_UCMM_or_LCMM[i]−N_{lcmm}] when 2×(target_UCMM_or_LCMM[i]−N_{lcmm})+pre_move<Nₕₐₘᵢₗₜₒₙ (Hamilton_X[2×(target_UCMM_or_LCMM[i]−N_{lcmm})+pre_move], Hamilton_Y[2×(target_UCMM_or_LCMM[i]−N_{lcmm})+pre_move], Hamilton_Z[2×(target_UCMM_or_LCMM[i]−N_{lcmm})+pre_move]) when 2×(target_UCMM_or_LCMM[i]−N_{lcmm})+pre_move≥Nₕₐₘᵢₗₜₒₙ (Hamilton_X[2×(target_UCMM_or_LCMM[i]−N_{lcmm})+pre_move−Nₕₐₘᵢₗₜₒₙ], Hamilton_Y[2×(target_UCMM_or_LCMM[i]−N_{lcmm})+pre_move−Nₕₐₘᵢₗₜₒₙ], Hamilton_Z[2×(target_UCMM_or_LCMM[i]−N_{lcmm})+pre_move−Nₕₐₘᵢₗₜₒₙ]) is defined as f_{mov_pre}(iX), and the numbers of times of movement in the directions parallel to the x, y and z-axes are set to nx, ny, and nz,

when nx, ny, and nz are an even number, an even number, and an even number, respectively,

f_{mov_pre}(iX)←fXₑᵥₑₙyₑᵥₑₙzₑᵥₑₙ(iX)=ix

when nx, ny, and nz are an even number, an even number, and an odd number, respectively,

f_{mov_pre}(iX)+fXₑᵥₑₙyₑᵥₑₙz_{odd}(iX)=fz⁺(iX)

when nx, ny, and nz are an even number, an odd number, and an even number, respectively,

f_{mov_pre}(iX)+fXₑᵥₑₙfy_{odd}fzₑᵥₑₙ(iX)=fy⁺(iX)

when nx, ny, and nz are an odd number, an even number, and an even number, respectively,

f_{mov_pre}(iX)+fx_{odd}fyₑᵥₑₙfzₑᵥₑₙ(iX)=fx⁺(iX)

when nx, ny, and nz are an even number, an odd number, and an odd number, respectively,

f_{mov_pre}(iX)←fxₑᵥₑₙy_{odd}z_{odd}(iX)=fx⁺(iX)

when nx, ny, and nz are an odd number, an odd number, and an even number, respectively,

f_{mov_pre}(iX)←fx_{odd}fy_{odd}fzₑᵥₑₙ(iX)=fz⁺(iX)

when nx, ny, and nz are an odd number, an even number, and an odd number, respectively,

f_{mov_pre}(iX)←fX_{odd}fyₑᵥₑₙfz_{odd}(iX)=fy⁺(iX)

when nx, ny, and nz are an odd number, an odd number, and an odd number, respectively,

f_{mov_pre}(iX)←fx_{odd}fy_{odd}fz_{odd}(iX)=ix

are defined.

(2) when 2×(target_UCMM_or_LCMM[i]−N_{lcmm})+pre_move<Nₕₐₘᵢₗₜₒₙ (Hamilton_X[2×(target_UCMM_or_LCMM[i]−N_{lcmm})+pre_move], Hamilton_Y[2×(target_UCMM_or_LCMM[i]−N_{lcmm})+pre_move], Hamilton_Z[2×(target_UCMM_or_LCMM[i]−N_{lcmm})+pre_move]) when 2×(target_UCMM_or_LCMM[i]−N_{lcmm})+pre_move≥Nₕₐₘᵢₗₜₒₙ (Hamilton_X[2×(target_UCMM_or_LCMM[i]−N_{lcmm})+pre_move−Nₕₐₘᵢₗₜₒₙ], Hamilton_Y[2×(target_UCMM_or_LCMM[i]−N_{lcmm})+pre_move−Nₕₐₘᵢₗₜₒₙ], Hamilton_Z[2×(target_UCMM_or_LCMM[i]−N_{lcmm})+pre_move−Nₕₐₘᵢₗₜₒₙ]) When the direction of movement to the next position P_start when the UCMM at the position above has moved by tracing pH is defined as a_start,

when a start=1,f_{extract}(X)←fx⁺_{extract}(iX)

when a start=2,f_{extract}(iX)←fy⁺_{extract}(iX)

when a_start=3,f_{extract}(iX)←fx⁻_{extract}(iX)

when a_start=4,f_{extract}(iX)+fy⁻_{extract}(iX)

when a_start=5,f_{extract}(iX)←fz⁺_{extract}(iX)

when a_start=6,f_{extract}(iX)←fz⁻_{extract}(iX)

are defined.

(3) When 2×(target_UCMM_or_LCMM[i]−N_{lcmm})+pre_move+1<Nₕₐₘᵢₗₜₒₙ (Hamilton_X[2×(target_UCMM_or_LCMM[i]−N_{lcmm})+pre_move+1], Hamilton_Y[2×(target_UCMM_or_LCMM[i]−N_{lcmm})+pre_move+1], Hamilton_Z[2×(target_UCMM_or_LCMM[i]−N_{lcmm})+pre_move+1]) When 2×(target_UCMM_or_LCMM[i]−N_{lcmm})+pre_move+1≥Nₕₐₘᵢₗₜₒₙ (Hamilton_X[2×(target_UCMM_or_LCMM[i]−N_{lcmm})+pre_move+1-Nₕₐₘᵢₗₜₒₙ], Hamilton_Y[2×(target_UCMM_or_LCMM[i]−N_{lcmm})+pre_move+1−Nₕₐₘᵢₗₜₒₙ], Hamilton_Z[2×(target_UCMM_or_LCMM[i]−N_{lcmm})+pre_move+1−Nₕₐₘᵢₗₜₒₙ])

When the direction of movement to the next position P_end when the LCMM at the position above has moved by tracing pH is defined as a_end,

when a_end=1,fₑₙₜₑᵣ(iX)←fx⁺ₑₙₜₑᵣ(iX)

when a_end=2,fₑₙₜₑᵣ(iX)←fy⁺ₑₙₜₑᵣ(iX)

when a_end=3,fₑₙₜₑᵣ(iX)←fx⁻ₑₙₜₑᵣ(iX)

when a_end=4,fₑₙₜₑᵣ(iX)←fy⁻ₑₙₜₑᵣ(iX)

when a_end=5,fₑₙₜₑᵣ(iX)←fz⁺ₑₙₜₑᵣ(iX)

when a_end=6,fₑₙₜₑᵣ(iX)←fz⁻ₑₙₜₑᵣ(iX)

are defined.

(4) On the assumption that, when A_max=0,

post_move←Nₕₐₘᵢₗₜₒₙ+(N_{ucmm}−(2+N_add))−(3*(N_{ucmm}−1−j)+1)−2 when A_max=1,

post_move←Nₕₐₘᵢₗₜₒₙ+N_{ucmm}−(0+N_add)−(3*(N_{ucmm}−1−j)+1)−2 when A_max=2,

post_move←Nₕₐₘᵢₗₜₒₙ+N_{ucmm}−(1+N_add)−(3*(N_{ucmm}−1−j))−2,

when a function representing change in the inner position of the control object within the UCMM when the UCMM has moved by post_move step along the Hamilton cycle pH from the position defined as, when 2×(target_UCMM_or_LCMM[i]−N_{lcmm})+pre_move+2<Nₕₐₘᵢₗₜₒₙ, (Hamilton_X[2×(target_UCMM_or_LCMM[i]−N_{lcmm})+pre_move+2], Hamilton_Y[2×(target_UCMM_or_LCMM[i]−N_{lcmm})+pre_move+2], Hamilton_Z[2×(target_UCMM_or_LCMM[i]−N_{lcmm})+pre_move+2]) When 2×(target_UCMM_or_LCMM[i]−N_{lcmm})+pre_move2≥Nₕₐₘᵢₗₜₒₙ (Hamilton_X[2×(target_UCMM_or_LCMM[i]−N_{lcmm})+pre_move+2−Nₕₐₘᵢₗₜₒₙ], Hamilton_Y[2×(target_UCMM_or_LCMM[i]−N_{lcmm})+pre_move+2−Nₕₐₘᵢₗₜₒₙ], Hamilton_Z[2×(target_UCMM_or_LCMM[i]−N_{lcmm})+pre_move+2−Nₕₐₘᵢₗₜₒₙ]),
to P′_UCMM[target_UCMM_or_LCMM[i]−N_{lcmm}] is defined as f_{mov_post}(iX), and the numbers of times of movement in the directions parallel to the x, y and z-axes are set to nx, ny, and nz,
   when nx, ny, and nz are an even number, an even number, and an even number, respectively,

f_{mov_post}(iX)←fxₑᵥₑₙyₑᵥₑₙzₑᵥₑₙ(iX)=ix

when nx, ny, and nz are an even number, an even number, and an odd number, respectively,

f_{mov_post}(iX)←fzₑᵥₑₙyₑᵥₑₙz_{odd}(iX)=fz⁺(iX)

when nx, ny, and nz are an even number, an odd number, and an even number, respectively,

f_{mov_post}(iX)+fXₑᵥₑₙfy_{odd}fzₑᵥₑₙ(iX)=fy⁺(iX)

when nx, ny, and nz are an odd number, an even number, and an even number, respectively,

f_{mov_post}(iX)←fz_{odd}fyₑᵥₑₙfzₑᵥₑₙ(iX)=fx⁺(iX)

when nx, ny, and nz are an even number, an odd number, and an odd number, respectively,

f_{mov_post}(iX)←fxₑᵥₑₙy_{odd}z_{odd}(iX)=fx⁺(iX)

when nx, ny, and nz are an odd number, an odd number, and an even number, respectively,

f_{mov_post}(iX)←fx_{odd}fy_{odd}fzₑᵥₑₙ(iX)=fz⁺(iX)

when nx, ny, and nz are an odd number, an even number, and an odd number, respectively,

f_{mov_post}(iX)←fx_{odd}fyₑᵥₑₙfz_{odd}(iX)=fy⁺(iX)

when nx, ny, and nz are an odd number, an odd number, and an odd number, respectively,

f_{mov_post}(iX)←fx_{odd}fy_{odd}fz_{odd}(iX)=ix

are defined.

(5) When a function representing change in the inner position of the control object within the control object unit target_UCMM_or_LCMM[i] in the exchange process is defined as f_{perm_ucmm}(iX),

f_{perm_ucmm}(iX)=f_{mov_post}(fₑₙₜₑᵣ(f_{extract}(f_{mov_pre}(iX))))

is provided.

When f_{perm_ucmm}(iX)=target_inner[i], target_inner_before[i]-ix.

As a result, the algorithm of setting an exchange target position is as follows.

### [Predict_Inner_Transform]

(1) The following calculation is performed for all control objects i.

When a control object unit including a target position of a control object i is an LCMM,
(i) when A_max=0
(i-i) when target_hamilton[i]−(N_{ucmm}−(2+N_add))≥0
target_UCMM_or_LCMM[i]+target_hamilton[i]−(N_{ucmm}−(2+N_add))
(i-ii) target_hamilton[i]−(N_{ucmm}−(2+N_add))<−(2+N_add) target_UCMM_or_LCMM[i]
←target_hamilton[i]−(N_{ucmm}−(2+N_add))+ (2+N_add)+N_{lcmm}
(ii) When A_max=1
(ii-i) when target_hamilton[i]−(N_{ucmm}−(0+N_add))≥−2 target_UCMM_or_LCMM[i]+target_hamilton[i]−(N_{ucmm}−(0+N_add))
when target_UCMM_or_LCMM[i]<0,
target_UCMM_or_LCMM[i]+target_UCMM_or_LCMM[i]+N_{lcmm}((ii-i) end)
(ii-ii) when target_hamilton[i]−(N_{ucmm}−(0+N_add))<−2-(0+N_add)
target_UCMM_or_LCMM[i]
←target_hamilton[i]−(N_{ucmm}−(0+N_add))+ (0+N_add)+N_{lcmm}
((ii-ii end)
(iii) when A_max=2
(iii-i) target_hamilton[i]−(N_{ucmm}−(1+N_add))≥−2
when target_UCMM_or_LCMM[i]+target_hamilton[i]−(N_{ucmm}−(1+N_add)) target_UCMM_or_LCMM[i]<0,
target_UCMM_or_LCMM[i]+target_UCMM_or_LCMM[i]+N_{lcmm} ((iii-i) end)
(iii-ii) when target_hamilton[i]−(N_{ucmm}−(1+N_add))<−2−(1+N_add)
target_UCMM_or_LCMM[i]
←target_hamilton[i]−(N_{ucmm}−(1+N_add))+ (1+N_add)+N_{lcmm} ((iii-ii) end)

When a control object unit including a target position of the control object i is a UCMM, target_UCMM_or_LCMM when the control object unit including the target position of the control object i is an LCMM is calculated, and target_UCMM_or_LCMM[i]-target_UCMM_or_LCMM[i]/2+N_{lcmm} is defined.

(2) For all the control objects i, (2-1) UCMM_inner_transform(i) is executed when target_UCMM_or_LCMM[i]≥N_{lcmm}, and (2-2) LCMM_inner_transform(i) is executed when target_UCMM_or_LCMM[i]<N_{lcmm}.

### [Position Exchange Process at Intermediate Position M]

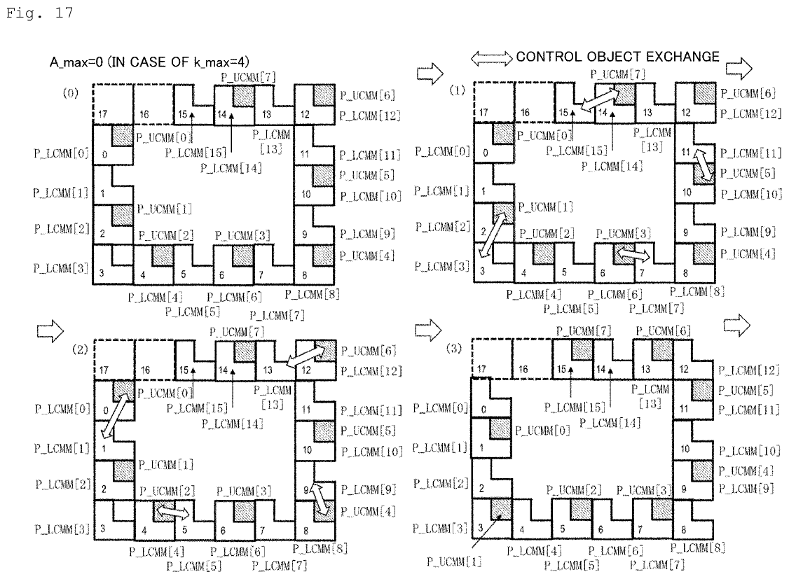

FIGS. 17 to 27 show operations of the exchange process in the case of each value of A_max. The operations are mainly performed by UCMMs in the exchange process. UCMMs simultaneously move on LCMMs along the Hamilton cycle pH. The operations shown in FIGS. 17, 18 and 19 shows a process in which one UCMM having no LCMM at a control object unit position that is a movement destination thereof is converted into an LCMM, and one LCMM is converted into a UCMM such that no LCMM is present and a void is present at the previous position from that position in the Hamilton cycle pH in the case of A_max=0 (when Nₕₐₘᵢₗₜₒₙ=N_{hamilton_min}). By repeating the operations shown in FIGS. 17, 18 and 19 N_{ucmm} times, conversion of all UCMMs into LCMMs is completed. Then, by further repeating the operations N_{lcmm}-N_{ucmm} times, conversion of all the LCMMs into UCMMs is terminated. Thereafter, by further repeating the operations N_{ucmm} times, re-conversion of all the UCMMs into UCMMs is completed and the exchange process is terminated.

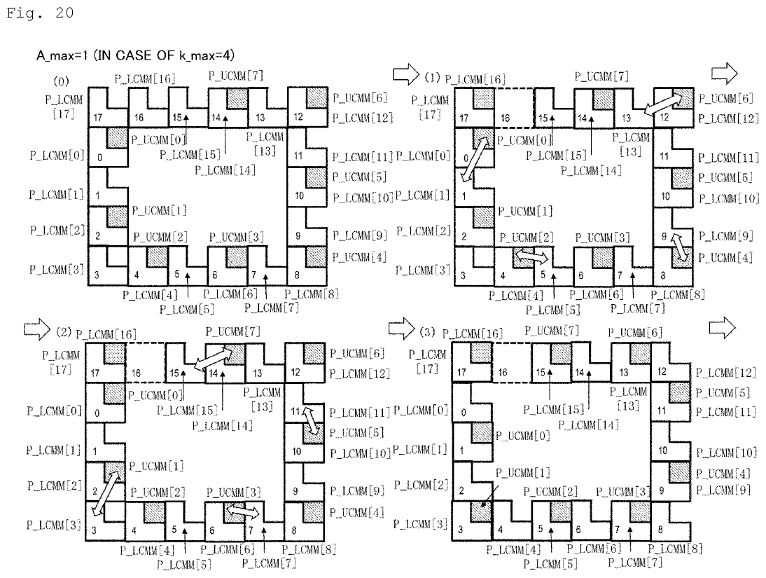

Similarly, the operations shown in FIGS. 20, 21 and 22 shows a process in which one UCMM having no LCMM at a control object unit position that is a movement destination thereof is converted into an LCMM, and one LCMM is converted into a UCMM such that no LCMM is present and a void is present at the previous position from that position in the Hamilton cycle pH in the case of A_max=1 (when Nₕₐₘᵢₗₜₒₙ=N_{hamilton_min}). By repeating the operations shown in FIGS. 20, 21, and 22 N_{ucmm} times, conversion of all UCMMs into LCMMs is completed. Then, by further repeating the operations N_{lcmm}-N_{ucmm} times, conversion of all the LCMMs into UCMMs is terminated. Thereafter, by further repeating the operations N_{ucmm} times, re-conversion of all the UCMMs into UCMMs is completed and the exchange process is terminated.

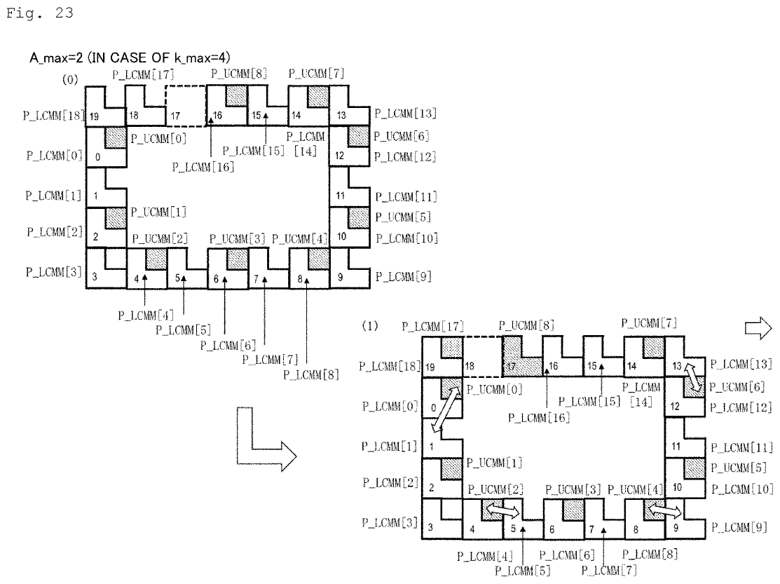

Similarly, the operations shown in FIGS. 23, 24, 25, 26, and 27 shows a process in which one UCMM having no LCMM at a control object unit position that is a movement destination thereof is converted into an LCMM, and one LCMM is converted into a UCMM such that no LCMM is present and a void is present at the previous position from that position in the Hamilton cycle pH in the case of A_max=2 (when Nₕₐₘᵢₗₜₒₙ=N_{hamilton_min}). By repeating the operations shown in FIGS. 23, 24, 25, 26, and 27 N_{ucmm} times, conversion of all UCMMs into LCMMs is completed. Then, by further repeating the operations N_{lcmm}-N_{ucmm} times, conversion of all the LCMMs into UCMMs is terminated.

Thereafter, by further repeating the operations N_{ucmm} times, re-conversion of all the UCMMs into UCMMs is completed and the exchange process is terminated.

During such an exchange process, while all control object units are converted into UCMMs and moves, the control objects included therein are moved into control objects (which have been converted into LCMMs at that time) including target positions thereof. In addition, all the control object units pass their positions through all other control object units converted into UCMMs while they are converted into LCMMs.

In the exchange process, the exchange operation of the position of each control object is executed only when the exchange operation of a control object is not executed in the adjacent UCMM in principle. That is, in the operation steps shown in FIGS. 17 to 27, at most two steps are required for all the UCMMs to complete the control object exchange operation at the positions thereof. The exception is (5) when A_max=0, (8) when A_max=1, and (8) when A_max=2. The reason why these operations are exceptional is that, although each UCMM normally exchanges the control object with an LCMM at the previous position from the control object unit position thereof in the Hamilton cycle pH, the control object unit converted into a UCMM at the latest time performs exchange of the control object with the LCMM at the previous position from the control object unit position in the Hamilton cycle pH in such an operation, and thus a control object is not connected even if an adjacent UCMM performs the control object exchange operation. Hereinafter, pseudo code of the exchange process at each value of A_max will be described.

### [Permutation_M_M′_A_max 0]

(1) The control object currently converted into a UCMM is defined as UCMM_NOW[j] (j=0, 1, 2, . . . , 2×k_max−1). It is assumed that j=0 for a control object which is converted into a UCMM at a position where it can reach a void position in the advancing direction with the smallest number of movement steps, and the value of j increases as the number of movement steps required to reach the void position in the advancing direction increases.

(2) (3) to (11) below are repeated N_{lcmm}+N_{ucmm} times.

(3) In each UCMM_NOW[j] where j is an even number, an exchange operation Position_Exchange_Fore(UCMM_NOW[j]) is simultaneously executed by the LCCM at the next position from each position in the Hamilton cycle pH and each UCCM_NOW[j] where j is an even number. At the same time, in each UCMM_NOW[j] where j is an odd number, in Position_Exchange_Fore( ) in both UCMM_NOW[j−1] and UCMM_NOW[j+1], the exchange operation

Position_Exchange_Fore(UCMM_NOW[j]) is simultaneously executed by the LCMM at the next position from each position in the Hamilton cycle pH and each UCMM_NOW[j] where j is an odd number only in a case in which the actual exchange operation is not necessary (FIG. 17(1)).

(4) In each UCMM_NOW[j] where j is an odd-number, in a UCMM_NOW[j] in which the exchange operation is not executed in (3), the exchange operation

Position_Exchange_Fore(UCMM_NOW[j]) is executed by the LCMM at the next position from each position in the Hamilton cycle pH and each UCMM_NOW[j] where j is an odd number (FIG. 17(2)).

(5) All UCMMs are simultaneously moved in the forward direction along the Hamilton cycle pH by one step (FIG. 17(3)).

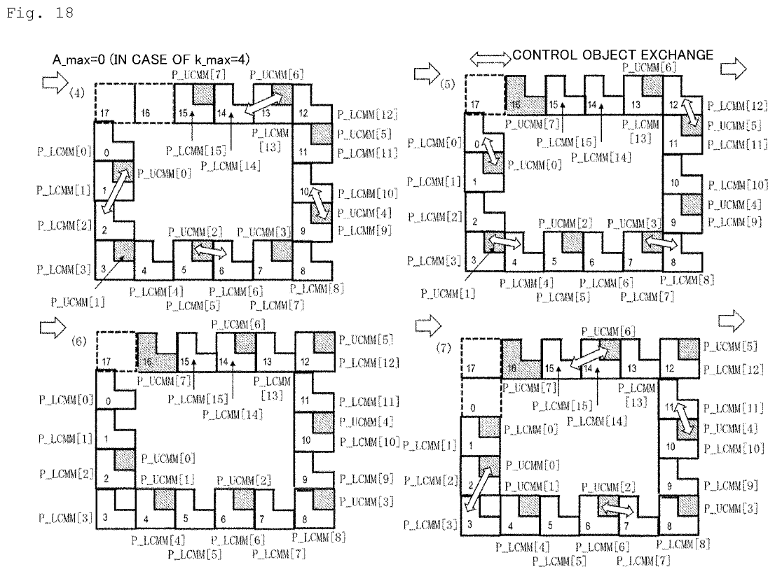

(6) In each UCMM_NOW (j) where j is an odd number, the exchange operation Position_Exchange_Fore(UCMM_NOW[j]) is executed by the LCMM at the next position from each position in the Hamilton cycle pH and each UCMM_NOW[j] where j is an odd number. At the same time, in each UCMM_NOW[j] where j>0 and j is an even number, in Position_Exchange_Fore( ) in both UCMM_NOW[j−1] and UCMM_NOW[j+1], the exchange operation Position_Exchange_Fore(UCMM_NOW[j]) is executed by the LCMM at the next position from each position in the Hamilton cycle pH and each UCMM_NOW[j] where j is an even number only in a case in which the actual exchange operation is not necessary. In Position_Exchange_Fore( ) in UCMM_NOW[2×k_max−1], Position_Exchange_Aft( ) in UCMM_NOW[2×k_max−1] is executed only in a case in which there is no actual exchange operation (FIG. 18(4)).

(7) UCMM_NOW[0] is converted into an LCMM. At the same time, in each UCMM_NOW[j] where j>0 and j is an even-number, in UCMM_NOW[j] in which the exchange operation is not performed in (6), the exchange operation Position_Exchange_Fore(UCMM_NOW[j]) is executed by the LCMM at the next position from each position in the Hamilton cycle pH and each UCMM_NOW[j] where j is an even number. In a case in which Position_Exchange_Aft( ) in UCMM_NOW[2×k_max−1] is not executed in (6), Position_Exchange_Aft( ) in UCMM_NOW[2×k_max−1] is executed. UCMM_NOW[j]+UCMM_NOW[j+1] is set. UCMM_NOW[2×k_max−1] is set as a missing number (FIG. 18(5)).

(8) All UCMMs are simultaneously moved in the forward direction along the Hamilton cycle pH by one step (FIG. 18(6)).

(9) An LCMM at a position requiring the largest number of movement steps to reach a void position in the advancing direction along the Hamilton cycle pH is converted into a UCMM and set as UCMM_NOW[2×k_max−1]. At the same time, in each UCMM_NOW[j] where j is an even number, the exchange operation Position_Exchange_Fore(UCMM_NOW[j]) is executed by the LCMM at the next position from each position in the Hamilton cycle pH and each UCMM_NOW[j] where j is an even number. At the same time, in each UCMM_NOW[j] where j<2×k_max−1 and j is an odd number, in Position_Exchange_Fore( ) in both UCMM_NOW[j−1] and UCMM_NOW[j+1], the exchange operation Position_Exchange_Fore(UCMM_NOW[j]) is executed by the LCMM at the next position from each position in the Hamilton cycle pH and each UCMM_NOW[j] where j is an odd number only in a case in which the actual exchange operation is not necessary (FIG. 18(7)).

(10) In each UCMM_NOW[j] where j<2×k_max−1 and j is an odd number, in UCMM_NOW[j] in which the exchange operation is not performed in (9), the exchange operation

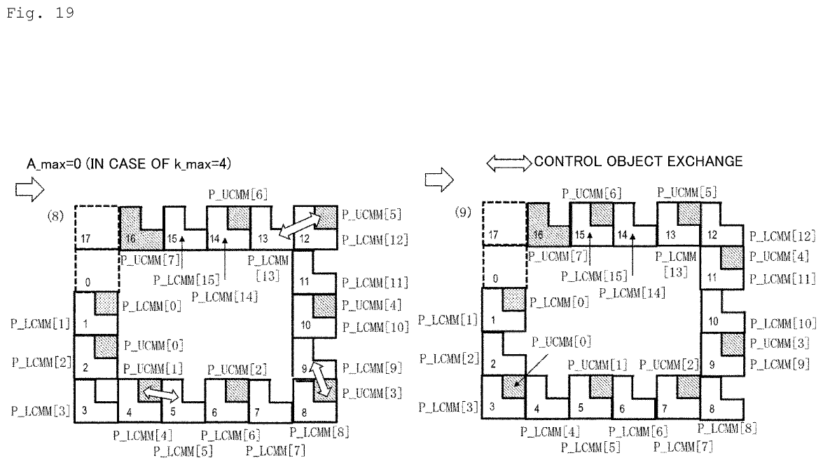

Position_Exchange_Fore(UCMM_NOW[j]) is executed by the LCMM at the next position from each position in the Hamilton cycle pH and each UCMM_NOW[j] where j is an odd number (FIG. 19(8)).

(11) All UCMMs with j<2×k_max−1 are simultaneously moved in the forward direction along the Hamilton cycle pH by one step (FIG. 19(9)).

### [Permutation_M_M′_A_max_1]

(1) The control object currently converted into a UCMM is defined as UCMM_NOW[j] (j=0, 1, 2, . . . 2×k_max−1). It is assumed that j=0 for a control object which is converted into a UCMM at a position where it can reach the position of P_LCMM[N_{lcmm}−4] with the smallest number of movement steps through movement in the forward direction along pH, and the value of j increases as the number of movement steps required to reach the position of P_LCMM[N_{lcmm}−2] through movement in the forward direction along pH increases. The position of Position_Become_LCMM←P_LCMM[N_{lcmm}−2] is set.

(2) (3) to (11) below are repeated N_{lcmm}+N_{ucmm} times.

(3) The LCMM at the position of Position_Become_LCMM is converted into a UCMM, and set as UCMM_NOW[2×k_max]. The position of Position_Become_LCMM is shifted to the next position in the Hamilton cycle pH in the forward direction. In each UCMM_NOW[j] where j is an odd number, the exchange operation Position_Exchange_Fore(UCMM_NOW[j]) is simultaneously executed by the LCMM at the next position from each position in the Hamilton cycle pH and each UCMM_NOW[j] where j is an odd number. At the same time, in each UCMM_NOW[j] where j<2×k_max and j is an even number, in Position_Exchange_Fore( ) in both UCMM_NOW[j−1] and UCMM_NOW[j+1], the exchange operation Position_Exchange_Fore(UCMM_NOW[j]) is simultaneously executed by the LCMM at the next position from each position in the Hamilton cycle pH and each UCMM_NOW[j] where j is an even number only in a case in which the actual exchange operation is not necessary (FIG. 20(1)).

(4) In each UCMM_NOW[j] where j<2×k_max and j is an even number, in a UCMM_NOW[j] in which the exchange operation is not executed in (3), the exchange operation Position_Exchange_Fore(UCMM_NOW[j]) is simultaneously executed by the LCMM at the next position from each position in the Hamilton cycle pH and each UCMM_NOW[j] where j is an even number (FIG. 20(2)).

(5) All UCMMs with j<2×k_max are simultaneously moved in the forward direction along the Hamilton cycle pH by one step (FIG. 20(3)).

(6) UCMM_NOW[0] is converted into an LCMM. In each UCMM_NOW (j) where j>0 and j is an even number, the exchange operation Position_Exchange_Fore(UCMM_NOW[j]) is simultaneously executed by the LCMM at the next position from each position in the Hamilton cycle pH and each UCMM_NOW[j] where j is an even number. At the same time, in each UCMM_NOW[j] where j is an odd number, in Position_Exchange_Fore( ) in both UCMM_NOW[j−1] and UCMM_NOW[j+1], the exchange operation

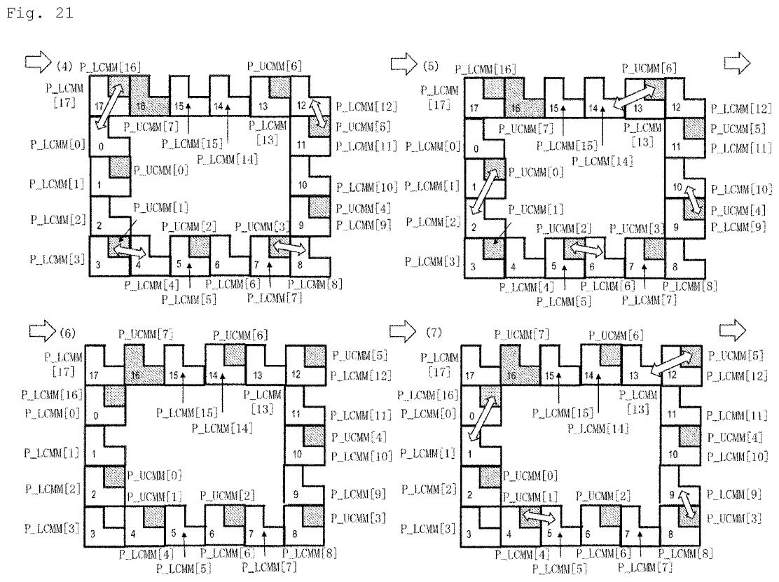

Position_Exchange_Fore(UCMM_NOW[j]) is simultaneously executed by the LCMM at the next position from each position in the Hamilton cycle pH and each UCMM_NOW[j] where j is an odd number only in a case in which the actual exchange operation is not necessary (FIG. 21(4)).

(7) In each UCMM_NOW[j] where j is an odd-number, in UCMM_NOW[j] in which the exchange operation is not performed in (6), the exchange operation

Position_Exchange_Fore(UCMM_NOW[j]) is simultaneously executed by the LCMM at the next position from each position in the Hamilton cycle pH and each UCMM_NOW[j] where j is an odd number. UCMM_NOW[j]-UCMM_NOW[j+1] is set. UCMM_NOW[2×k_max] is set as a missing number (FIG. 21(5)).

(8) All UCMMs are simultaneously moved in the forward direction along the Hamilton cycle pH by one step (FIG. 21(6)).

(9) In each UCMM_NOW[j] where j is an odd number, the exchange operation Position_Exchange_Fore(UCMM_NOW[j]) is simultaneously executed by the LCMM at the next position from each position in the Hamilton cycle pH and each UCMM_NOW[j] where j is an odd number. At the same time, in each UCMM_NOW[j] where j is an even number, in Position_Exchange_Fore( ) in both UCMM_NOW[j−1] and UCMM_NOW[j+1], the exchange operation Position_Exchange_Fore(UCMM_NOW[j]) is simultaneously executed by the LCMM at the next position from each position in the Hamilton cycle pH and each UCMM_NOW[j] where j is an even number only in a case in which the actual exchange operation is not necessary. At the same time, in Position_Exchange_Fore( ) in UCMM_NOW[2×k_max−1], Position_Exchange_Aft( ) in UCMM_NOW[2×k_max−1] is executed only in a case in which no actual exchange operation is performed (FIG. 21(7)).

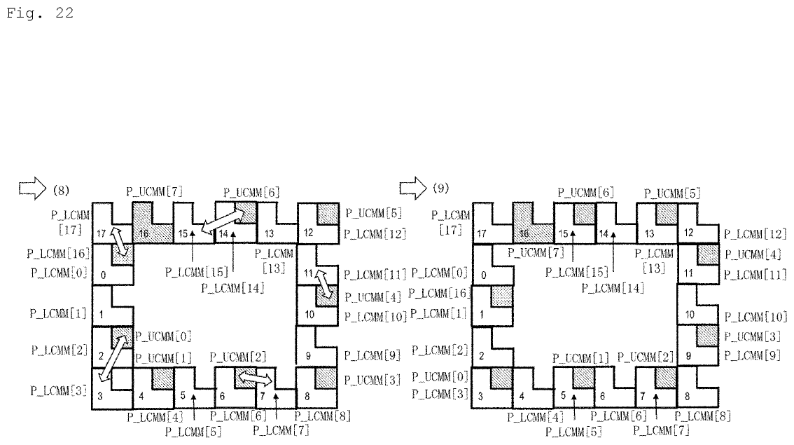

(10) In each UCMM_NOW[j] where j is an even number, in UCMM_NOW[j] in which the exchange operation is not performed in (9), the exchange operation Position_Exchange_Fore(UCMM_NOW[j]) is simultaneously executed by the LCMM at the next position from each position in the Hamilton cycle pH and each UCMM_NOW[j] where j is an even number. At the same time, only in a case in which Position_Exchange_Aft( ) in UCMM_NOW[2×k_max−1] is not executed in (9), Position_Exchange_Aft( ) in UCMM_NOW[2×k_max−1] is executed (FIG. 22(8)).

(11) All UCMMs are simultaneously moved in the forward direction along the Hamilton cycle pH by one step (FIG. 22(9)).

### [Permutation_M_M′_A_max 2]

(1) The control object currently converted into a UCMM is defined as UCMM_NOW[j] (j=0, 1, 2, . . . , 2×k_max). It is assumed that j=0 for a control object which is converted into a UCMM at a position where it can reach the position of P_LCMM[N_{lcmm}−2] with the smallest number of movement steps through movement in the forward direction along pH, and the value of j increases as the number of movement steps required to reach the position of P_LCMM[N_{lcmm}−2] increases. The position of Position_Become_LCMM←P_LCMM[N_{lcmm}−2] is set.

(2) (3) to (11) below are repeated N_{lcmm}+N_{ucmm} times.

(3) The LCMM at the position of Position_Become_LCMM is converted into a UCMM, and set as UCMM_NOW[2×k_max+1]. The position of Position_Become_LCMM is shifted to the next position in the Hamilton cycle pH in the forward direction. The UCMM_NOW[0] is converted into an LCMM. In each UCMM_NOW (j) where j>0 and j is an even number, the exchange operation Position_Exchange_Fore(UCMM_NOW[j]) is simultaneously executed by the LCMM at the next position from each position in the Hamilton cycle pH and each UCMM_NOW[j] where j is an even number.

At the same time, in each UCMM_NOW[j] where j<2×k_max+1 and j is an odd number, in Position_Exchange_Fore( ) in both UCMM_NOW[j−1] and UCMM_NOW[j+1], the exchange operation Position_Exchange_Fore(UCMM_NOW[j]) is simultaneously executed by the LCMM at the next position from each position in the Hamilton cycle pH and each UCMM_NOW[j] where j is an odd number only in a case in which the actual exchange operation is not necessary (FIG. 23(1)).

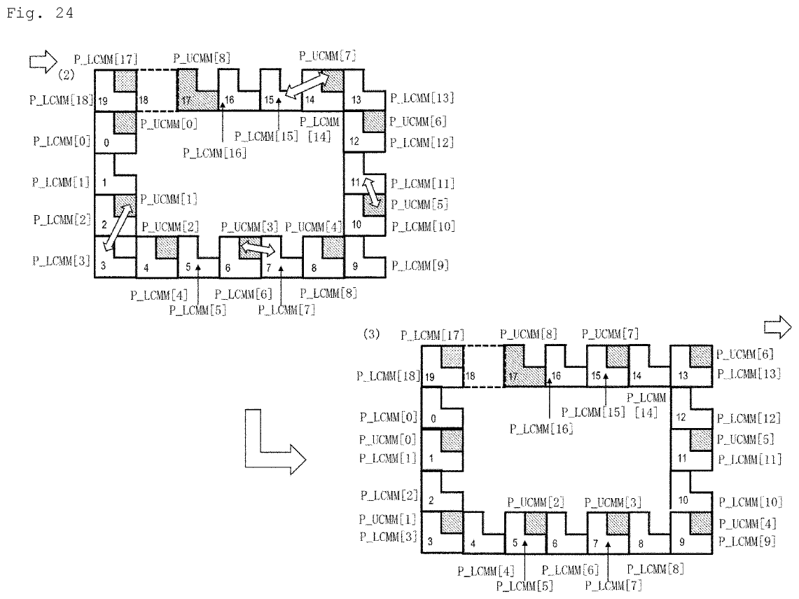

(4) In each UCMM_NOW[j] where j<2×k_max+1 and j is an odd number, in a UCMM_NOW[j] in which the exchange operation is not executed in (3), the exchange operation Position_Exchange_Fore(UCMM_NOW[j]) is simultaneously executed by the LCMM at the next position from each position in the Hamilton cycle pH and each UCMM_NOW[j] where j is an odd number. UCMM_NOW[j]+UCMM_NOW[j+1] is set. UCMM_NOW[2×k_max+1] is set as a missing number (FIG. 24(2)).

(5) All UCMMs with j<2×k_max are simultaneously moved in the forward direction along the Hamilton cycle pH by one step (FIG. 24(3)).

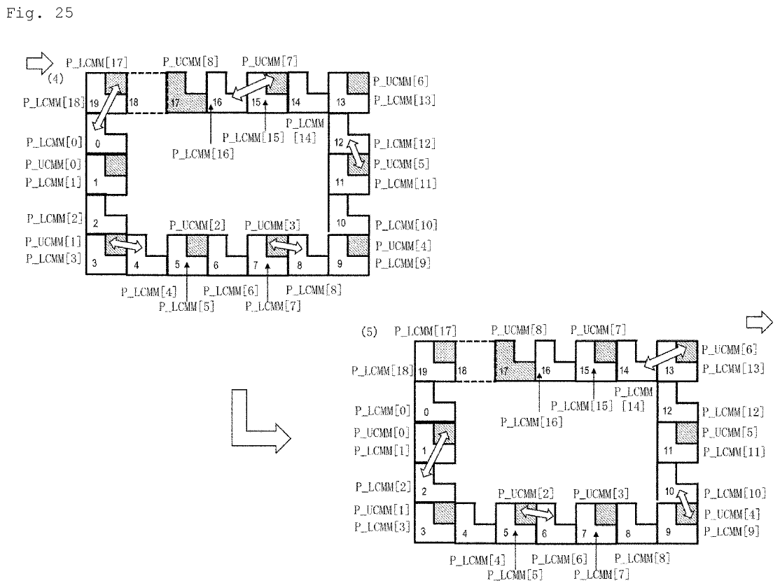

(6) In each UCMM_NOW[j] where j is an even number, an exchange operation Position_Exchange_Fore(UCMM_NOW[j]) is simultaneously executed by the LCCM at the next position from each position in the Hamilton cycle pH and each UCCM_NOW[j] where j is an even number. At the same time, in each UCMM_NOW[j] where j is an odd number, in Position_Exchange_Fore( ) in both UCMM_NOW[j−1] and UCMM_NOW[j+1], the exchange operation Position_Exchange_Fore(UCMM_NOW[j]) is simultaneously executed by the LCMM at the next position from each position in the Hamilton cycle pH and each UCMM_NOW[j] where j is an odd number only in a case in which the actual exchange operation is not necessary (FIG. 25(4)).

(7) In each UCMM_NOW[j] where j is an odd-number, in UCMM_NOW[j] in which the exchange operation is not performed in (6), the exchange operation Position_Exchange_Fore(UCMM_NOW[j]) is simultaneously executed by the LCMM at the next position from each position in the Hamilton cycle pH and each UCMM_NOW[j] where j is an odd number (FIG. 25(5)).

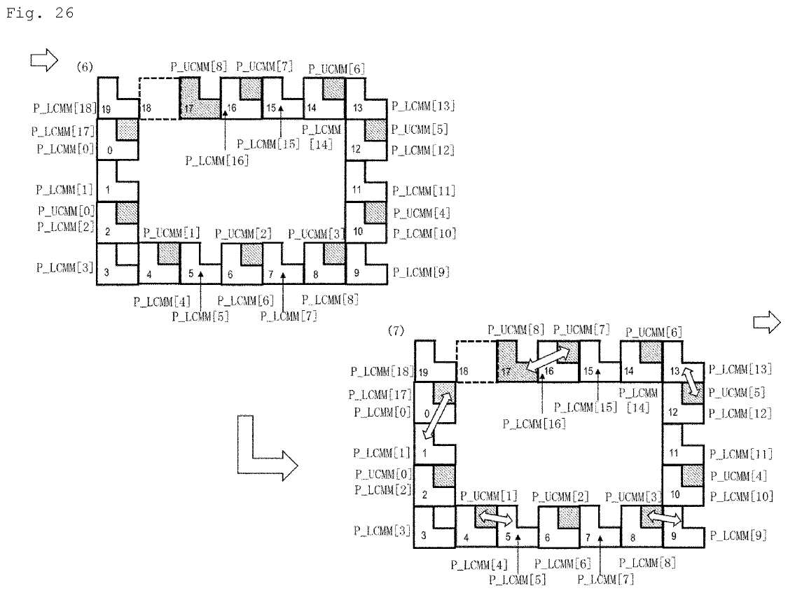

(8) All UCMMs are simultaneously moved in the forward direction along the Hamilton cycle pH by one step (FIG. 26(6)).

(9) In each UCMM_NOW[j] where j is an even number, an exchange operation Position_Exchange_Fore(UCMM_NOW[j]) is simultaneously executed by the LCCM at the next position from each position in the Hamilton cycle pH and each UCCM_NOW[j] where j is an even number. At the same time, in each UCMM_NOW[j] where j is an odd number, in Position_Exchange_Fore( ) in both UCMM_NOW[j−1] and UCMM_NOW[j+1], the exchange operation Position_Exchange_Fore(UCMM_NOW[j]) is simultaneously executed by the LCMM at the next position from each position in the Hamilton cycle pH and each UCMM_NOW[j] where j is an odd number only in a case in which the actual exchange operation is not necessary. At the same time, in Position_Exchange_Fore( ) in UCMM_NOW[2×k_max], Position_Exchange_Aft( ) in UCMM_NOW[2×k_max] is executed only in a case in which no actual exchange operation is performed (FIG. 26(7)).

(10) In each UCMM_NOW[j] where j is an odd-number, in UCMM_NOW[j] in which the exchange operation is not performed in (9), the exchange operation

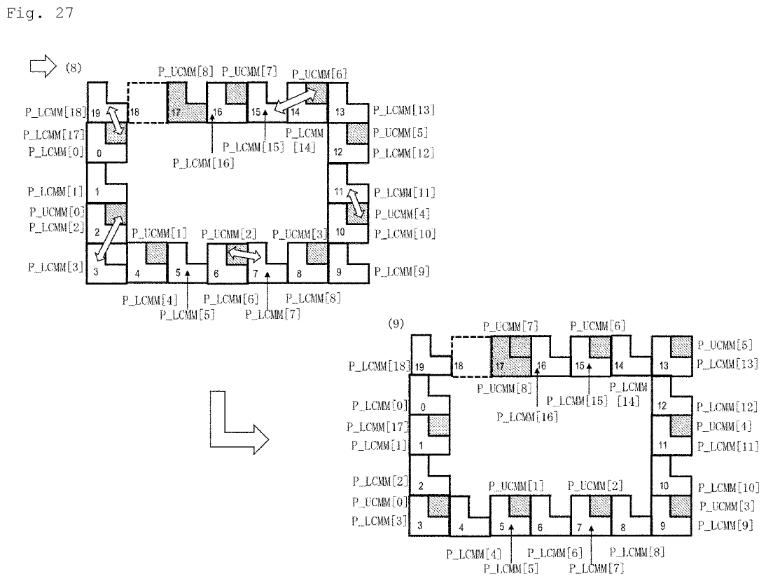

Position_Exchange_Fore(UCMM_NOW[j]) is simultaneously executed by the LCMM at the next position from each position in the Hamilton cycle pH and each UCMM_NOW[j] where j is an odd number. At the same time, only in a case in which Position_Exchange_Aft( ) in UCMM_NOW[2×k_max] is not executed in (9), Position_Exchange_Aft( ) in UCMM_NOW[2×k_max] is executed (FIG. 27(8)).

(11) All UCMMs are simultaneously moved in the forward direction along the Hamilton cycle pH by one step (FIG. 27(9)).

### [Control Object Position Exchange Operation]

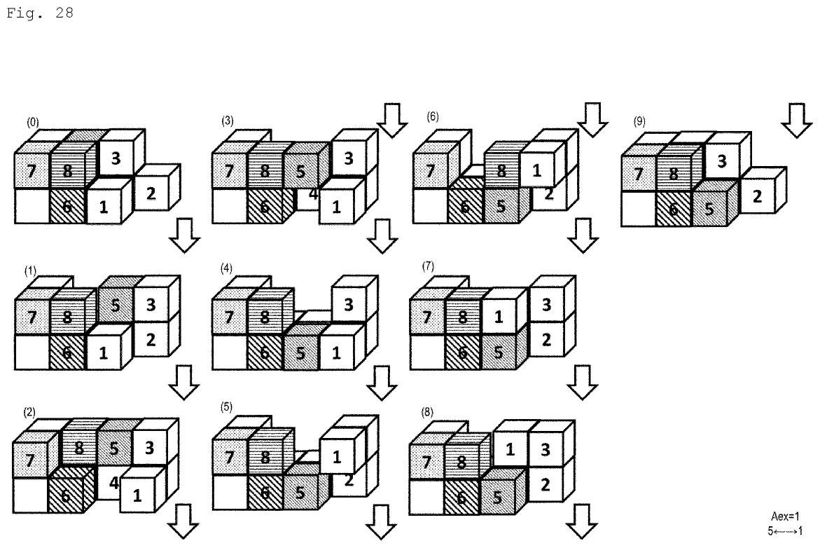

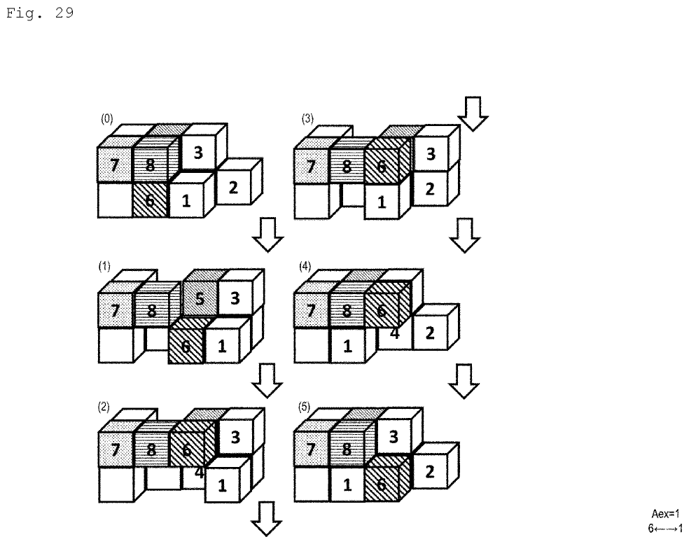

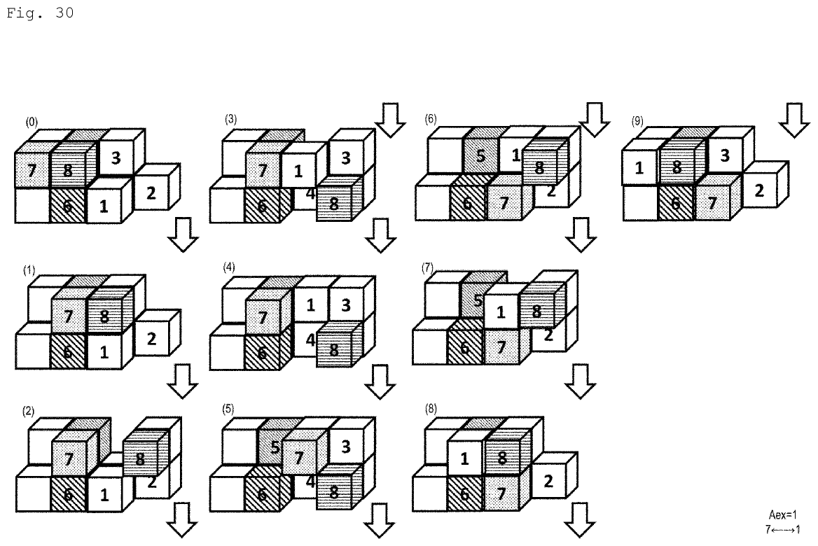

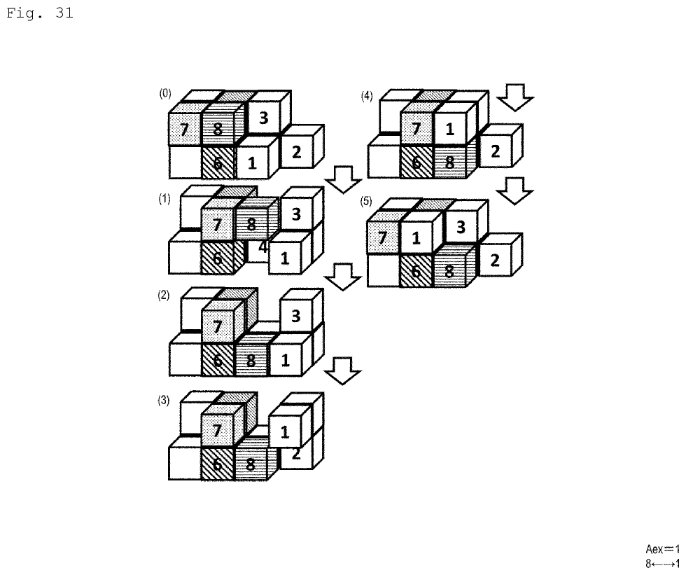

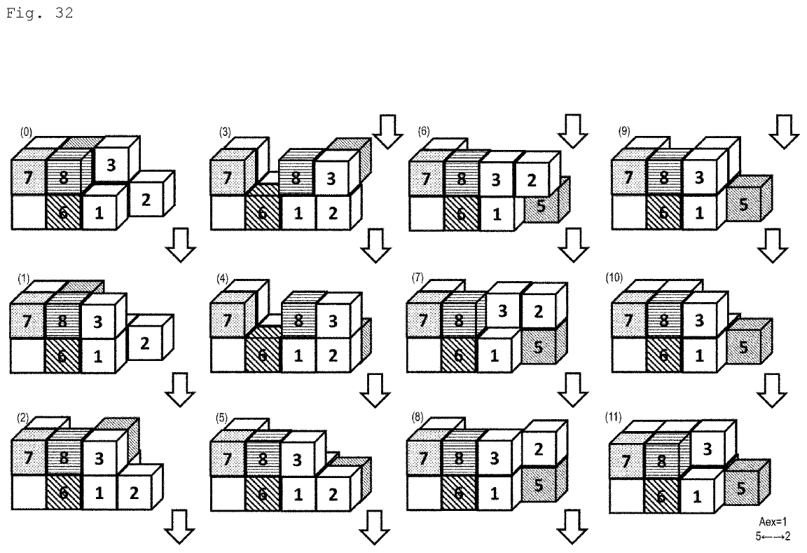

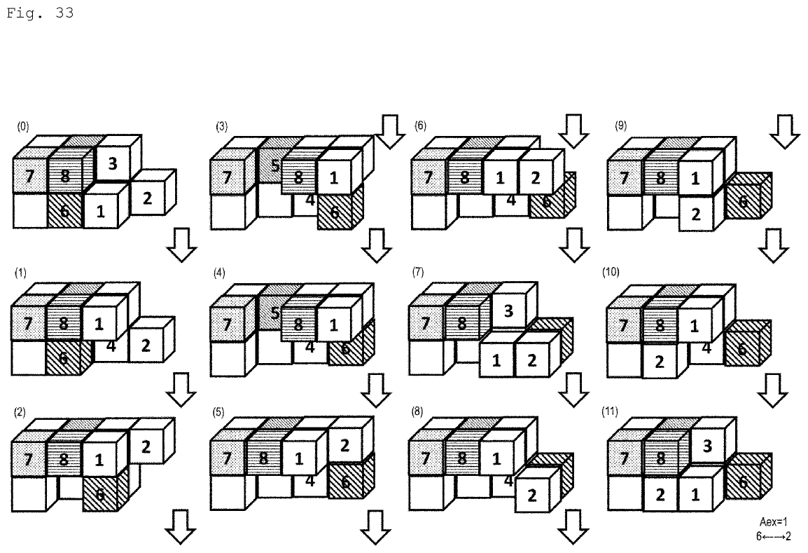

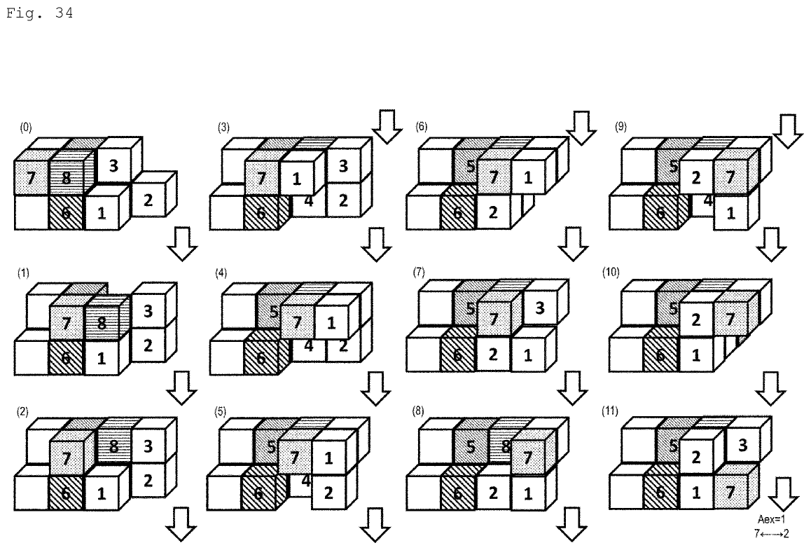

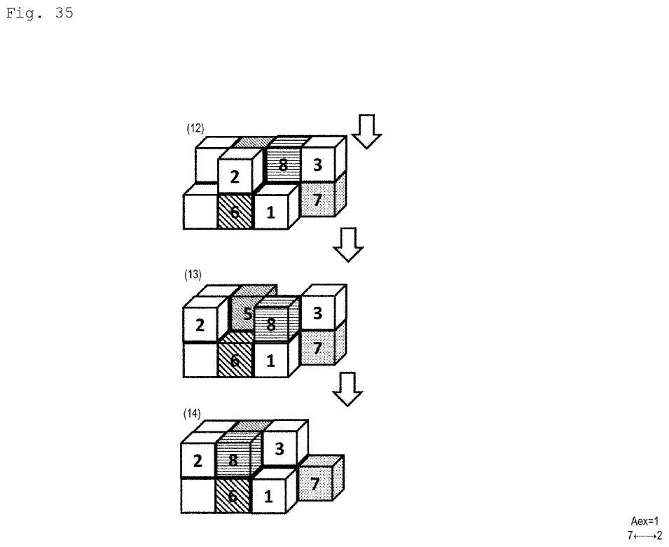

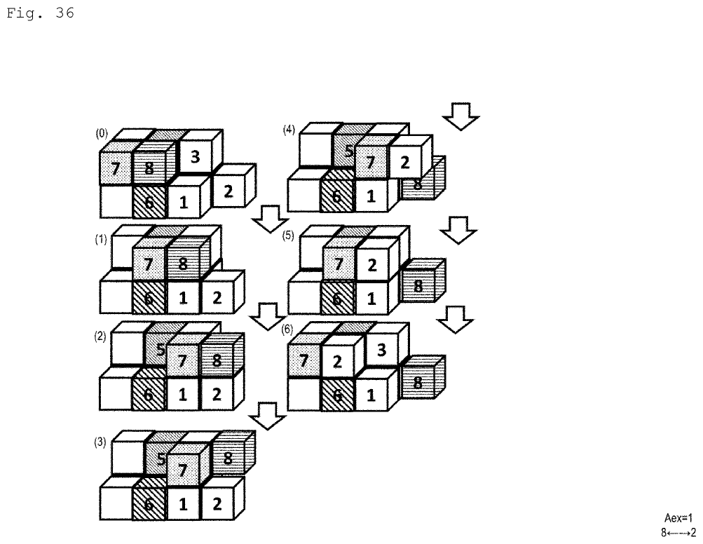

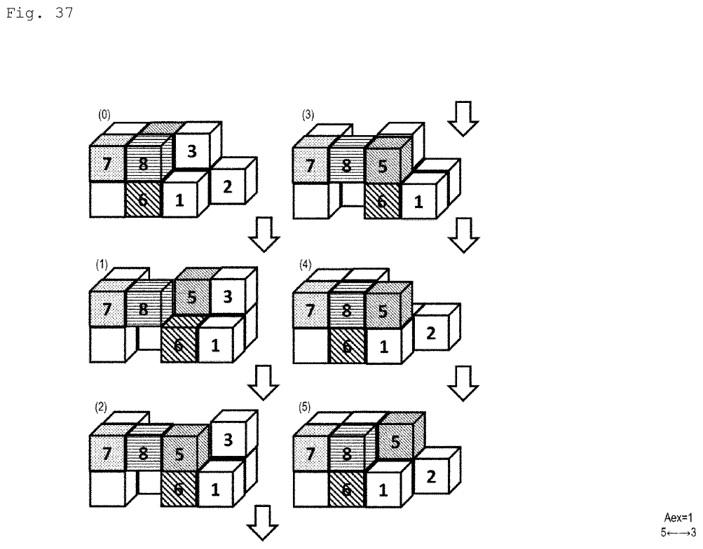

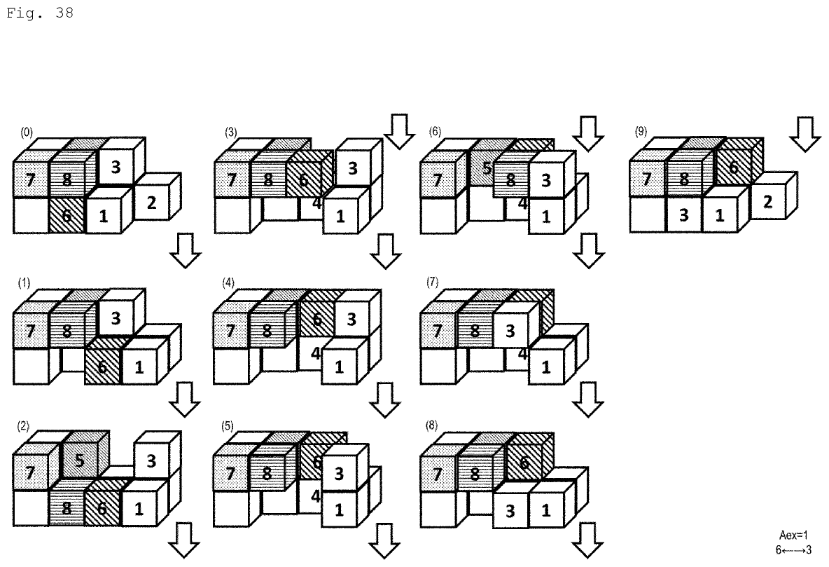

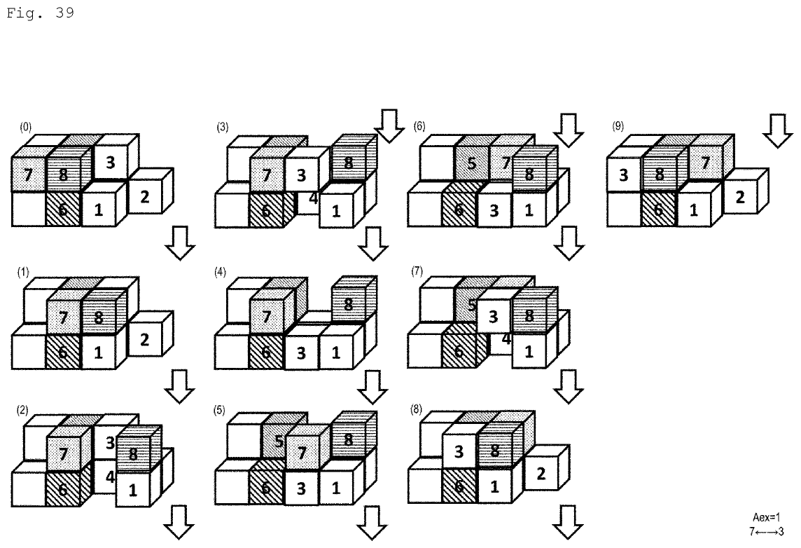

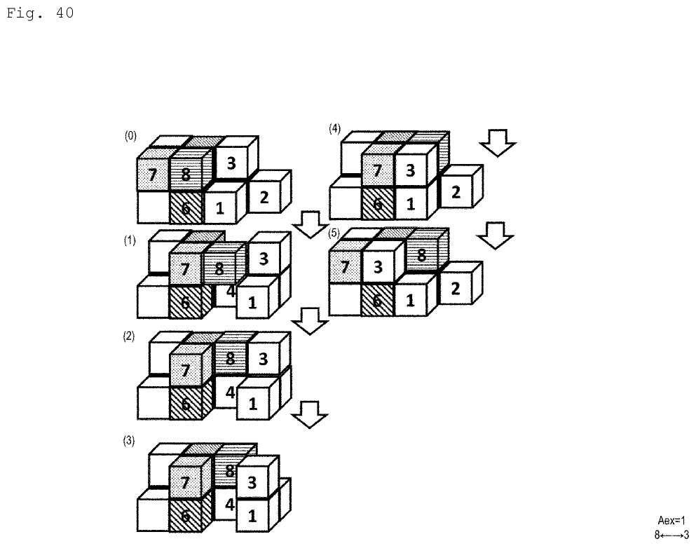

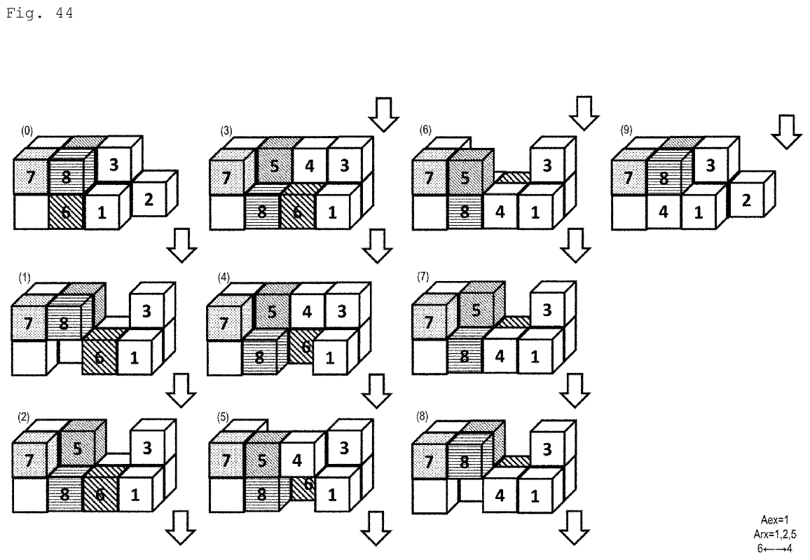

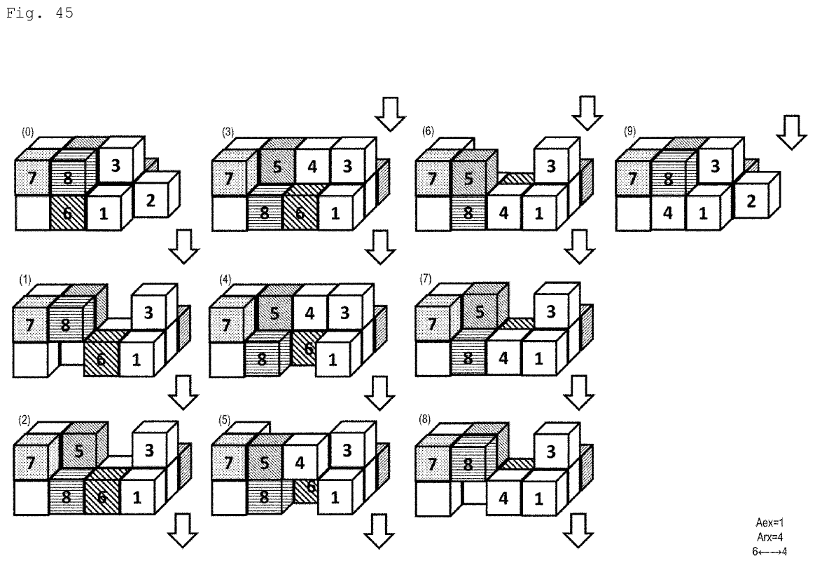

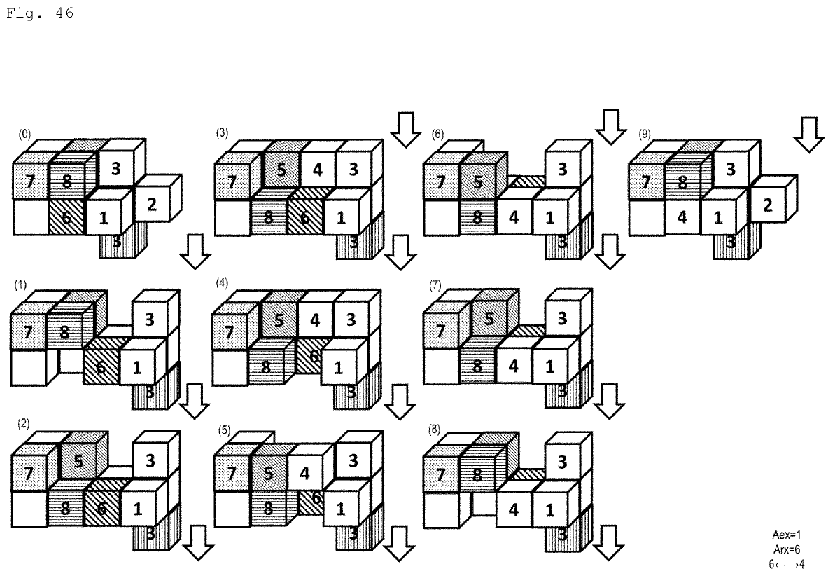

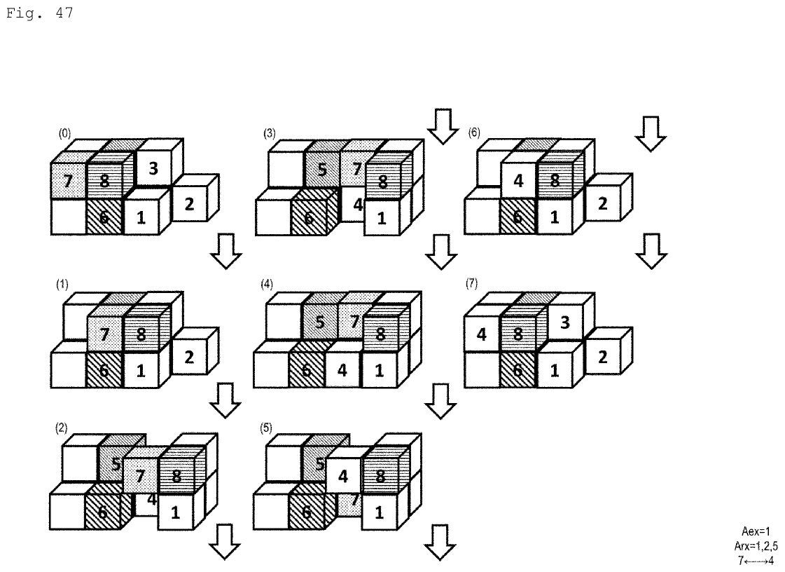

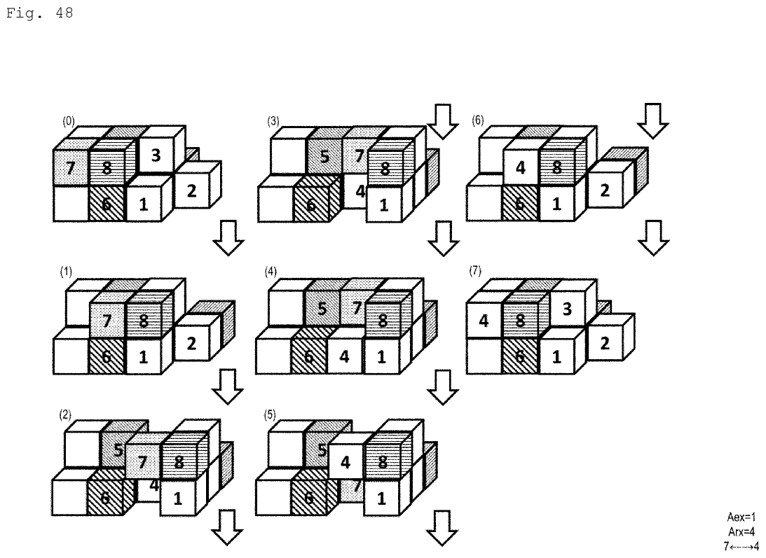

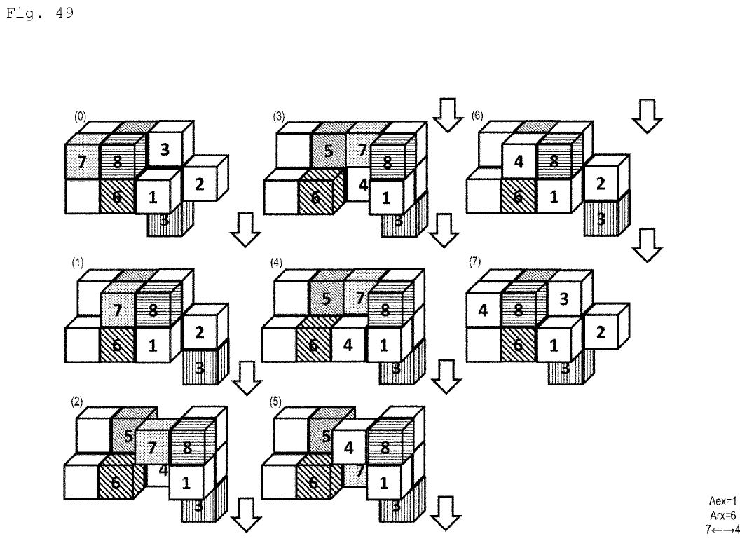

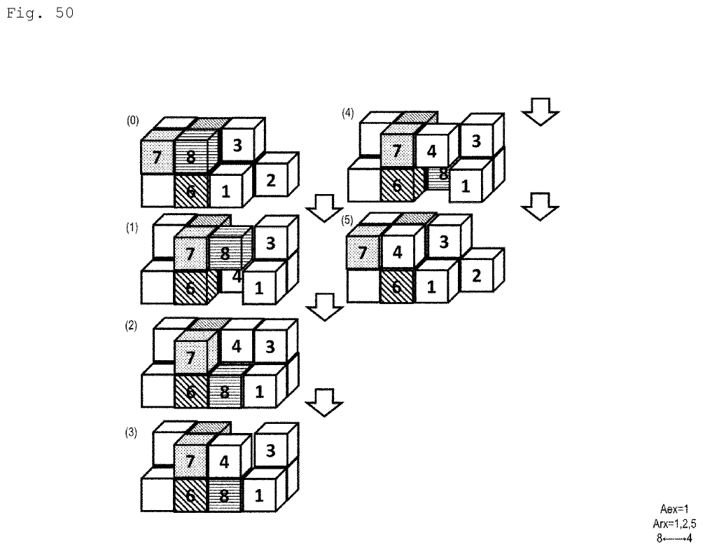

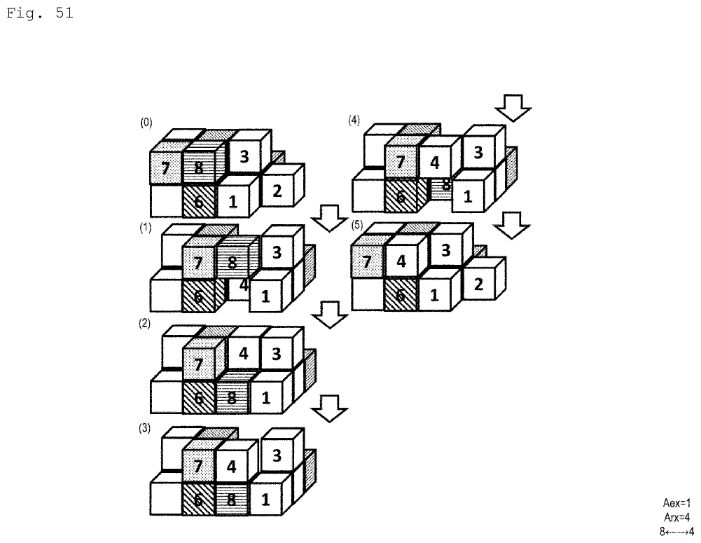

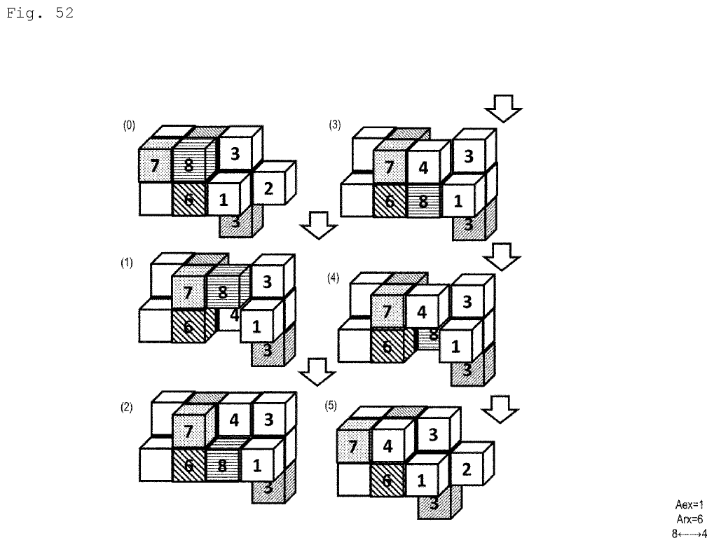

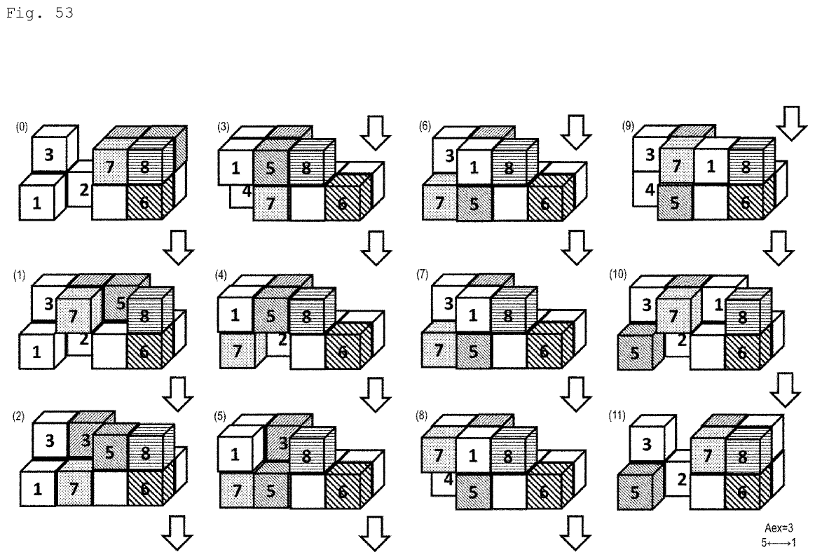

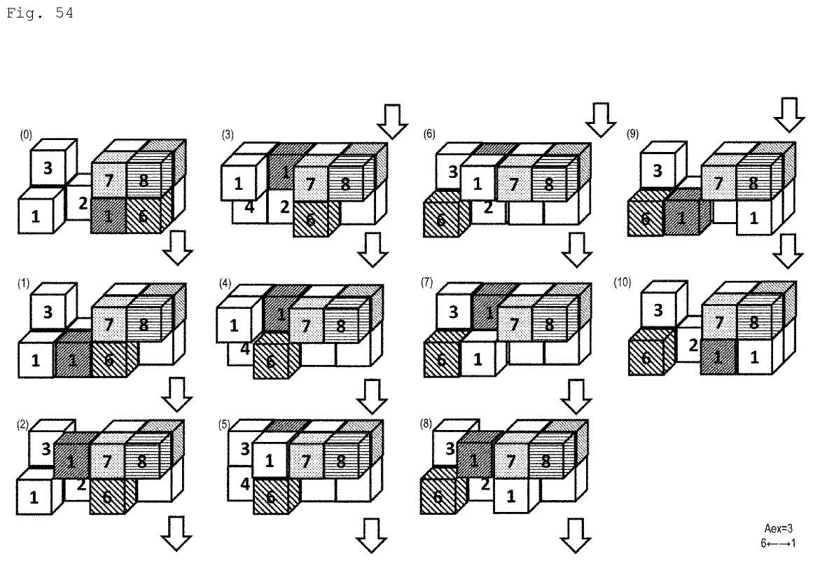

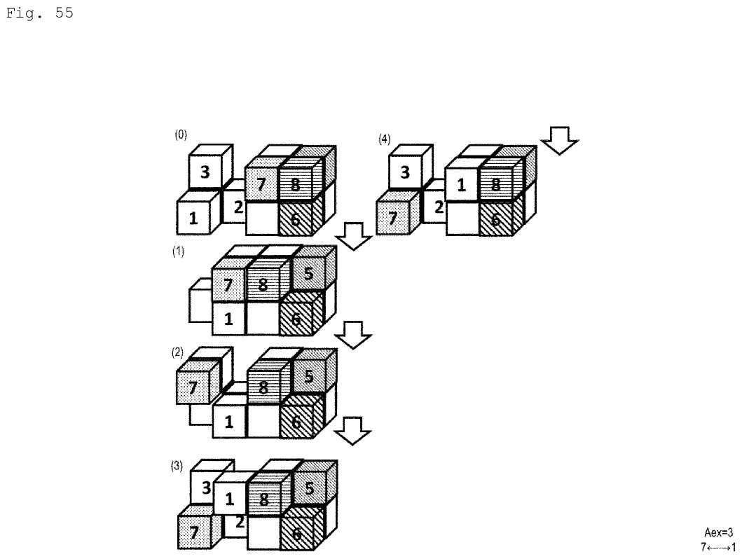

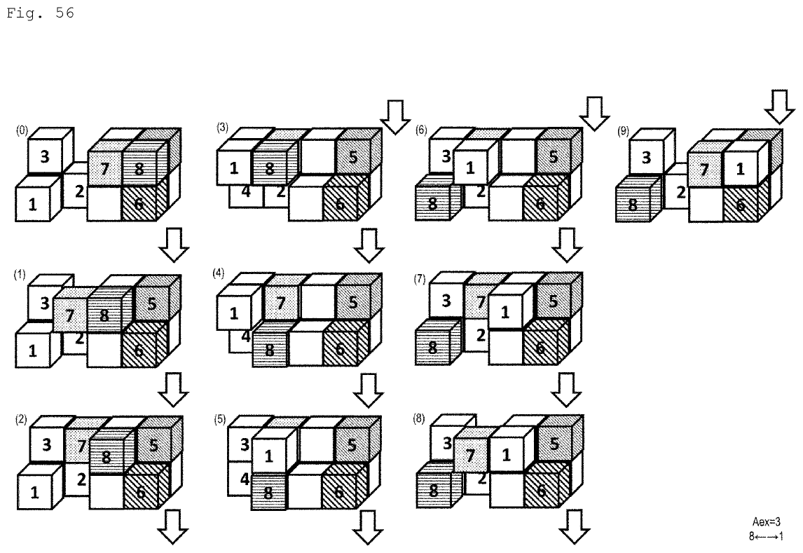

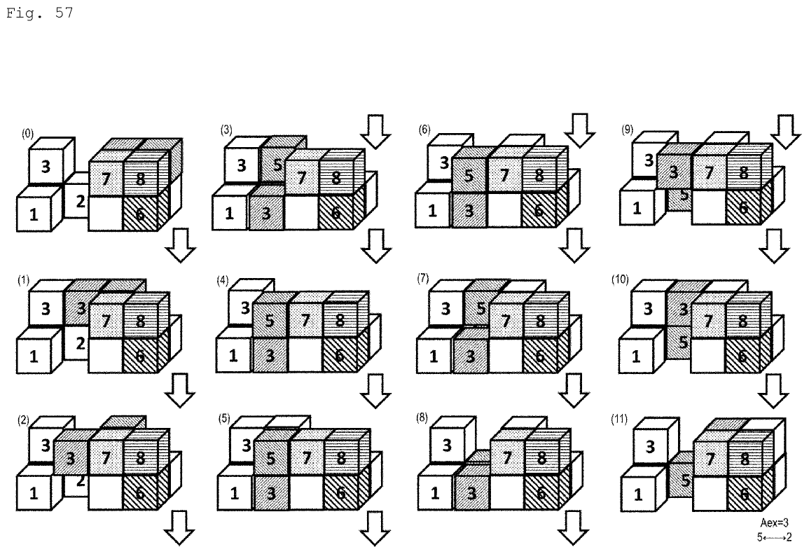

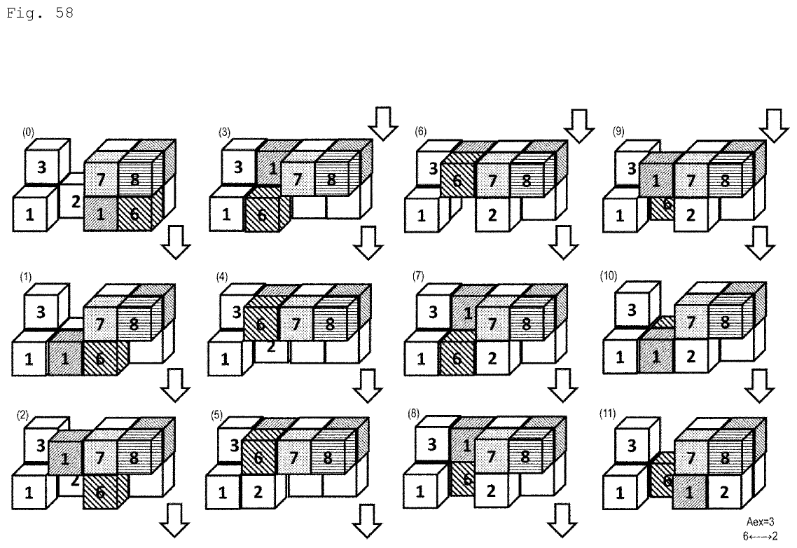

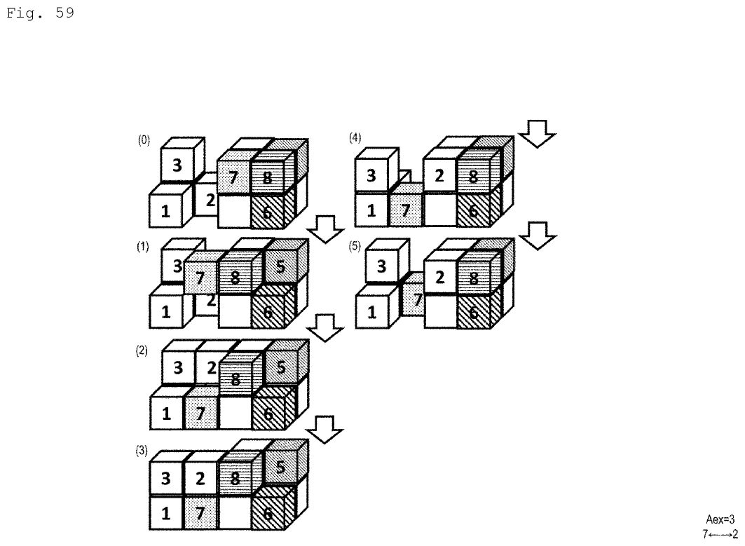

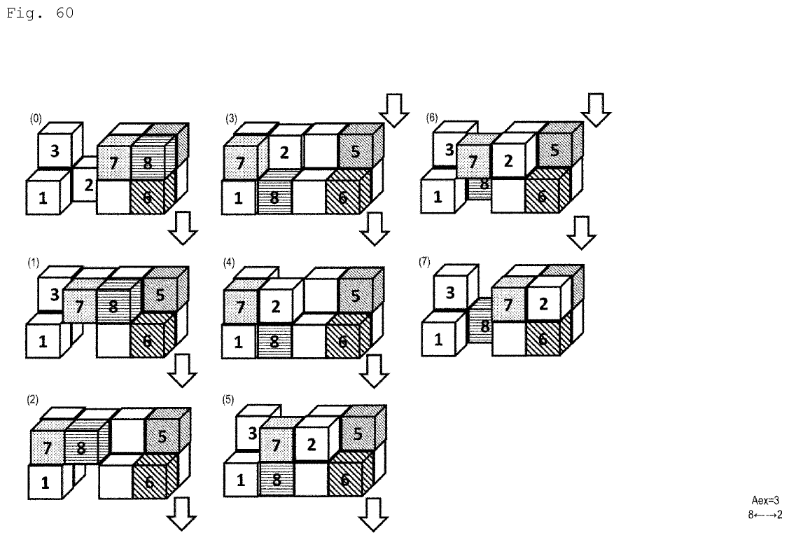

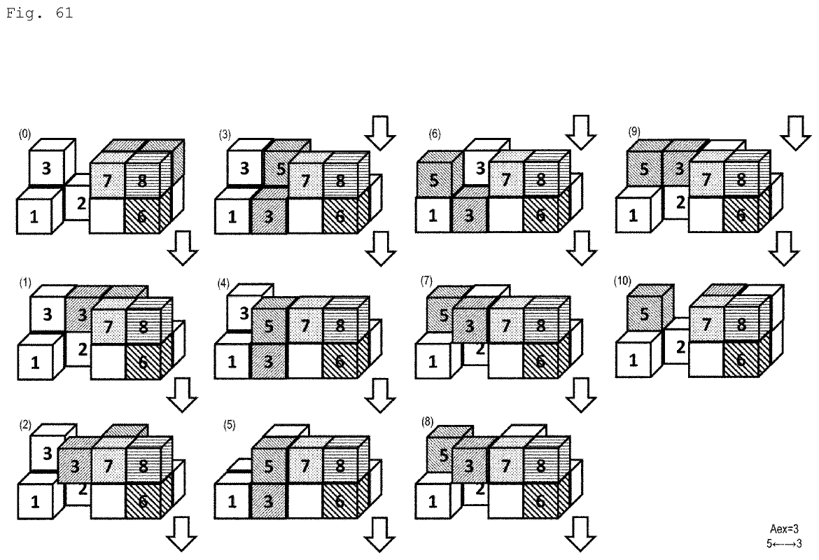

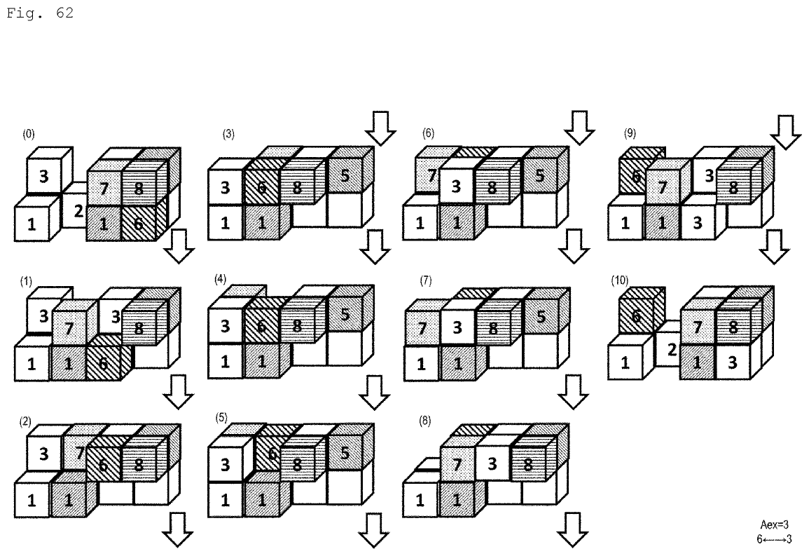

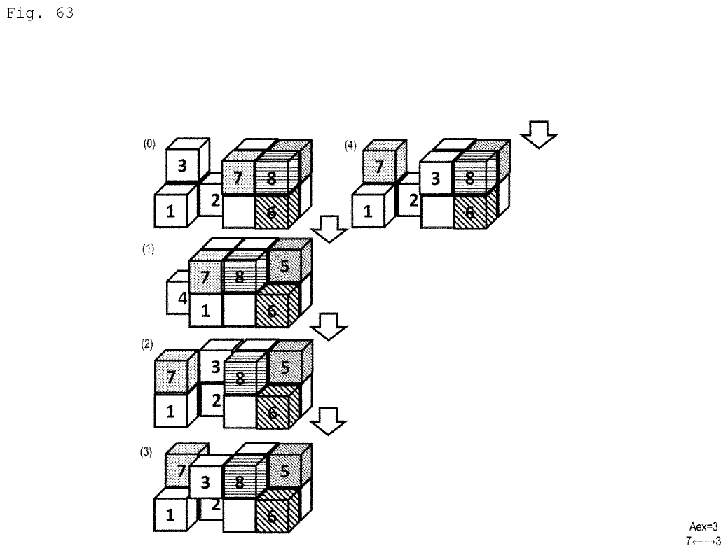

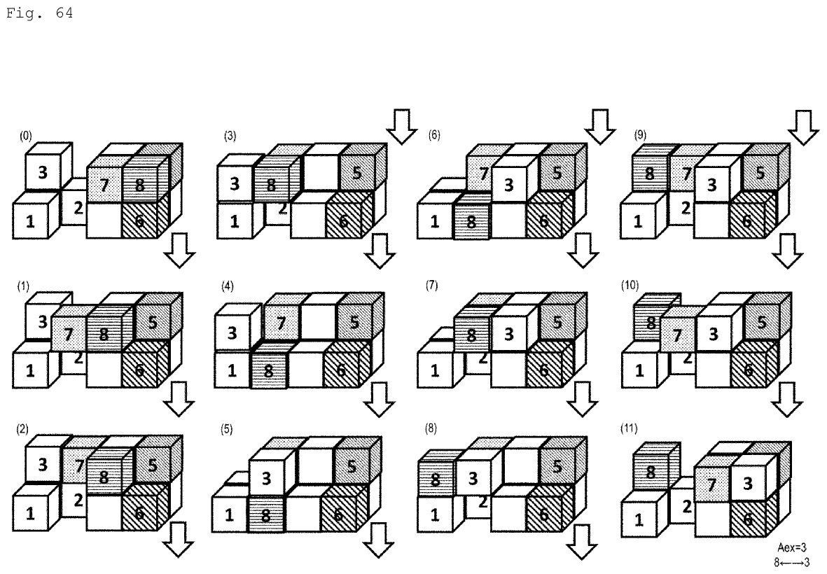

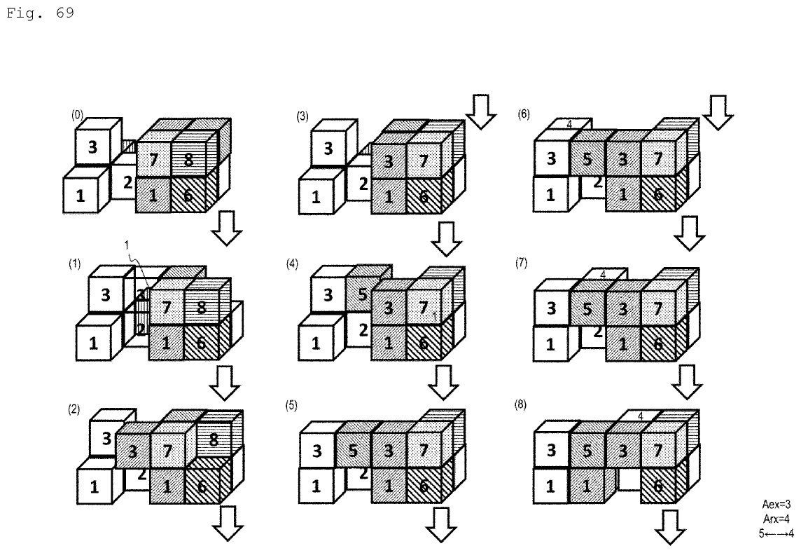

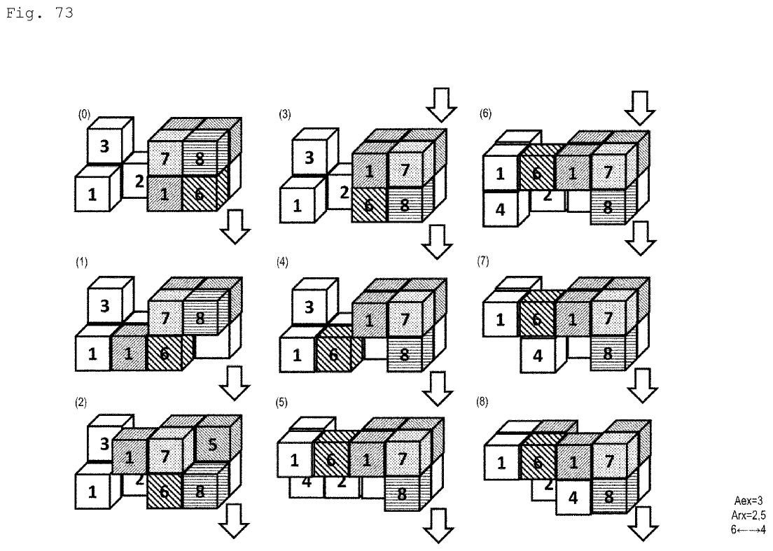

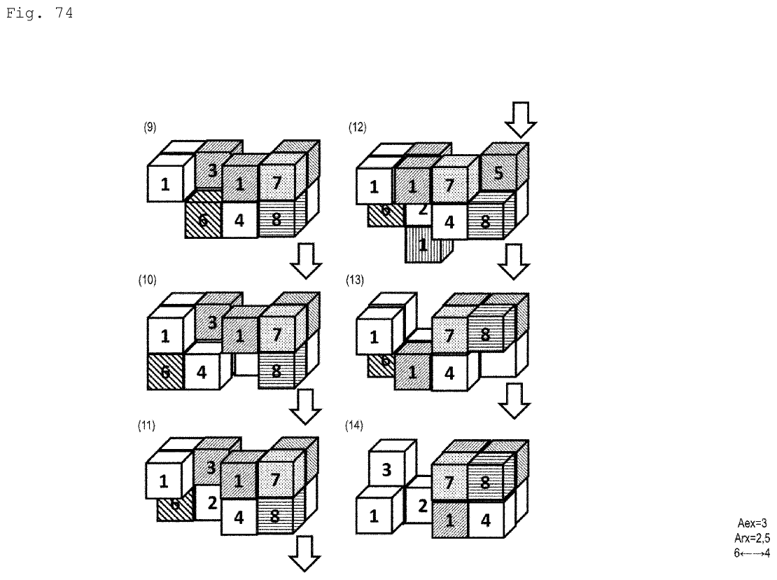

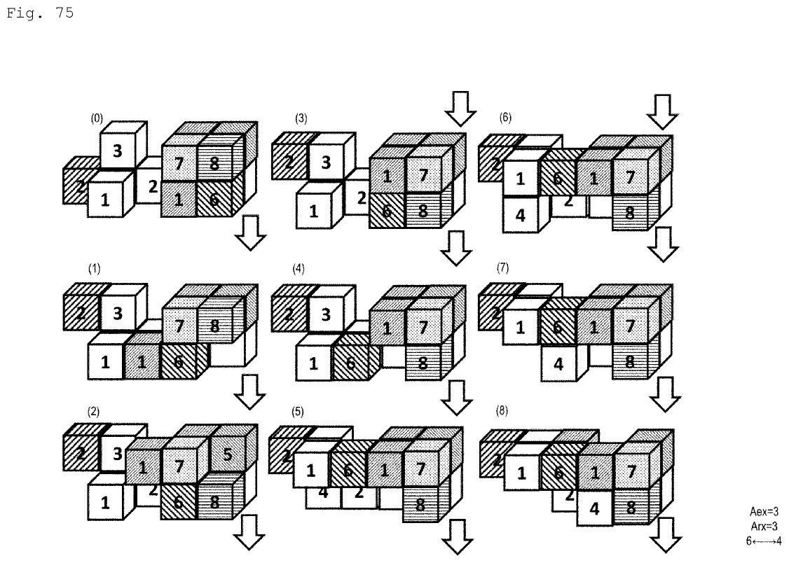

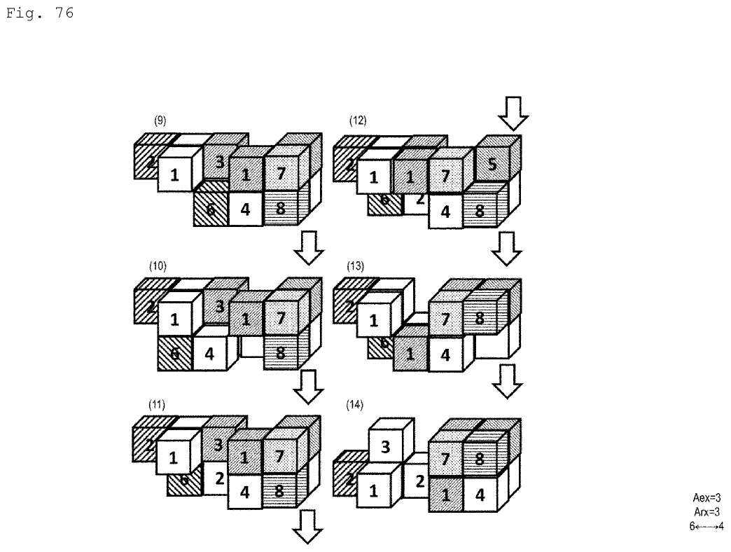

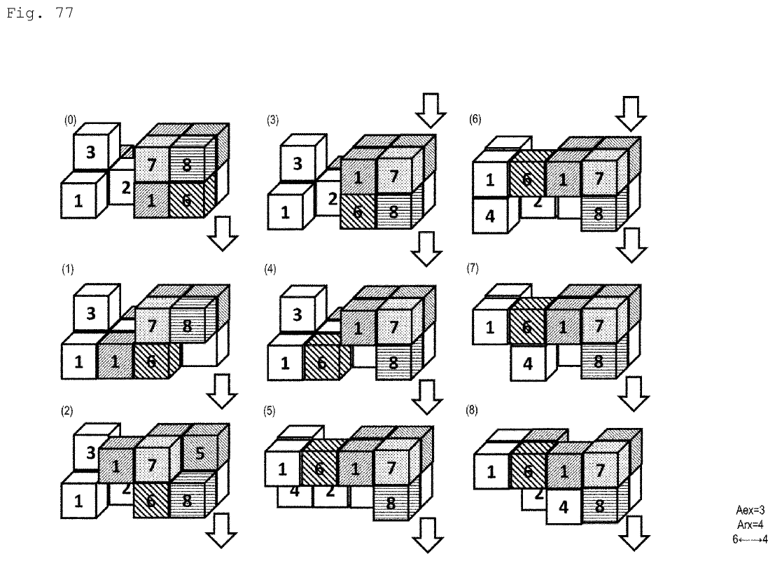

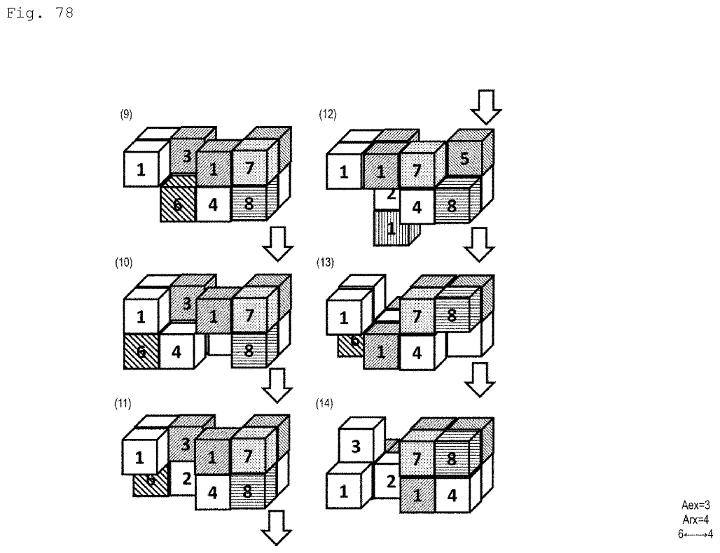

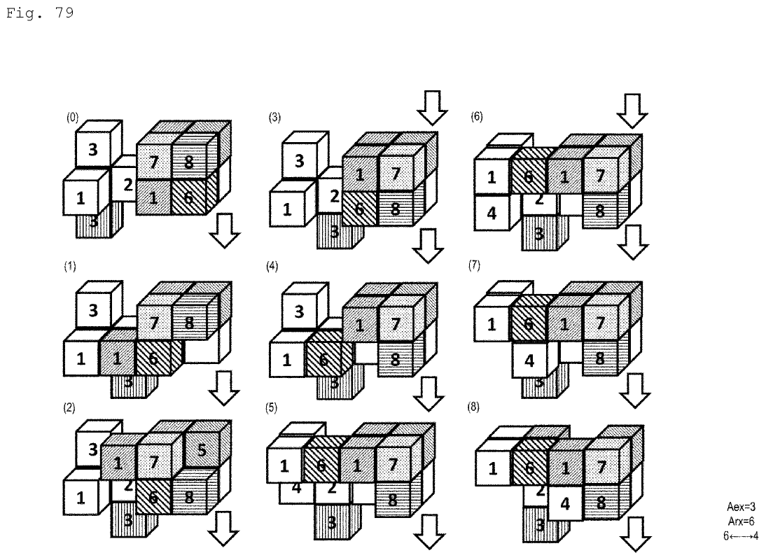

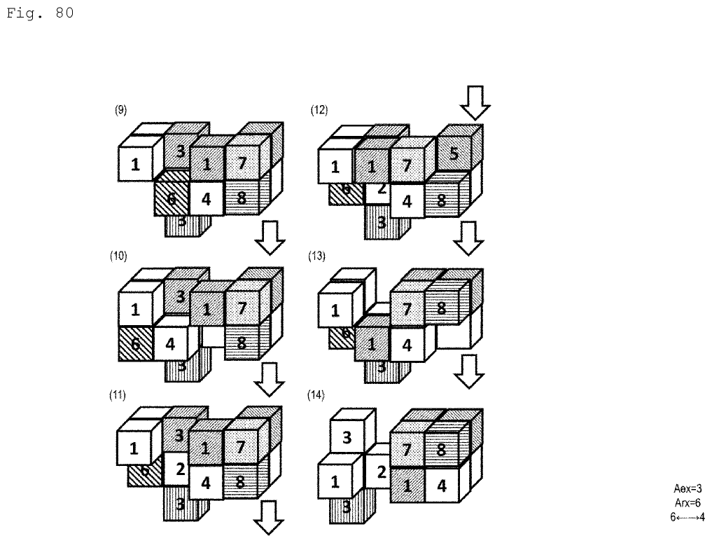

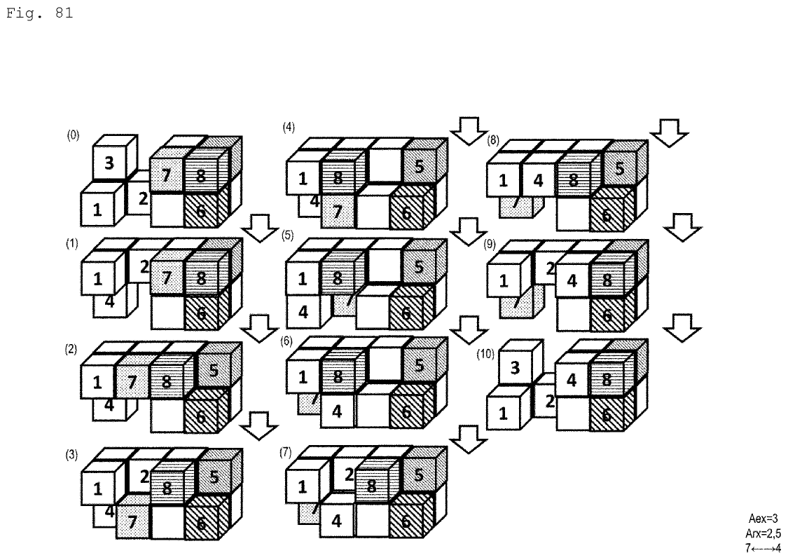

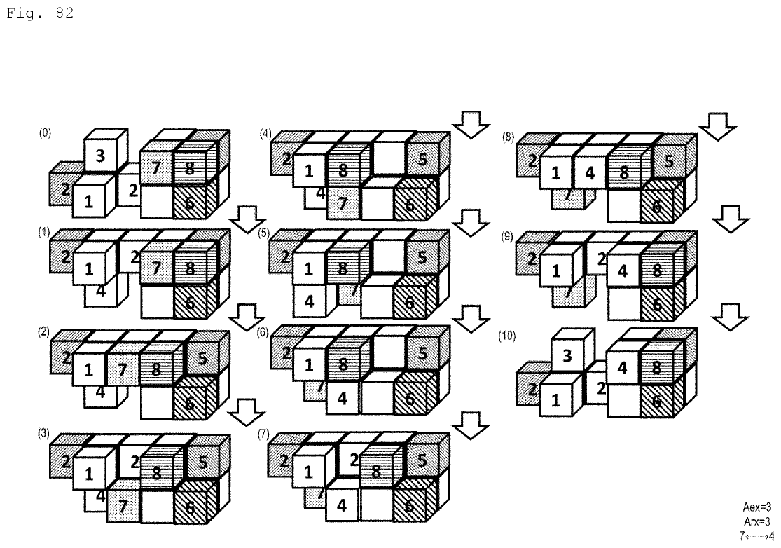

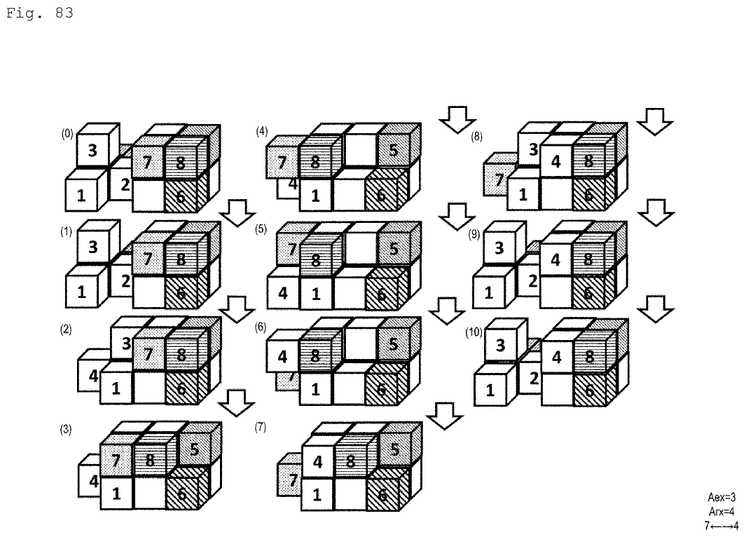

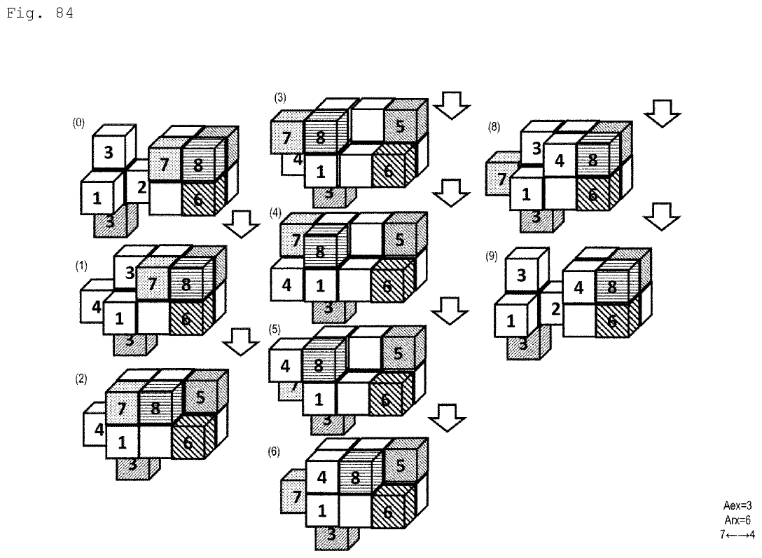

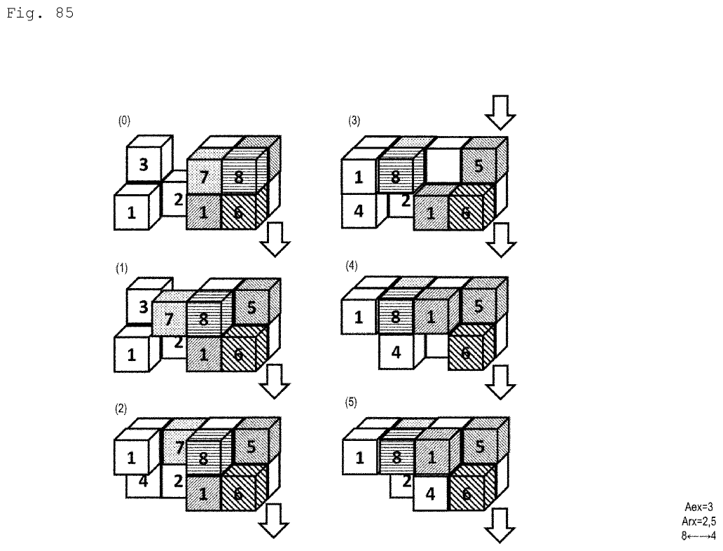

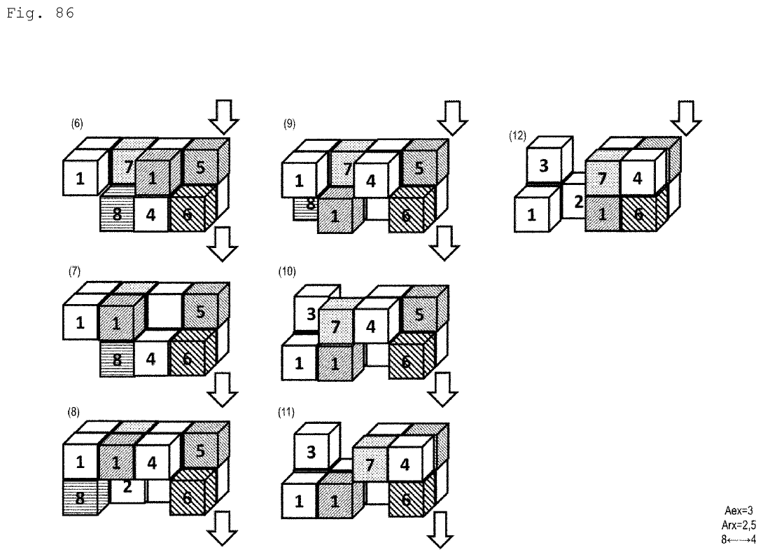

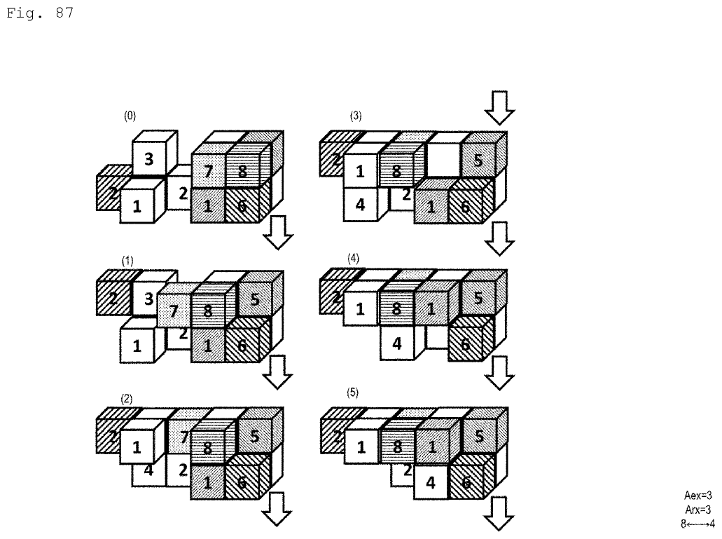

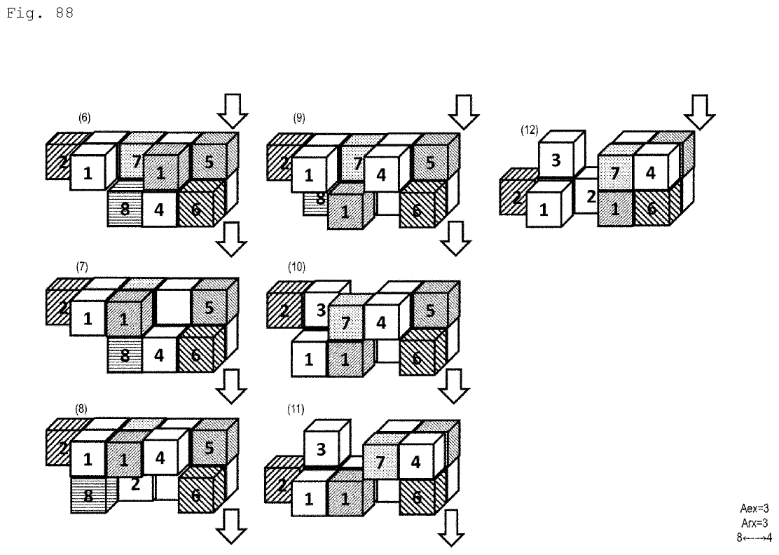

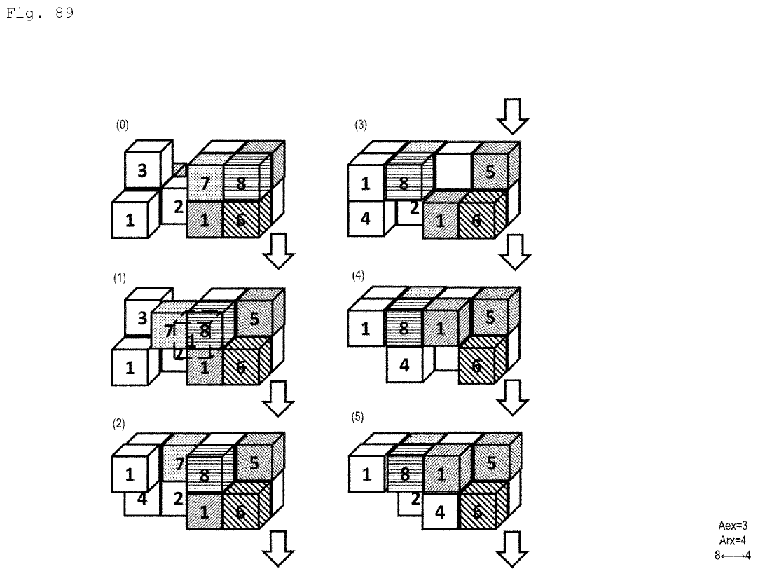

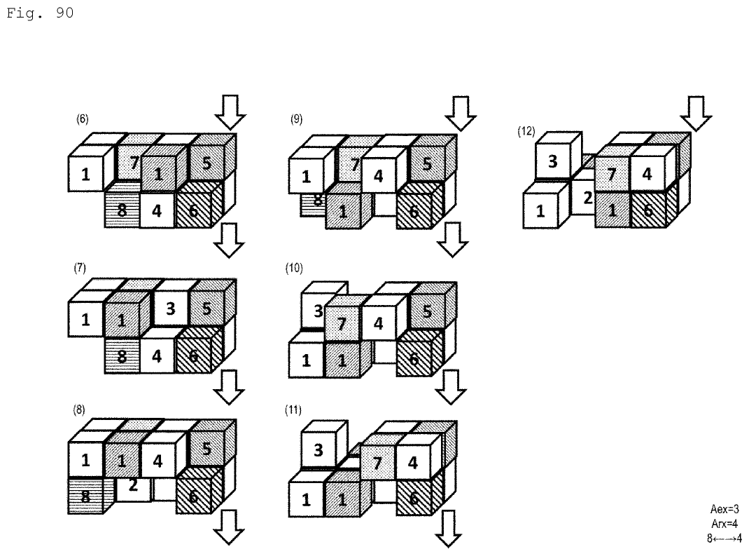

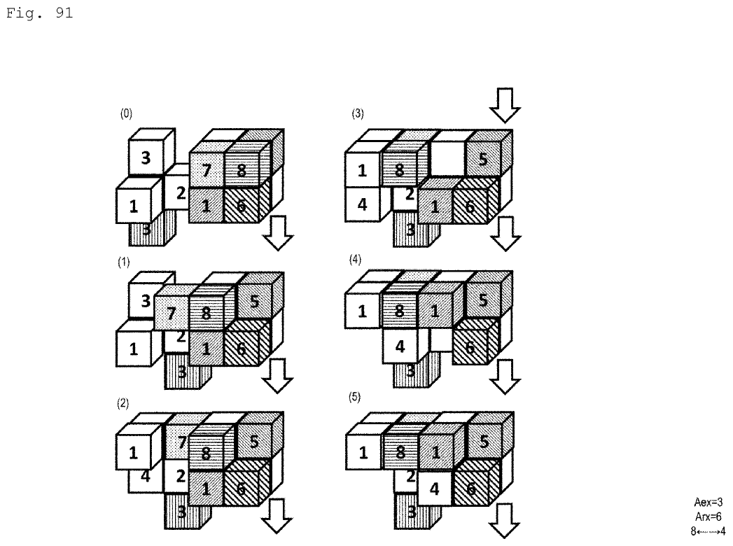

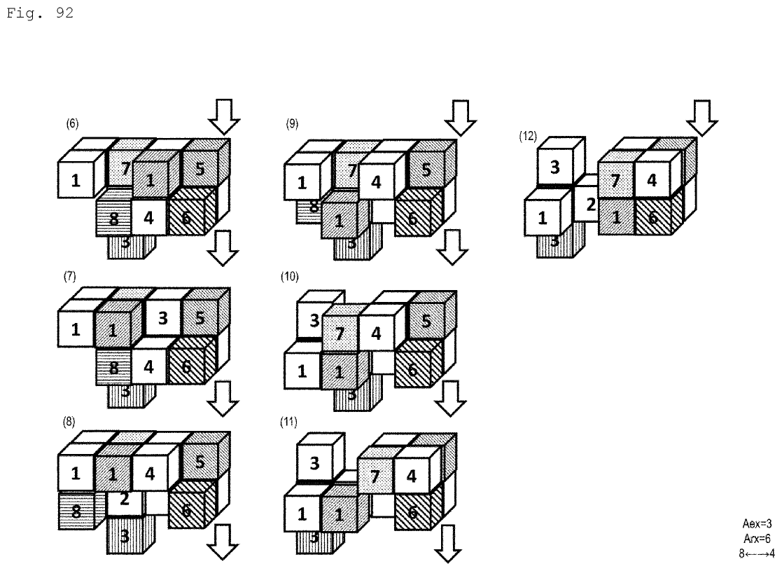

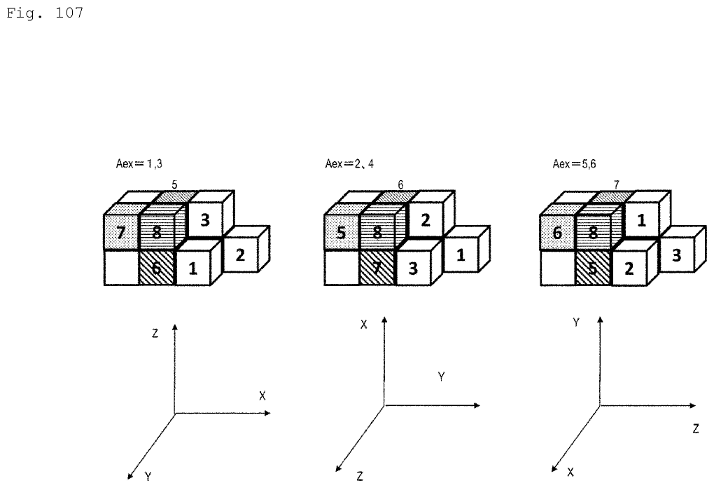

In the control object position exchange operation (the aforementioned Position_Exchange_Fore and Position_Exchange_Aft), the exchange operation changes depending on the positional relationship between a control object unit j which is a UCMM and a control object unit j′ to be exchanged which is an LCMM. FIGS. 28 to 52 show position exchange operations in the case where the direction of j→j′ (defined as Aex) is Aex=1, 2, and 5. FIGS. 53 to 92 show position exchange operations in the case where the direction of j→j′ is Aex=3, 4, and 6. In (1) of FIG. 69, control object units indicated by 2 and 3 are made transparent in order to indicate the position of a control object unit indicated with the right-upward diagonal stripes and 1. FIGS. 28 to 52 illustrates an example of the case of Aex=1. In the case of other exchange operations of Aex=2 and 5, the direction indicated as the right direction in the figure may be regarded as a direction of Aex=2 and 5, and control objects may be caused to perform the same operation. In this case, the number of a control object unit in which the exchange operation is actually performed is converted as shown in FIG. 107. FIGS. 53 to 92 illustrates an example of the case of Aex=3. In the case of other exchange operations of Aex=4 and 6, the direction indicated as the left direction in the figure may be regarded as a direction of Aex=4 and 6, and control objects may be caused to perform the same operation. In this case, the number of a control object unit in which the exchange operation is actually performed is converted as shown in FIG. 107.

In the present invention, since each LCMM is always on the Hamilton cycle pH, in order to maintain the connection of the entire robot structure, it is sufficient that connection between each LCMM position and two LCMMs present at both adjacent positions in the Hamilton cycle pH can be maintained. That is, in the exchange operation, it is sufficient that connection between two LCMMs to be exchanged and two LCMMs present at both adjacent positions in the Hamilton cycle pH can be maintained. In this sense, in exchange between control objects i at inner positions i5, 16, i7, and i8 within a UCMM to be exchanged and control objects i′ at inner positions i1, i2, and i3 in an LCMM, the exchange operation is not different depending on the direction in which a control object unit j″ at an adjacent position on the side of a control target unit j′ on which it is not j on pH is present when viewed from j′ (the control object units are arranged in the order of j, j′, j″ in pH), whereas in exchange between the inner positions i5, i6, i7, and i8 within the UCMM to be exchanged and the inner position i4 within the LCMM, the exchange operation differs depending on the direction (Arx) in which a control object unit j″ at an adjacent position on the side of a control target unit j′ on which it is not j on pH is present when viewed from j′.

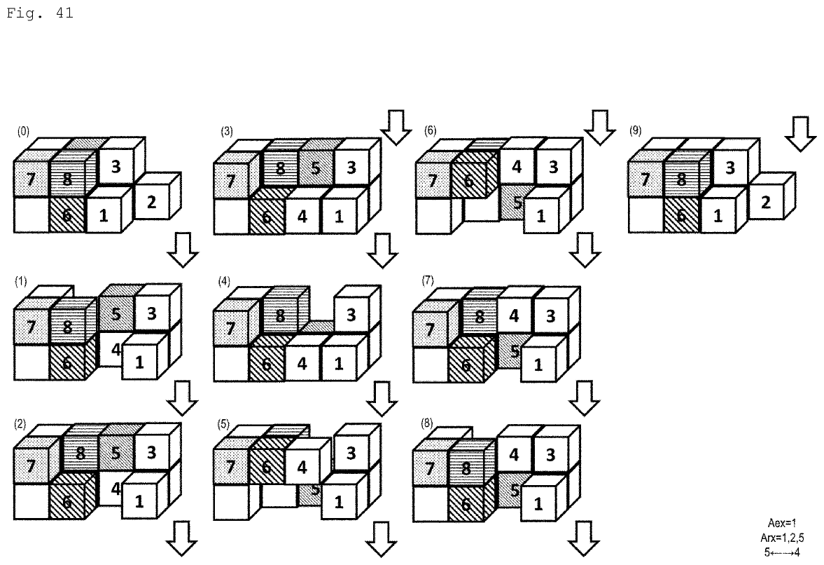

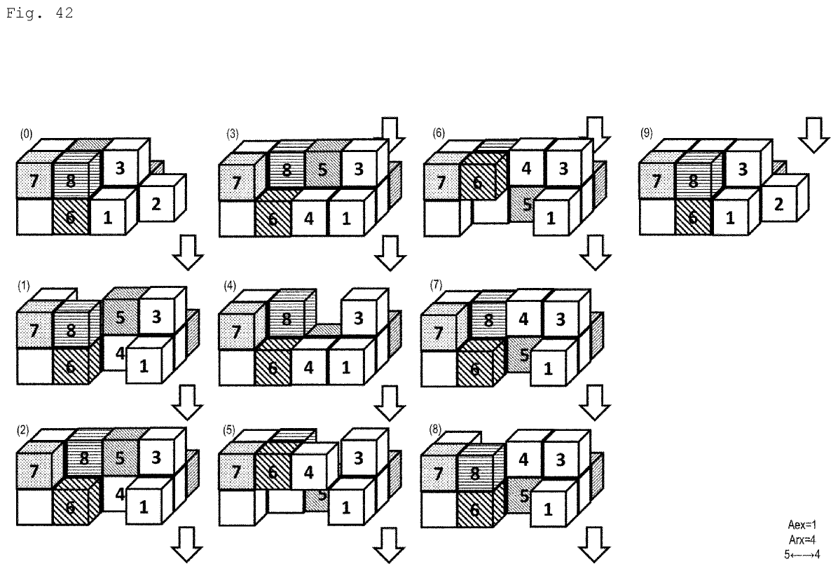

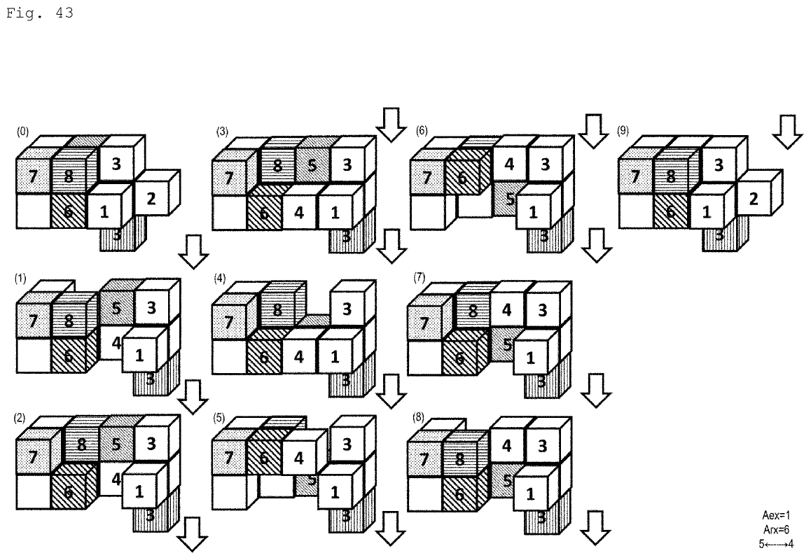

In a case where the direction of j→j′ is Aex=1, 2, and 5, for example, exchange between a control objects i and i′ at the inner position i5 in a UCMM and i4 in an LCMM is as shown in FIG. 41 when j→j′ is the direction of Aex=1 and j′→j″ is the direction of Arx=1, 2, and 5, as shown in FIG. 42 when j′→j″ is the direction of Arx=4, and as shown in FIG. 43 when j′→j″ is the direction of Arx=6. In a case where the positions of control objects i′ within the LCMM are i1, i2, and i3, the exchange operation corresponds to FIGS. 28, 32, and 37.

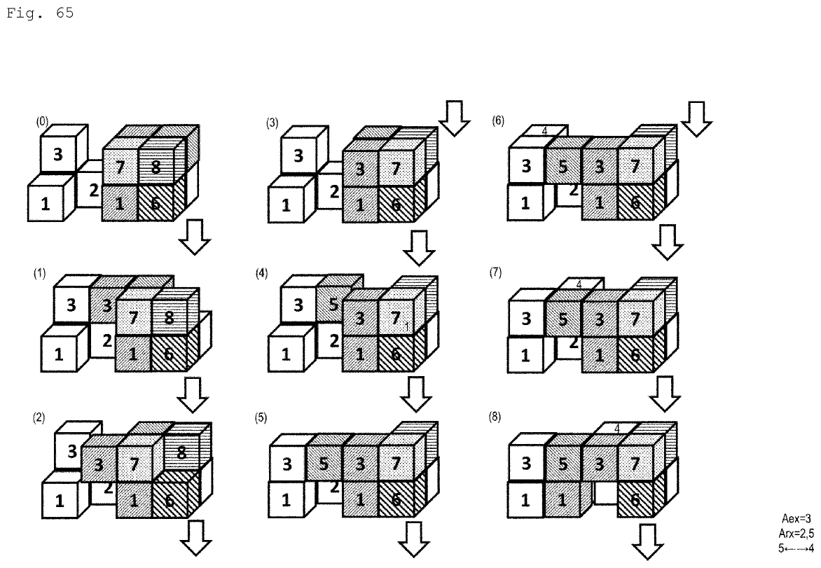

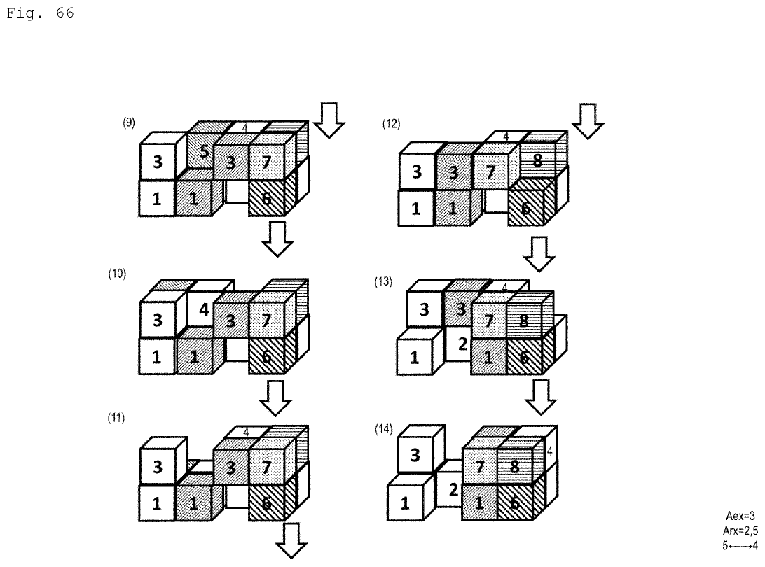

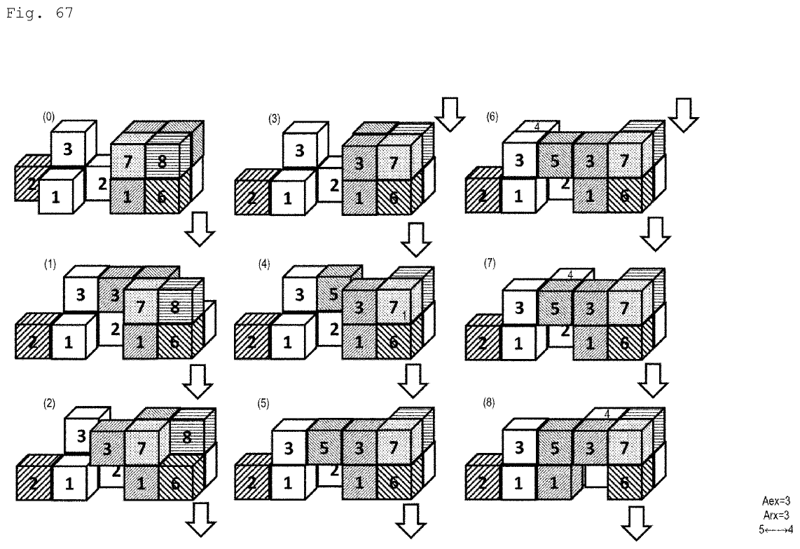

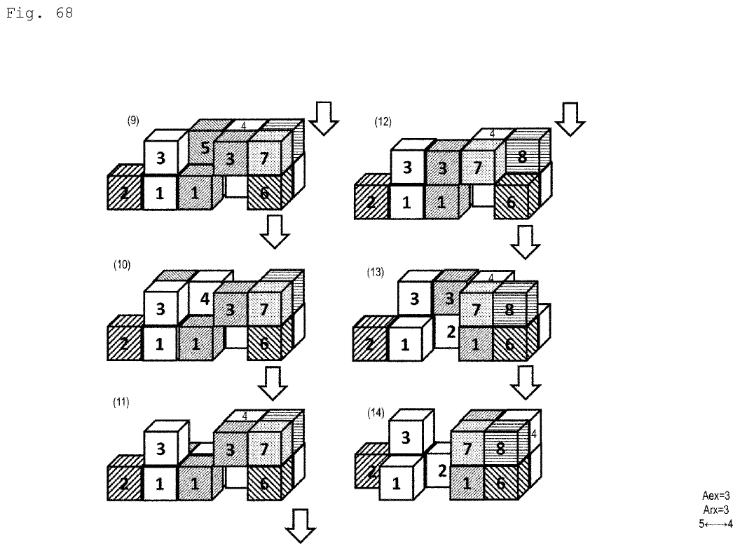

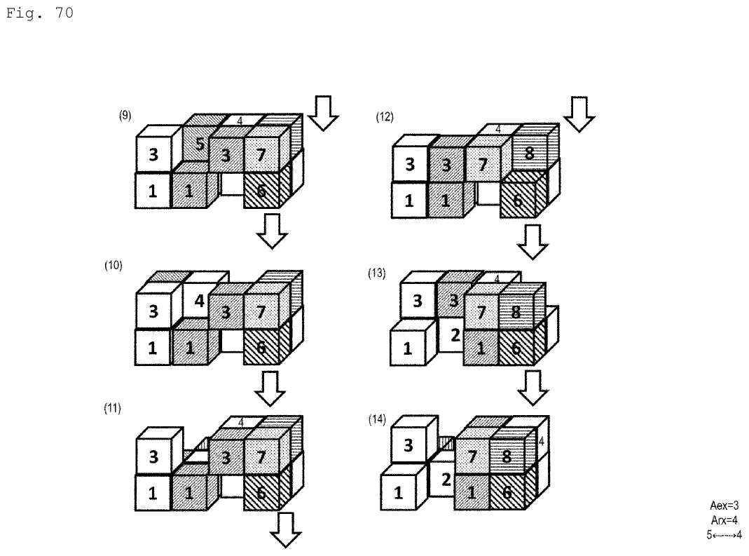

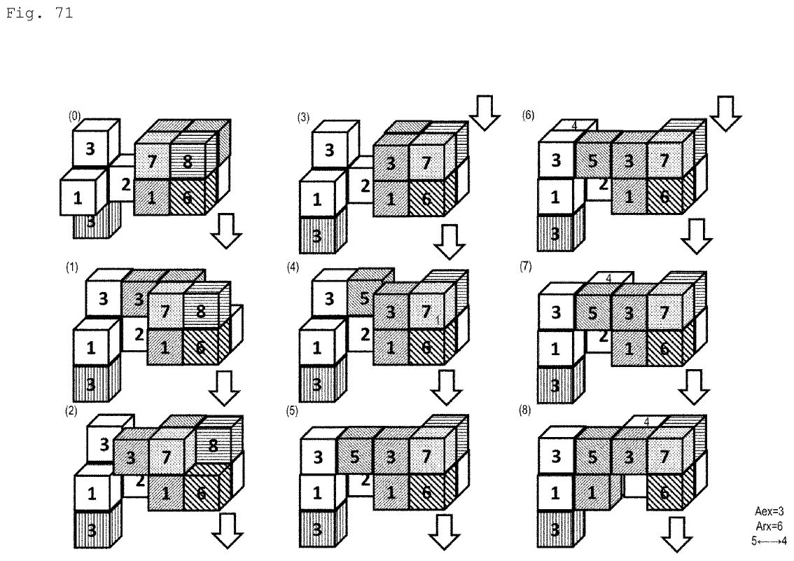

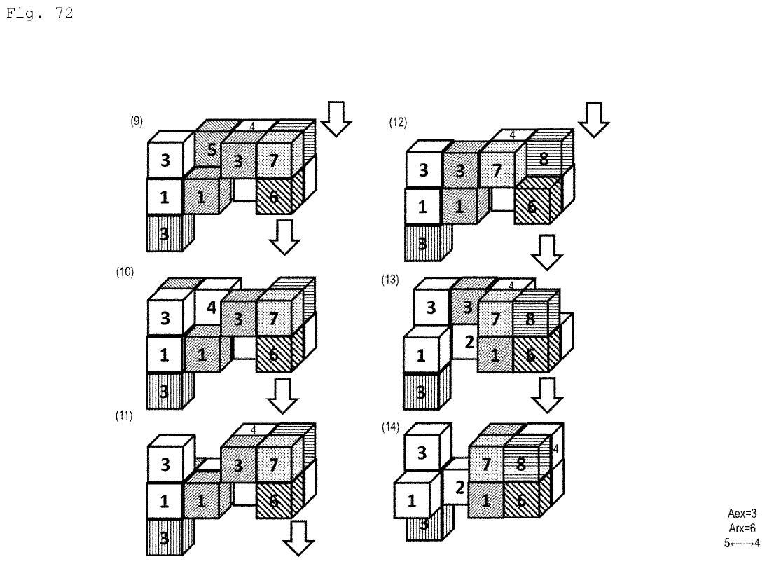

In a case where the direction of j→j′ is Aex=3, 4, and 6, for example, exchange between a control objects i and i′ at the inner position i5 in a UCMM and i4 in an LCMM is as shown in FIGS. 65 and 66 when j→j′ is the direction of Aex=3 and j′→j″ is the direction of Arx=2 and 5, as shown in FIGS. 67 and 68 when j′→j″ is the direction of Arx=3, as shown in FIGS. 69 and 70 when when j′→j″ is the direction of Arx=4, and as shown in FIGS. 71 and 72 when j′→j″ is the direction of Arx=6. For example, the exchange operation between the control object i in i5 within the UCMM and the control objects i′ in i1, i2, and i3 within the LCMM correspond to FIGS. 53, 58, 61.

The reason why the above-described case classification is necessary is that the control object at the position i4 within the control object unit j′ which is an LCMM has the only connecting plane in j′ of connection with the control object unit j″ at the positions adjacent thereto in the direction of a=3, 4 and 6. That is, the operation for maintaining the connection differs depending on the direction in which the control object in j″ in contact with the control object at the position i4 in j′ is present.

### [Position_Exchange_Fore(UCMM_NOW[j_tmp])]

(1) A control object unit UCMM_NOW[j_tmp] is defined as a control object unit j. A control object unit which is an LCMM present at an adjacent position ahead of an LCMM at the same control object unit position as the control object unit j in the Hamilton cycle pH is defined as a control object unit j′, and a control object unit which is an LCMM at an adjacent position ahead of the control object unit j′ in the Hamilton cycle pH is defined as a control object unit j″. With respect to a control object i in j, in (i) a case in which target_UCMM_or_LCMM[i]>N_{lcmm}−1, and a control object unit j′ was a UCMM which was at the position of P_UCMM[target_UCMM_or_LCMM[i]−N_{lcmm}] at the start of an exchange process (at the start of Permutation_M_M′_A_max_0, Permutation_M_M′_A_max_1, or Permutation_M_M′_A_max_2) or (ii) a case in which target_UCMM_or_LCMM[i]<N_{lcmm}, and the control object unit j′ was an LCMM which was at the position of P_LCMM[target_UCMM_or_LCMM[i]] at the start of the exchange process, processing proceeds to (2) having a control object whose inner position at the start of the exchange process (inner position at the start of Permutation_M_M′_A_max_0, Permutation_M_M′_A_max_1, or Permutation_M_M′_A_max_2) is target_inner_before[i], among the control objects in the control object unit j′, as a control object i′ to be exchanged with the control object i (having a control object corresponding to Ori[i′]=target_inner_before[i] defined in [All_Transformation] which will be described later as the control object i′). In other cases, processing is finished.

(2) Processing proceeds to (3) if the direction of j→j′ is a=1, 2 and 5 and proceeds to (4) if the direction of j→j′ is a=3, 4 and 6.

(3) If the position of the control object i′ within the the control object unit j′ is i1, i2 and i3, the exchange operation is performed through the operations shown in FIGS. 28 to 40. If the position is i4, the exchange operation is performed through the operations shown in FIGS. 41 to 52 in the direction of j′→j″. The values of Ori[i] and Ori[i′] are exchanged by the control objects i and i′.

(4) If the position of the control object i′ within the control object unit j′ is i1, i2 and i3, the exchange operation is performed through the operations shown in FIGS. 53 to 64. If the position is i4, the exchange operation is performed through the operations shown in FIGS. 65 to 92 in the direction of j′→j″. The values of Ori[i] and Ori[i′] are exchanged by the control objects i and i′.

(5) As a result of the exchange operation of (3) or (4), with respect to the control object i′ which has moved into the control object unit j, in a case in which target_UCMM_or_LCMM[i′]>N_{lcmm}−1, and the control object unit j was a UCMM which was at the position of P_UCMM[target_UCMM_or_LCMM[i′]−N_{lcmm}] at the start of the exchange process (at the start of Permutation_M_M′_A_max_0, Permutation_M_M′_A_max_1, or Permutation_M_M′_A_max_2) or a case in which target_UCMM_or_LCMM[i′]<N_{lcmm}, and the control object unit j was an LCMM which was at the position of P_LCMM[target_UCMM_or_LCMM[i′]] at the start of the exchange process, if the inner position of the control object i that was originally at the inner position in the UCMM after the main exchange operation of the control object i′ at the start of the exchange process (inner position at the start of Permutation_M_M′_A_max_0, Permutation_M_M′_A_max_1, or Permutation_M_M′_A_max_2) is not target_inner_before[i′] (if the value of Ori[i′] after exchanging the values in (3) or (4) is not target_inner_before[i′]), Inner_Exchange(j, j′) is executed to perform exchange with a control object i″ in the control object unit j whose inner position at the start of the exchange process is target_inner_before[i′].

### [Position_Exchange_Aft(UCMM_NOW[j_tmp])]

(1) A control object unit UCMM_NOW[j_tmp] is defined as a control object unit j. A control object unit which is an LCMM present at an adjacent position before an LCMM at the same control object unit position as the control object unit j in the Hamilton cycle pH is defined as a control object unit j′, and a control object unit which is an LCMM at an adjacent position before the control object unit j′ in the Hamilton cycle pH is defined as a control object unit j″. With respect to a control object i in j, in (i) a case in which target_UCMM_or_LCMM[i]>N_{lcmm}−1, and a control object unit j′ was a UCMM which was at the position of

P_UCMM[target_UCMM_or_LCMM[i]−N_{lcmm}] at the start of an exchange process (at the start of Permutation_M_M′_A_max_0, Permutation_M_M′_A_max_1, or Permutation_M_M′_A_max_2) or (ii) a case in which target_UCMM_or_LCMM[i]<N_{lcmm}, and the control object unit j′ was an LCMM which was at the position of P_LCMM[target_UCMM_or_LCMM[i]] at the start of the exchange process, processing proceeds to (2) having a control object whose inner position at the start of the exchange process (inner position at the start of Permutation_M_M′_A_max_0, Permutation_M_M′_A_max_1, or Permutation_M_M′_A_max_2) is target_inner_before[i], among the control objects in the control object unit j′, as a control object i′ to be exchanged with the control object i (having a control object corresponding to Ori[i′]=target_inner_before[i] defined in [All_Transformation] which will be described later as the control object i′). In other cases, processing is finished.

(2) Processing proceeds to (3) if the direction of j→j′ is a=1, 2 and 5 and proceeds to (4) if the direction of j→j′ is a=3, 4 and 6.

(3) If the position of the control object i′ within the control object unit j′ is i1, i2 and i3, the exchange operation is performed through the operations shown in FIGS. 28 to 40. If the position is i4, the exchange operation is performed through the operations shown in FIGS. 41 to 52 in the direction of j′→j″. The values of Ori[i] and Ori[i′] are exchanged by the control objects i and i′.

(4) If the position of the control object i′ within the control object unit j′ is i1, i2 and i3, the exchange operation is performed through the operations shown in FIGS. 53 to 64. If the position is i4, the exchange operation is performed through the operations shown in FIGS. 65 to 92 in the direction of j′→j″. The values of Ori[i] and Ori[i′] are exchanged by the control objects i and i′.

(5) As a result of the exchange operation of (3) or (4), with respect to the control object i′ which has moved into the control object unit j, in a case in which target_UCMM_or_LCMM[i′]>N_{lcmm}−1, and the control object unit j was a UCMM which was at the position of

P_UCMM[target_UCMM_or_LCMM[i′]−N_{lcmm}] at the start of the exchange process (at the start of Permutation_M_M′_A_max_0, Permutation_M_M′_A_max_1, or Permutation_M_M′_A_max_2) or a case in which target_UCMM_or_LCMM[i′]<N_{lcmm}, and the control object unit j was an LCMM which was at the position of P_LCMM[target_UCMM_or_LCMM[i′]] at the start of the exchange process, if the inner position of the control object i that was originally at the inner position in the UCMM after the main exchange operation of the control object i′ at the start of the exchange process (inner position at the start of Permutation_M_M′_A_max_0, Permutation_M_M′_A_max_1, or Permutation_M_M′_A_max_2) is not target_inner_before[i′] (if the value of Ori[i′] after exchanging the values in (3) or (4) is not target_inner_before[i′]), Inner_Exchange(j, j′) is executed to perform exchange with a control object i″ in the control object unit j whose inner position at the start of the exchange process is target_inner_before[i′].

[Inner_Exchange] is required when a target position of a control object i′ that has newly entered the control object j is within j as a result of executing (3) and (4) of Position_Exchange_Fore and Position_Exchange_Aft. Only by executing (3) and (4) of Position_Exchange_Fore and Position_Exchange_Aft, i′ is within j, but it is not necessarily at the correct position within j. In this case, [Inner_Exchange] serves to move i′ to the correct position within j. [Inner_Exchange] is a stage before the position exchange process in M starts, and is provided in consideration of a case in which target positions of control objects in j are within j (that is, a case in which position exchange within a plurality of j is required). For processing of [Inner_Exchange], a control object within each control object remembers an inner arrangement among i1, i2, i3, 14, 15, 16, i7, and i8 before each control object starts circular movement within pH. The variable is defined as Ori[i]. At the time of executing Exchange, information of Ori[i] is exchanged between the control objects i and i′ to be exchanged at Position_Exchange_Fore and Position_Exchange_Aft(refer to (3) and (4) of Position_Exchange_Fore andPosition_Exchange_Aft).

[Inner_Exchange(j, j′)]

(1) In a case in which there are control objects i′ having different inner positions indicated by Ori[i′] and target_inner_before[i′] among control objects i′ in a control object unit j, which have target positions within the control object unit j which is a UCMM, (2) is executed for one thereof. If not, processing is finished.

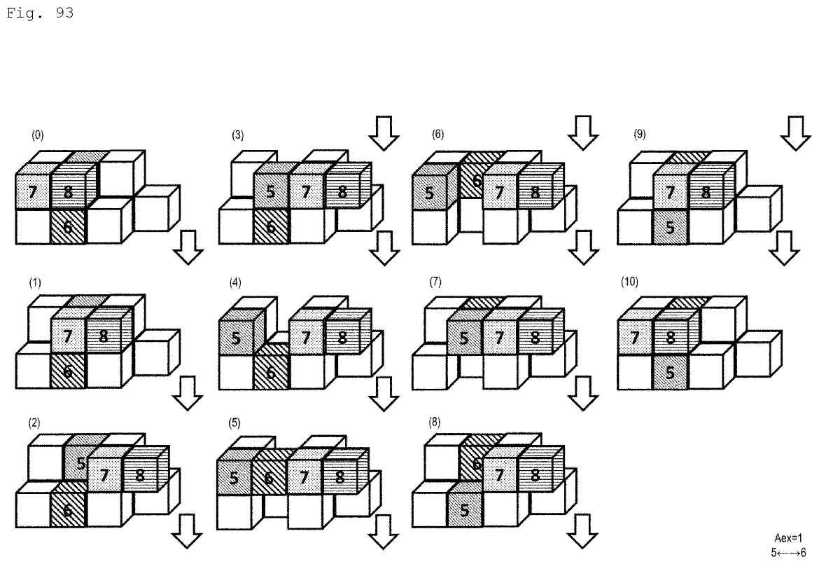

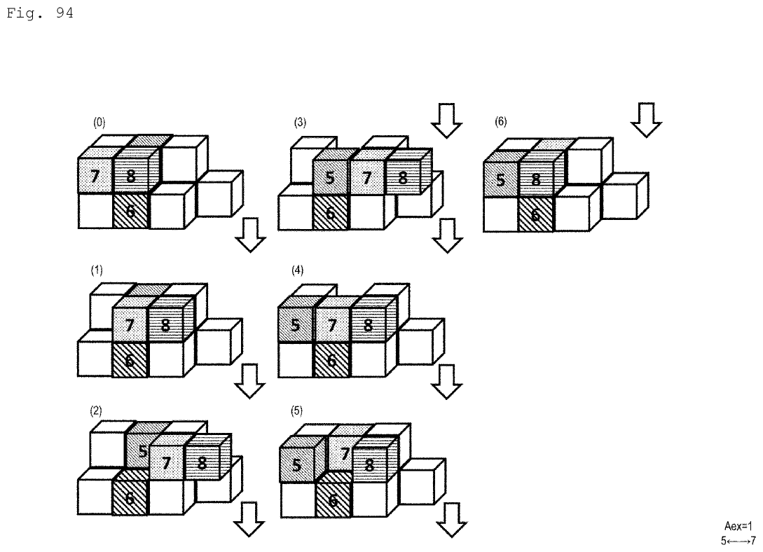

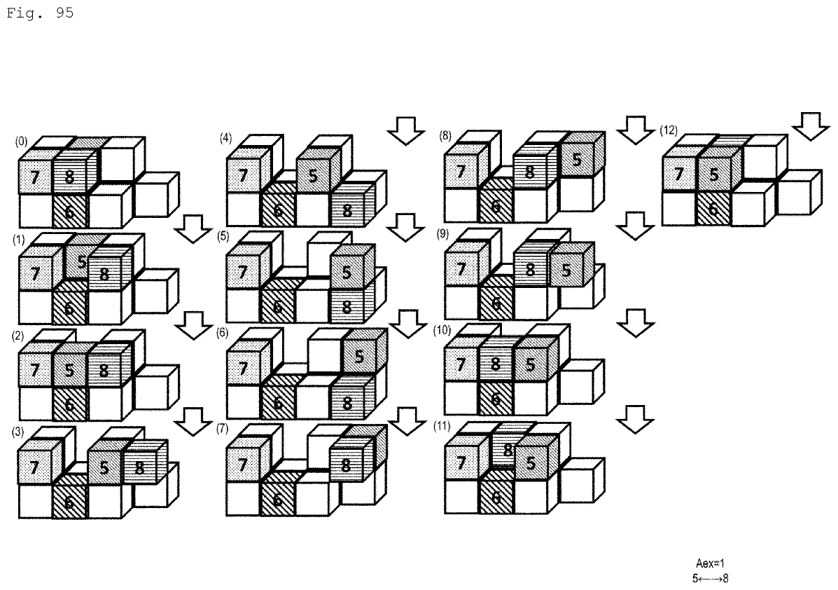

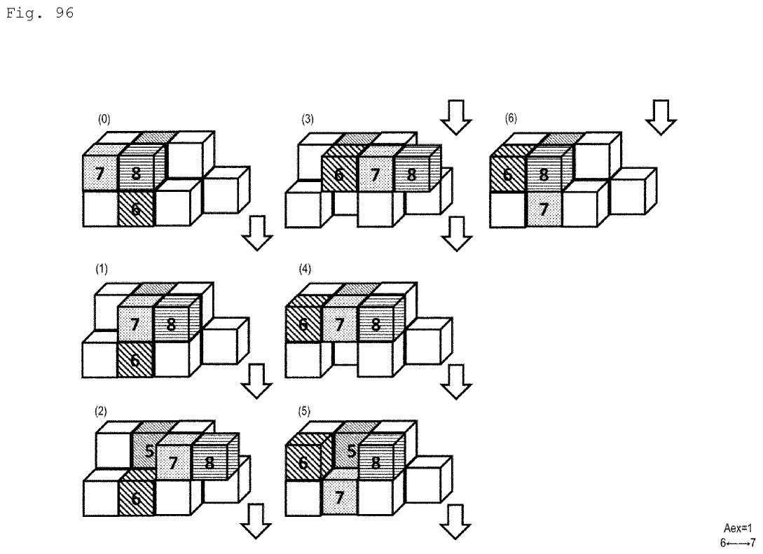

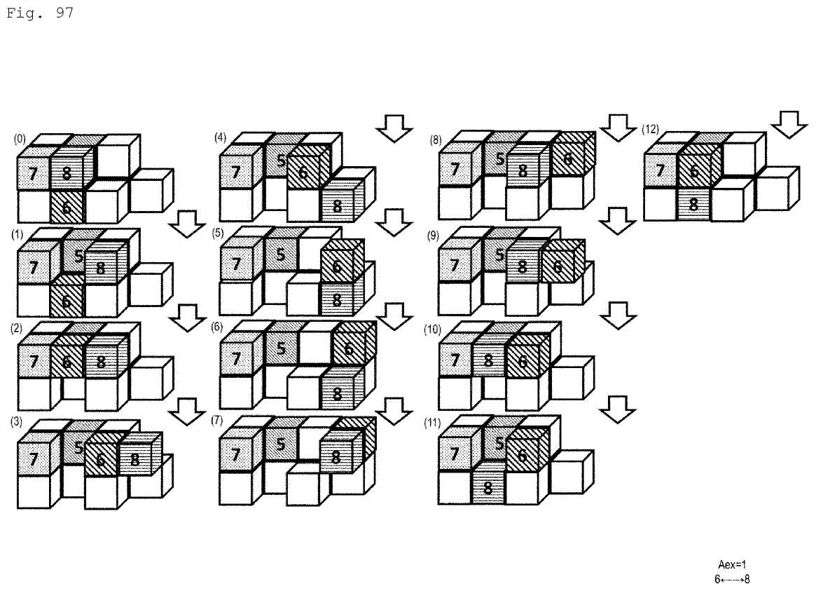

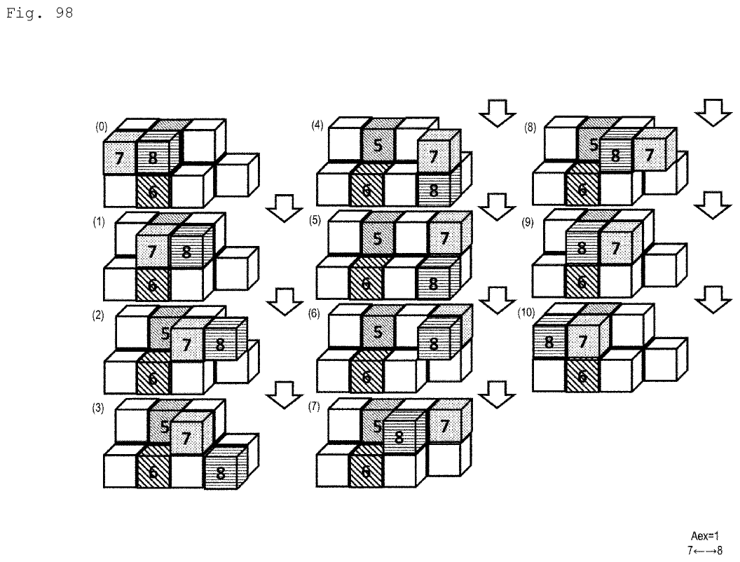

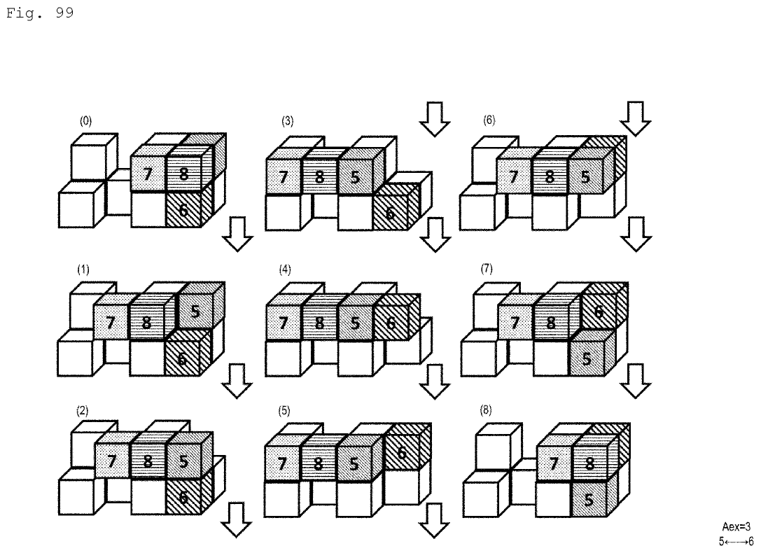

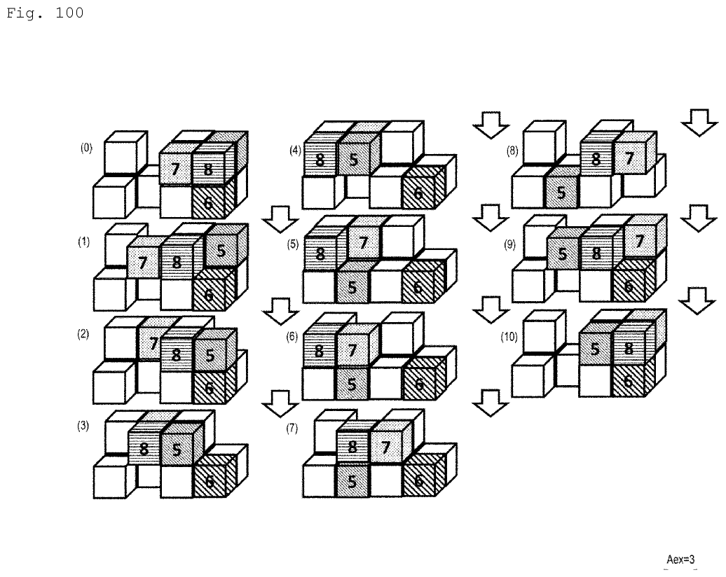

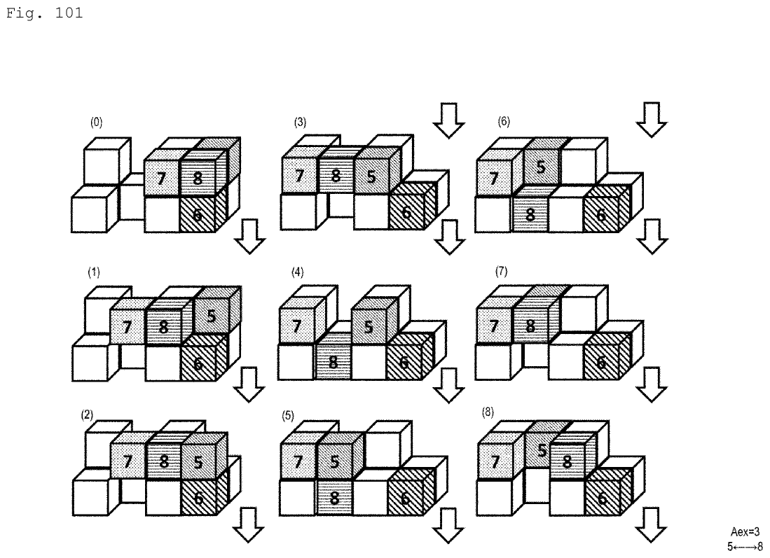

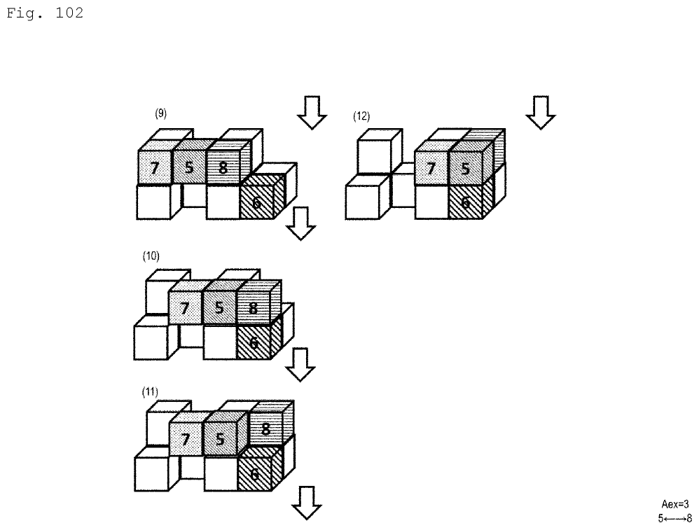

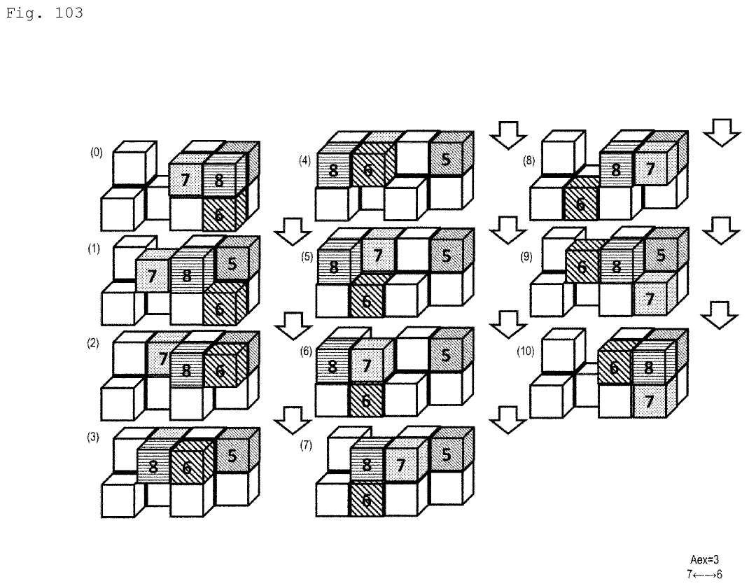

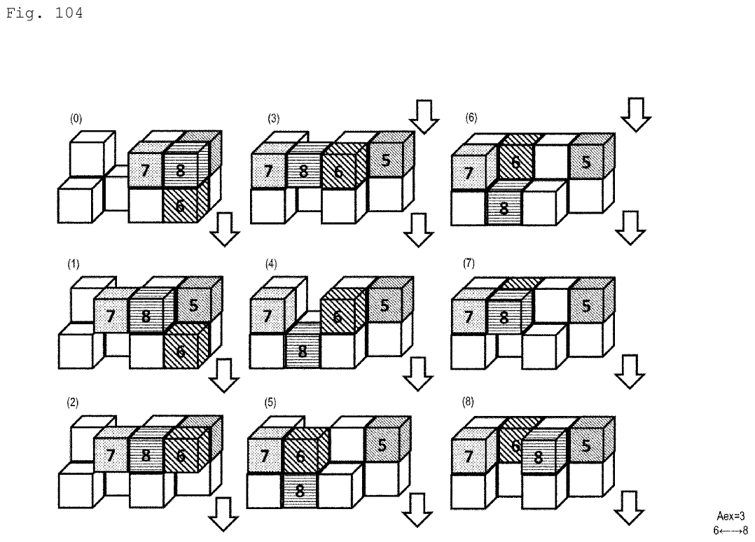

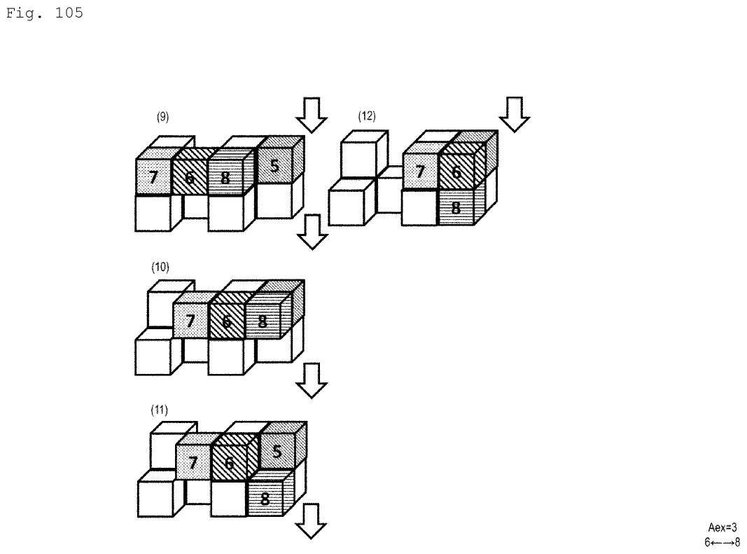

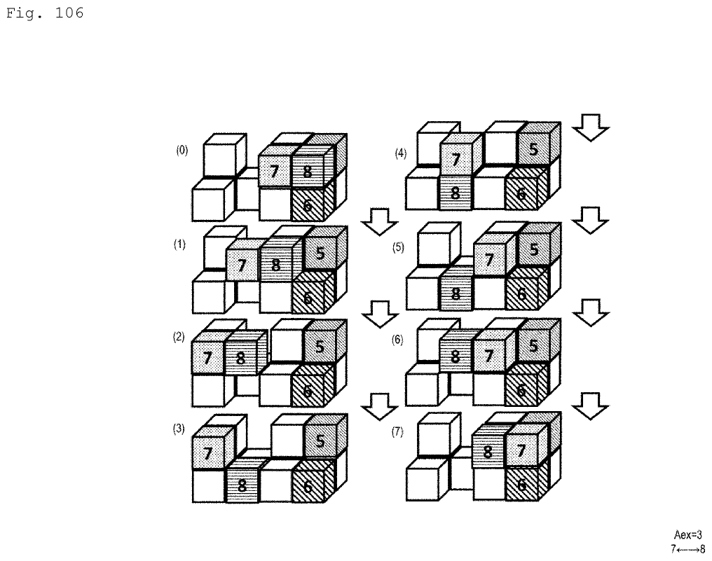

(2) A control object i″ corresponding to Ori[i″]=target_inner_before[i′] is selected from control objects i″ within the control object unit j that is a UCMM, and the control object i′ and the control object i″ are exchanged by the operations shown in FIGS. 93 to 98 when the direction of j→j′ is a=1, 2, and 5. When the direction of j→j′ is a=3, 4, and 6, the control object i′ and the control object i″ are exchanged by the operations shown in FIGS. 99 to 106. Processing returns to (1).

The inner position exchange operation within a control object unit in (2) is shown in FIGS. 93 to 106. FIGS. 93 to 106 also show examples of actual operations in the case where Aex=1 and 3. Similarly, in the case of the exchange operation with other values of Aex, the direction of j→j′ in the figure may be regarded as the direction of Aex, and a control object may be caused to perform the same operation. In this case, the number of a control object unit in which the exchange operation is actually performed is converted as shown in FIG. 107.

[Transformation process of M→G]

The present transformation process is basically obtained by temporally reverse-reproducing [transformation process of S→M] in which S has been exchanged with G and M has been exchanged with M′ [in the transformation process of G→M′]. That is, homogeneous transformation from G to the intermediate position M′pre is performed by the existing 8-square homogeneous transformation method, and then [M′pre->M′_Transform] which will be described later is executed for transformation from M′pre to M′. An example of an existing 8-square homogeneous transformation method is the method described in PCT/JP2021/025458.

Similarly, for M′pre, for convenience in the exchange process of M→M′, which will be described later, an 8-square control object position within M′pre is defined as P_M′pre[j]=(X_M′pre[j], Y_M′pre[j], Z_M′pre[j]) (j=0, 1, 2, . . . , j_max/2−1), it is numbered as P_M′pre[j]=P_Mpre[j+drift] on the assumption that drift←N_{ucmm}−(2+N_add) when A_max=0, drift←N_{ucmm}−(0+N_add) when A_max=1, and drift←N_{ucmm}−(1+N_add) when A_max=2 (P_M′pre[j]=P_Mpre[j+drfit←Nₕₐₘᵢₗₜₒₙ] in (j+drfit≥ Nₕₐₘᵢₗₜₒₙ). The outline of transformation from Mpre to M′ is as follows.

(1) Each UCMM at a control object unit position from P_M′pre[j_max/2−1] to P_M′pre[j_max/2−1−j_become_lcmm] is moved to fill a Hamilton cycle position which is blank in M′ Pre. The value of j_become_lcmm is N_{lcmm}−j_max/2−1, that is, k_max−1 when A_max=0, k_max when A_max=1, and k_max when when A_max=2.

(2) UCMMs at control object unit positions of P_M′pre[N_{ucmm}−1] (=P_M′pre[j_max/2−1−j_become_lcmm−1]) to P_M′pre[0] are moved to predetermined UCMM positions in M′.

Pseudo code is as follows.

### [M′pre->M′_Transform]

(1) In j=0 to j_become_lcmm, the UCMM at the control object unit position of P_M′pre[j_max/2−1−j] sets a target position thereof to (Hamilton_X[N_{hamilton_min}−3−j+drfit], Hamilton_Y[N_{hamilton_min}−3−j+drfit], Hamilton_Z[N_{hamilton_min}−3−j+drfit]) when A_max=0 and 1, and to (Hamilton_X[N_{hamilton_min}−4−j+drfit], Hamilton_Y[N_{hamilton_min}−4−j+drfit], Hamilton_Z[N_{hamilton_min}−4−j+drfit]) when A_max=2, and moves on LCMMs in a direction in which the number of the position in pH increases along the Hamilton cycle pH until reaching a position adjacent to each target position in the Hamilton cycle pH. Thereafter, it is transformed and moved to LCMM to each target position. A movement start time difference between UCMMs at P_M′pre[j_max/2−1−j] and P_M′pre[j_max/2−1−(j+1)] is set to the number of time steps required for P_M′pre[j_max/2−1−j] to transform and move to LCMMs.

(2) In j=0 to N_{ucmm}−1, the UCMM at the control object unit position of P_M′pre[N_{ucmm}−1−j] sets a target position thereof to P′_UCMM[N_{ucmm}−1−j]=(Hamilton_X[2×(N_{ucmm}−1−j)+drfit], Hamilton_Y[2×(N_{ucmm}−1−j)+drfit], Hamilton_Z[2×(N_{ucmm}−1-j)+drfit]), and moves on LCMMs in a direction in which the number of the position in pH increases along the Hamilton cycle pH until reaching each target position. A movement start time difference between UCMMs at P_M′pre[N_{ucmm}−1−j] and P_M′pre[N_{ucmm}−1−(j+1)] is set to the number of time steps required for each UCMM to move on LCMMs.

In summary, [transformation process of S→M] and [transformation process of G→M′] are as follows.

[Transformation process of S→M]

(1) Homogeneous transformation from S to Mpre is performed using an existing 8-square homogeneous transformation method. An example of an existing 8-square homogeneous transformation method is the method described in PCT/JP2021/025458.

(2) [Mpre->M_Transform] is executed.

[Transformation process of G→M′]

(1) Homogeneous transformation from G→M′pre is performed using an existing 8-square homogeneous transformation method. An example of an existing 8-square homogeneous transformation method is the method described in PCT/JP2021/025458.

(2) [M′pre->M′_Transform] is executed. The position of each control object obtained as a result is set to target[i].

### [Whole Transformation Process]

By combining the processes described above, in other words, by performing processing of [All_Transformation] which will be described below, the whole heterogeneous transformation process is completed.

### [All_Transformation]

(1) Control objects are moved according to an operation history calculated in [Transformation process of S→M]. This processing is performed by a first movement planning unit 1 and a first movement unit 2 which will be described later.

(2) [Transformation process of G→M′] is executed by a virtual robot to obtain operation history data. This processing is performed by a second movement planning unit 3.

(3) The control object unit inner position of each control object i at the intermediate position M is stored in a variable Ori[i]. Thereafter, [Position change process at intermediate position M] is executed, and each control object at the intermediate position M before exchange is moved to the intermediate position M′ after exchange. Specifically, [Permutation_M_M′_A_max_0] is executed when A_max=0, [Permutation_M_M′_A_max_1] is executed when A_max=1, and [Permutation_M_M′_A_max_2] is executed when A_max=2. This processing is performed by an intermediate position exchange unit 4 which will be described later.

(4) Control objects are moved according to the operation obtained by reversely reproducing the operation history calculated in [Transformation process of G→M′]. This processing is performed by a second movement unit 5 which will be described later.

### Embodiment

An embodiment of the present invention will be described in detail below. Further, components with the same function are denoted by the same reference numerals in the diagrams, and overlapping explanations are omitted accordingly. First, an embodiment of a control device and method will be described.

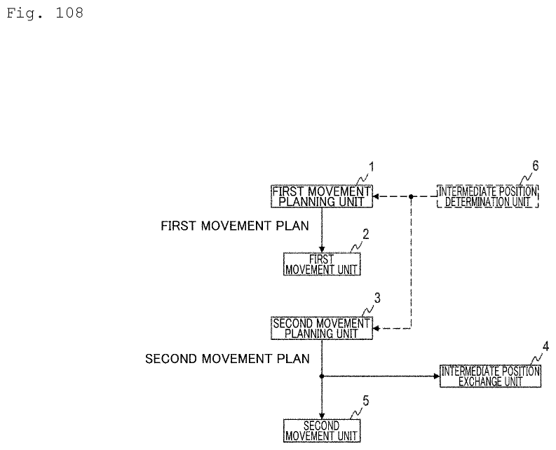

As shown in FIG. 108, the control device includes the first movement planning unit 1, the first movement unit 2, the second movement planning unit 3, the intermediate position exchange unit 4 and the second movement unit 5.

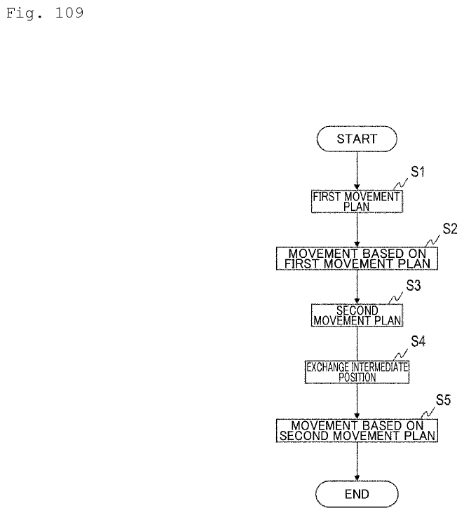

The control method is realized, for example, by each constituent unit of the control device performing processing of step S1 to step S5 shown in FIG. 109 which will be described below.

Each constituent unit of the control device will be described below.

### <First Movement Planning Unit 1>

The first movement planning unit 1 creates a first movement plan for moving each control object at an initial position S to an intermediate position M before exchange in control object units (step S1). The created first movement plan is output to the first movement unit 2.

For example, the first movement planning unit 1 creates the first movement plan by performing processing of [Transformation process of S→M] described above.

More specifically, the first movement planning unit 1 creates the first movement plan by performing processing of homogeneous transformation from the initial position S to Mpre and processing of homogeneous transformation from Mpre to the intermediate position M before exchange, which have been described above.

In this embodiment, processing is performed on the basis of a predetermined intermediate position M before exchange.

### <First Movement Unit 2>

The first movement plan is input to the first movement unit 2.

The first movement unit 2 moves each control object at the initial position S to the intermediate position M before exchange in control object units according to the first movement plan (step S2).

The first movement unit 2 moves control objects in the control object units according to the method described in [Transformation process of S→M].

### <Second Movement Planning Unit 3>

The second movement planning unit 3 creates a second movement plan for moving each control object assumed to be at a target position G to an intermediate position M′ after exchange in control object units (step S3). The created second movement plan is output to the intermediate position exchange unit 4 and the second movement unit 5.

For example, the second movement planning unit 3 creates the second movement plan by performing [Transformation process of G→M′] described above.

In this embodiment, processing is performed on the basis of a predetermined intermediate position M′ after exchange.

### <Intermediate Position Exchange Unit 4>

The first movement plan created by the first movement planning unit 1 and the second movement plan created by the second movement planning unit 3 are input to the intermediate position exchange unit 4.

The intermediate position exchange unit 4 moves each control object at the intermediate position M before exchange to a movement destination of each control object determined by the second movement plan among intermediate positions M′ after exchange (step S4).

For example, the intermediate position exchange unit 4 performs processing of [Position exchange process at intermediate position M] described above.

That is, the intermediate position exchange unit 4 moves a first type control object unit j along a Hamiltonian cycle, and in a case in which there is a movement destination of a control object constituting the first type control object unit j, determined by the second movement plan, among second type control object units adjacent to the first type control object unit j, repeats processing of exchanging the control object with the control object at the movement destination to move each control object moved by the first movement unit to the movement destination of each control object determined by the second movement plan among the intermediate positions M′ after exchange. In such processing, each control object unit moves all positions on the Hamilton cycle as the first type control object unit j.

As described above, a graph in which a control object unit at an intermediate position is defined as a node and a plane connecting two control object units in contact with each other is defined as an edge constitutes a part or the whole of the Hamilton cycle, and a combined control object unit and a second type control object unit are alternately disposed at the intermediate position along the Hamilton cycle.

### <Second Movement Unit 5>

The second movement plan is input to the second movement unit 5.

The second movement unit 5 moves each control object at an intermediate position M′ after exchange to a target position G in control object units according to a plan obtained by temporally reversing the second movement plan (step S5).

The second movement unit 5 moves the control object in the control object units by the method described in [Transformation process of M′-G].

The control device may include an intermediate position determination unit 6 indicated by a broken line in FIG. 108.

In this case, the intermediate position determination unit 6 determines the intermediate position M before exchange and the intermediate position M′ after exchange by performing processing of [M_Decision] described above. The intermediate position determination unit 6 may determine the intermediate position M before exchange and the intermediate position M′ after exchange by performing processing of [M_Additional_Decision] described above. The determined intermediate position M before exchange and intermediate position M′ after exchange are output to the first movement planning unit 1 and the second movement planning unit 3.

### Modified Examples

While embodiments of the present invention have been described above, specific configurations are not limited to the embodiments and, needless to say, the present invention also includes appropriate modifications in design or the like having been made without departing from the spirit and the scope of the present invention.

The various types of processing described in the embodiments are not limited to being executed in a time series manner in the described order, and may be executed in parallel or individually in accordance with the processing capability of the device that executes the processing or as required.

Data may be directly exchanged between the constituent elements of the control device or may be exchanged via a storage unit which is not shown.

### Program, Recording Medium

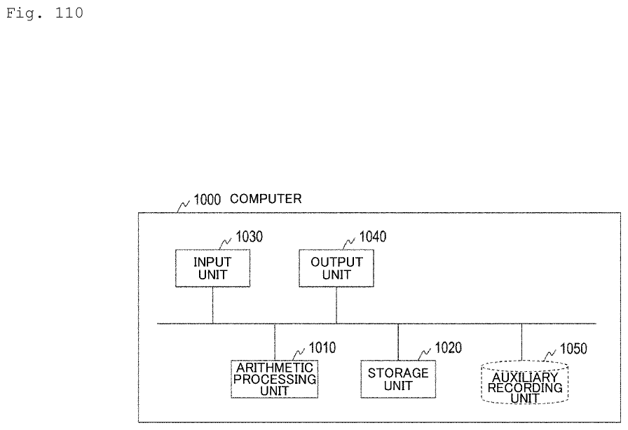

The processing of each unit of each device may be implemented by a computer, and in this case, the processing details of the functions that each device should have are described by a program. Then, various types of processing functions in each device are realized on the computer by causing this program to be read by a storage unit 1020 of the computer 1000 shown in FIG. 110 and operating an arithmetic processing unit 1010, an input unit 1030, an output unit 1040, a display unit 1060, and the like.

A program in which details of this processing are described can be recorded on a computer-readable recording medium. The computer-readable recording medium is, for example, a non-transitory recording medium, and specifically a magnetic recording device, an optical disc, and the like.

The program is distributed, for example, by sales, transfer, or lending of a portable recording medium such as a DVD or a CD-ROM on which the program is recorded. In addition, the distribution of the program may be performed by storing the program in advance in a storage device of a server computer and transferring the program from the server computer to another computer via a network.

The computer executing such a program first temporarily stores the program recorded in the portable recording medium or the program transferred from the server computer, for example, in an auxiliary recording unit 1050, which is its own non-transitory storage device. Then, when executing processing, the computer reads the program stored in the auxiliary recording unit 1050 serving as its own non-transitory storage device onto the storage unit 1020, and executes processing according to the read program. Alternatively, as another of executing the program, the computer may read the program directly from the portable recording medium onto the storage unit 1020, and execute processing according to the program, or the computer may sequentially execute processing according to the program received from the server computer every time the program is transferred thereto from the server computer.

Moreover, the above-described processing may be executed by a so-called application service provider (ASP) type service that implements a processing function only by an execution instruction and result acquisition without transferring the program from the server computer to the computer. Note that the program in the present embodiment includes information that is used for processing by an electronic computer and is equivalent to the program (data or the like that is not a direct command to the computer but has property that defines processing performed by the computer).

In addition, although the present device is configured by executing a predetermined program on the computer in this from, at least a part of the details of the processing may be implemented by hardware. For example, the first movement planning unit 1, the first movement unit 2, the second movement planning unit 3, the intermediate position exchange unit 4, the second movement unit 5, and the intermediate position determination unit 6 may be configured by a processing circuit.

In addition, modifications can be made as appropriate without departing from the gist of the present invention.

### REFERENCE SIGNS LIST

1 First movement planning unit
2 First movement unit
3 Second movement planning unit
4 Intermediate position exchange unit
5 Second movement unit
6 Intermediate position determination unit

1. A control device comprising, on the assumption that control object units include a first type control object unit and a second type control object unit, each of the first type control object unit and the second type control object unit is composed of U (U is an integer of 4 or more) control objects,
an initial position S and a target position G are determined for each control object, a structure composed of control objects at initial positions S and target positions G is constituted by a combined control object unit composed of 2U control objects by combining the first type control object unit and the second type control object unit,
a graph in which a control object unit at an intermediate position is defined as a node and a plane connecting two control object units in contact with each other is defined as an edge constitutes a part or the whole of a Hamilton cycle, a combined control object unit and a second type control object unit are alternately disposed at intermediate positions along the Hamilton cycle, and intermediate positions include an intermediate position M before exchange and an intermediate position M′ after exchange wherein:
a first movement planning unit configured to create a first movement plan for moving each control object at an initial position S to an intermediate position M before exchange in control object units;
a first movement unit configured to move each control object at the initial position S to the intermediate position M before exchange in control object units according to the first movement plan;
a second movement planning unit configured to create a second movement plan for moving each control object assumed to be at a target position G to an intermediate position M′ after exchange in control object units;
an intermediate position exchange unit configured to move each control object at the intermediate position M before exchange to a movement destination of each control object determined by the second movement plan among intermediate positions M′ after exchange; and
a second movement unit configured to move each control object at the intermediate position M′ after exchange to a target position G in control object units according to a plan obtained by temporally reversing the second movement plan.

2. The control device according to claim 1, wherein
the intermediate position exchange unit moves a first type control object unit j along the Hamiltonian cycle, and in a case in which there is a movement destination of a control object constituting the first type control object unit j, determined by the second movement plan, among second type control object units adjacent to the first type control object unit j, repeats processing of exchanging the control object with the control object at the movement destination to move each control object moved by the first movement unit to the movement destination of each control object determined by the second movement plan among intermediate positions M′,
wherein, in the processing, each control object unit moves at all positions on the Hamilton cycle as the first type control object unit j.

3. A control method, wherein control object units include a first type control object unit and a second type control object unit, each of the first type control object unit and the second type control object unit is composed of U (U is an integer of 4 or more) control objects,
an initial position S and a target position G are determined for each control object, a structure composed of control objects at initial positions S and target positions G is constituted by a combined control object unit composed of 2U control objects by combining the first type control object unit and the second type control object unit,
a graph in which a control object unit at an intermediate position is defined as a node and a plane connecting two control object units in contact with each other is defined as an edge constitutes a part or the whole of a Hamilton cycle, a combined control object unit and a second type control object unit are alternately disposed at intermediate positions along the Hamilton cycle, and intermediate positions include an intermediate position M before exchange and an intermediate position M′ after exchange, the control method comprising:
a first movement planning step of creating, by a first movement planning unit, a first movement plan for moving each control object at an initial position S to an intermediate position M before exchange in control object units;
a first movement step of moving, by a first movement unit, each control object at the initial position S to the intermediate position M before exchange in control object units according to the first movement plan;
a second movement planning step of creating, by a second movement planning unit, a second movement plan for moving each control object assumed to be at a target position G to an intermediate position M′ after exchange in control object units;
an intermediate position exchange step of moving, by an intermediate position exchange unit, each control object at the intermediate position M before exchange to a movement destination of each control object determined by the second movement plan among intermediate positions M′ after exchange; and
a second movement step of moving, by a second movement unit, each control object at the intermediate position M′ after exchange to a target position G in control object units according to a plan obtained by temporally reversing the second movement plan.

4. (canceled)

5. A control device comprising, A computer-readable non-transitory recording medium storing computer-executable program instructions that when executed by a processor cause a computer to execute a control method comprising:
on the assumption that control object units include a first type control object unit and a second type control object unit, each of the first type control object unit and the second type control object unit is composed of U (U is an integer of 4 or more) control objects,
an initial position S and a target position G are determined for each control object, a structure composed of control objects at initial positions S and target positions G is constituted by a combined control object unit composed of 2 U control objects by combining the first type control object unit and the second type control object unit,
a graph in which a control object unit at an intermediate position is defined as a node and a plane connecting two control object units in contact with each other is defined as an edge constitutes a part or the whole of a Hamilton cycle, a combined control object unit and a second type control object unit are alternately disposed at intermediate positions along the Hamilton cycle, and intermediate positions include an intermediate position M before exchange and an intermediate position M′ after exchange wherein:
a first movement planning unit configured to create a first movement plan for moving each control object at an initial position S to an intermediate position M before exchange in control object units;
a first movement unit configured to move each control object at the initial position S to the intermediate position M before exchange in control object units according to the first movement plan;
a second movement planning unit configured to create a second movement plan for moving each control object assumed to be at a target position G to an intermediate position M′ after exchange in control object units;
an intermediate position exchange unit configured to move each control object at the intermediate position M before exchange to a movement destination of each control object determined by the second movement plan among intermediate positions M′ after exchange; and
a second movement unit configured to move each control object at the intermediate position M′ after exchange to a target position G in control object units according to a plan obtained by temporally reversing the second movement plan.

6. The computer-readable non-transitory recording medium according to claim 5 wherein the control method further comprises:
the intermediate position exchange unit moves a first type control object unit j along the Hamiltonian cycle, and in a case in which there is a movement destination of a control object constituting the first type control object unit j, determined by the second movement plan, among second type control object units adjacent to the first type control object unit j, repeats processing of exchanging the control object with the control object at the movement destination to move each control object moved by the first movement unit to the movement destination of each control object determined by the second movement plan among intermediate positions M′,
wherein, in the processing, each control object unit moves at all positions on the Hamilton cycle as the first type control object unit j.
